(19) United States
(12) Patent Application Publication
(10) Pub. No.: US 2008/0169375 A1
(43) Pub. Date: Jul. 17, 2008

(54) VERTICALLY MOVABLE FLYING BODY

(76) Inventor: Rikiya ISHIKAWA, Hyogo (JP)

Correspondence Address: DUANE MORRIS, LLP;IP DEPARTMENT, 30 SOUTH 17TH STREET, PHILADELPHIA, PA, 19103-4196, US

(21) Appl. No.: 11/864,272

(22) Filed: Sep. 28, 2007

Related U.S. Application Data
(63) Continuation of application No. PCT/JP2005/006146, filed on Mar. 30, 2005.

(51) Int. Cl. B64C 29/00; B64D 27/10

(52) U.S. Cl. 244/12.1; 244/53 R

(57) ABSTRACT

The flying body includes a body (100a), a lift engine (102a1), and reaction control engines. The lift engine includes, a gas generator (200a1) for generating a turbine driving gas, a first thrust device (204a1, 208a1, 210a1) for providing a power by the turbine driving gas and exhausting a gas (20a1) in a predetermined direction to generate a first thrust force, a second thrust device (214a1, 218a1, 220a1) driven by the power to suck and compress a surrounding gas (21a1) and to accelerate and exhaust the surrounding gas substantially in a direction of a flow of the gas exhausted by the first thrust device to generate a second thrust force to be added to the first thrust force. The gas generator generates a gas by using a raw material (10, 11a) for gas generation carried by the flying body. The first thrust device has a turbine (204a1, 208a1) for obtaining a rotational force, and the second thrust device has a fan (214a1, 218a1) driven by the rotational force obtained by the turbine, and a nozzle (222a1) in a downstream of the fan.

This application is a continuation of International Application No. PCT/JP2005/6146, filed Mar. 30, 2005 by Rikiya ISHIKAWA, titled “VERTICALLY MOVABLE FLYING BODY,” the entirety of which application is incorporated by reference herein.

### FIELD OF THE INVENTION

This invention relates to a vertically movable flying body, and in particular to a flying body which accelerates a surrounding gas flow with a gas carried by the flying body and generates a thrust force by return action thereby to provide flotation, flight, reaction control or the like.

### BACKGROUND OF THE INVENTION

Now, well-known techniques relating to fixed-wing aircrafts which has been now put to practical use and which can vertically take off and land except for rotary-wing aircrafts such as helicopters are described below in items 1.1-1.3. The following patent and non-patent documents are incorporated herein by reference.

1.1 In U.S. Pat. No. 3,447,764 (AIRCRAFT WITH JET PROPULSION ENGINE), there is described a flotation (lift) method by a bias of a gas stream discharged from a turbo fan engine with a high bypass ratio (Pegasus Engine: ROLLS-POYCE PEGASUS of Jane's AERO-ENGINES ISSUE 5), such as Harrier fighter attacker (JANE'S ALL THE WORLD'S AIRCRAFT 1993-94 pp. 389-391 “BAe HARRIER/BAe SEA HARRIER”). Moreover, in “The JET ENGINE” (1986 fifth edition) edited by Rolls-Royce plc and FIG. 18-18 of p. 197 of “THE JET ENGINE” issued by Japan Aeronautical Engineers' Association, which is its translational book, a method by RCS (Reaction Control System) with swooshing of compressed air extracted from the Pegasus engine is described.

1.2 There are described a lift method by both of a turbo fan engine with a low bypass ratio (R-79-300 of Jane's AERO-ENGINES ISSUE 6) having the exhaust direction control nozzle of U.S. Pat. No. 3,429,509-B (COOLING SCHEME FOR A THREE BEARING SWIVEL NOZZLE) and a turbo jet engine specified for lift (RD-60 of Jane's AERO-ENGINES ISSUE 6), and a reaction control method by swooshing of compressed air extracted from the turbo fan engine, such as a free style fighter (YAKOVLEV Yak-141 of JANE'S ALL WORLD'S AIRCRAFT 1993-94 pp. 336-337).

1.3 In U.S. Pat. No. 5,209,428 (PLOPULSION SYSTEM FOR A VERTICAL AND SHORT TAKEOFF AND LANDING AIRCRAFT) and U.S. Pat. No. 5,275,356 (PLOPULSION SYSTEM FOR A V/STOL AIRCRAFT), there are described a lift method by both of a turbo fan engine with a low bypass ratio (see, PRATT& WHITNEY F119 of R-79-300 of Jane's AERO-ENGINES ISSUE 5: the mass production model is F135) having a exhaust direction control nozzle and a fin specialized for lift driven by the engine, and a reaction control method by swooshing of compressed air extracted from the turbo fan engine, such as an ASTOVL (Advanced Short Takeoff and Vertical Landing) version of Joint Strike Fighter (JSF) (see, LOCKHEED MARTIN X-35 AND JOINT STRIKE FIGHTER of JANE'S ALL THE WORLD'S AIRCRAFT 1999-2000 pp. 681-683).

The body described in item 1.1 above has been the V/STOL (Vertical/Short Take-Off and Landing) fixed-wing aircraft put into practical use for the first time in the world. However, the speed of exhaust gas flow of Pegasus engine, which is a turbo fan engine with a high bypass ratio, is small for supersonic flight, and hence, can be operated only in subsonic flight. For the solution, the body of 1.2, which has become the world's first supersonic V/STOL fixed-wing aircraft, has been developed. The body has obtained supersonic performance with loading a turbo fan engine with a low bypass ratio with an afterburner. However, noise caused by the high-speed gas flow exhausted by the turbo jet engine (lift engine), high exhaust gas temperature, and bad mileage has become problems. In the body of 1.3, a lift fan driven by a turbo fan engine with a low bypass ratio with an afterburner have been loaded instead of the lift engine, and thereby, the speed and temperature of the exhaust gas flow have been slightly lowered and the mileage has been somewhat improved.

### DISCLOSURE OF THE INVENTION

### Summary of the Invention

In an aspect of the present invention, the vertically movable flying body includes a body and an engine. The engine has a gas generator device for generating a gas by using a raw material for gas generation carried by the flying body, a first thrust device of exhausting the gas in a predetermined direction to generate a first thrust force, and a second thrust device for sucking a surrounding gas and accelerating and exhausting the surrounding gas substantially in a direction of exhausting the gas by the first thrust device to generate a second thrust force to be added to the first thrust force.

In another aspect of the invention, the electronic device further includes a voltage detector which detects the first DC supply voltage of the DC power source. When the value of the first DC supply voltage detected by the voltage detector is not higher than a first predetermined threshold value which is higher by a predetermined value than a predetermined output voltage of the DC voltage regulator, the control unit, independently of the operation state of the loading, provides to the switch the second control signal for selecting the first DC supply voltage.

In a further aspect of the invention, the vertically movable flying body comprises a body and a lift engine. The lift engine includes a gas generator device of generating a gas for external work by using a raw material for gas generation, a first thrust device which receives a power by the gas for external work and exhausts the gas for external work in a predetermined direction to thereby generate a first thrust force, and a second thrust device which is driven by the power to take in and compress a surrounding gas and to accelerate and exhaust a flow of the surrounding gas substantially in a predetermined direction of a flow of the gas for external work exhausted by the first thrust device to generate a second thrust force to be added to the first thrust force.

In a further aspect of the invention, the vertically movable flying body comprises a body and a reaction control engine which provides a thrust force to mainly control reaction of the flying body. The reaction control engine has, a gas generator device for generating a gas for reaction control by using a raw material for gas generation, and an ejector which exhausts the gas for reaction control in a predetermined direction to generate a first thrust force, and accelerates a flow of a surrounding gas and exhausts the accelerated surrounding gas substantially in a direction of a flow of the exhausted gas for reaction control to generate a second thrust force to be added to the first thrust force.

### BRIEF DESCRIPTION OF THE DRAWINGS

FIGS. 1A to 10 show a first embodiment of the present invention.

FIGS. 1A-1C show, a top view and a right-half-cut upper section view in takeoff and landing of an aircraft, a side section view in which the aircraft is cut along 1B-1B, and a front view and a front section view in which the aircraft is cut along 1C-1C, respectively.

FIGS. 2A and 2B show vertical section views of a lift engine in an activated state and in a stopped state of aircraft 1a, respectively.

FIG. 2C is an enlarged vertical section view of a right side part of a turbine driven gas generator of the lift engine in the activated state of FIG. 2A.

FIG. 2D is a lower section view along the upper horizontal plane 2D-2D of the lift engine in the stopped state of the FIG. 2B.

FIG. 2E is an upper section view along 2E-2E of the upper horizontal plane 2E-2E of the lift engine in the activated state of FIG. 2A.

FIG. 2F is a lower section view along the lower horizontal view 2F-2F of the lift engine of FIG. 2A.

FIG. 2G is an upper plane view showing a fully open state and a fully closed state of an inlet movable louver of the lift engine.

FIG. 2H is a lower plane view showing a fully open state and a fully closed state of an exhaust direction control louver of the lift engine.

FIG. 2I shows a bottom view showing a state in which an exhaust gas from the lift engine is subjected to a reaction force of the reverse rotational direction.

FIG. 2J is a lower plane view showing a state in which the exhaust gas from the lift engine is direction-controlled and subjected to a reaction force of the reverse direction.

FIGS. 3A and 3B are a vertical and horizontal section views, respectively, showing an activated state of a reaction control engine of the aircraft.

FIG. 4A is a side plan view showing the movement around pitch axis of the aircraft.

FIG. 4B is a top view showing an example of the movements around yaw axis of aircraft 1a.

FIG. 4C is a front view showing the movement around roll axis of the aircraft.

FIGS. 5A and 5B are a side view and an upper view showing backward and forward movement of the aircraft.

FIG. 5C is a front view showing rightward and leftward movement of the aircraft.

FIG. 5D is a top view showing the rightward and the leftward movement of the aircraft.

FIGS. 5E and 5F are a front view and a side view showing moving up and down of aircraft 1a.

FIG. 6A-6C are a top view, a side view, and a front view in a ground alert state of the aircraft on which an in-air refilling probe 126a for refilling an oxider in the air, an in-air refueling probe for refilling a fuel in the air, external oxider tanks, and external fuel tanks are loaded.

FIGS. 7A to 7C illustrate a top view, a side view, and a front view in a state in which one lift engine is stopped in vertical takeoff and landing of aircraft 1a.

FIGS. 8A and 8B are a side view and a top view containing a partial section useful for explaining vertical takeoff and landing of the aircraft.

FIG. 8C is a side view containing a partial section useful for explaining vertical takeoff and landing of the aircraft.

FIG. 9A is a side view showing a method for operating the aircraft as a VTOL body.

FIG. 9B is a side view showing a method for operating the aircraft as an STOLVL body.

FIG. 9C is a method for operating the aircraft as a VTOL body when the body receives refueling or refilling in the air in a flight.

FIG. 9D is a side view showing a method for operating the aircraft as a VTOL body utilizing external oxider tank and external fuel tank.

FIG. 9E is a side view showing a method for operating the aircraft as a VTOCL body performing maneuver the like;

FIG. 9F is a side view showing a method for operating the aircraft as a CTOL body.

FIG. 10 is a block diagram of fluid and electric system of the aircraft.

FIGS. 11A to 14 show a second embodiment.

FIGS. 11A to 11C show a top view and a right-half-cut upper section view in takeoff and landing of an aircraft, a side section view in which the aircraft is cut along 11B-11B, and a front view and a front section view in which the aircraft is cut along 11C-11C, respectively.

FIG. 12A shows vertical section views of a lift engine in an activated state of aircraft 1b.

FIG. 12B is an enlarged vertical section view of a right side part of a turbine driven gas generator of the lift engine in the activated state of FIG. 2A.

FIGS. 13A and 13B are a vertical section view and a horizontal section view showing an activated state of a reaction control engine of the aircraft.

FIG. 14 is a block diagram of fluid and electric system of the aircraft.

FIGS. 15 to 22 show a third embodiment of the invention.

FIGS. 15A-15C are a top view and a right-half-cut top view in ground alert of the aircraft, a side section view in which the aircraft is cut along 15B-15B, and a front view and a front section view in which the aircraft is cut along 15C-15C, respectively.

FIG. 16A shows a vertical section view of a lift engine of the aircraft in an activated state.

FIG. 16B is an enlarged vertical section view of a right side part of a turbine driven gas generator of the lift engine in the activated state of FIG. 16A.

FIG. 16C is a partial lower section view of a turbine driven gas generator of the lift engine in the activated state of FIG. 16A, in which the gas generator is cut along 16C-16C.

FIG. 16D is a top view showing an attachment part of the lift engine to the aircraft.

FIG. 17 is a vertical section view showing an activated state of a reaction control engine of the aircraft.

FIGS. 18A-18C show a vertical takeoff and landing in a ground and the like of an aircraft to which another aircraft is fixed.

FIG. 19A is a side view showing the movement around pitch axis of the aircraft to which another aircraft is fixed.

FIG. 19B is a front view showing the movement around roll axis around the aircraft to which an aircraft is fixed.

FIGS. 19C and 19D are a top view and a side view showing an example of the clockwise movement of nose around yaw axis of the aircraft to which an aircraft is fixed.

FIGS. 19E and 19F are an upper view and a side view showing an example showing an example of the counterclockwise movement of nose around yaw axis of aircraft 1c to which an aircraft 380 is fixed.

FIG. 20A is a side view showing forward movement of the aircraft to which an aircraft is fixed.

FIG. 20B is a side view showing backward movement of the aircraft to which an aircraft is fixed.

FIG. 20C is a front view showing rightward movement of the aircraft to which an aircraft is fixed.

FIG. 20D is a front view showing leftward movement of the aircraft to which an aircraft is fixed.

FIG. 20E is a front view showing moving up of the aircraft to which an aircraft is fixed.

FIG. 20F is a front view showing moving down of the aircraft to which an aircraft is fixed.

FIGS. 21A and 21B are side views useful for explaining vertical takeoffand landing of, the aircraft being capable of detaching from and attaching to a flying body and of vertically taking off and landing, and an aircraft.

FIG. 22 is a block diagram of fluid and electric system of the aircraft.

FIGS. 23 to 30 show fourth embodiment of the invention.

FIGS. 23A-23C show a top view and a right-half-cut upper section view in taxing of the aircraft being capable of taxing and vertically taking off and landing, a side section view in which the aircraft is cut along 23B-23B, and a front view and a front section view in which the aircraft is cut along 23C-23C, respectively.

FIGS. 24A-24C show, a top view and a right-half-cut upper section view in takeoff and landing of the aircraft, a side section view in which the aircraft is cut along 24B-24B, and a front view and a front section view in which the aircraft is cut along 24C-24C, respectively.

FIGS. 25A-25C show, a top view and a right-half-cut upper section view in a flight state of the aircraft, a side section view in which the aircraft is cut along 25B-25B, and a front view and a front section view in which the aircraft is cut along 25C-25C, respectively.

FIGS. 26A-26C are a vertical section view and a horizontal section view of the lift engine in an activated state of the aircraft.

FIG. 27A is a side view showing the movement around pitch axis of the aircraft.

FIGS. 27B-27D are a top view, a side view, and a front view showing the clockwise movement of nose around yaw axis of the aircraft.

FIGS. 27E-27G are a top view, a side view, and a front view showing the counter clockwise movement of nose around yaw axis of the aircraft.

FIG. 27H is a front view showing the movement around roll axis around the aircraft.

FIGS. 28A and 28B are a side view and a top view showing forward movement of the aircraft.

FIGS. 28C and 28D are a side view and a top view showing backward movement of the aircraft.

FIGS. 28E and 28F are a front view and a top view showing the rightward movement of the aircraft.

FIGS. 28G and 28H are a front view and a top view showing a left movement of the aircraft.

FIGS. 28I and 28J are a front view and a side view showing moving up of the aircraft.

FIGS. 29A and 29B are explanatory views useful for explaining vertical takeoff and landing of the aircraft.

FIG. 30 is a block diagram of fluid and an electric system of the aircraft.

FIGS. 31A to 36 show a fifth embodiment of the invention.

FIGS. 31A-31C are an upper view and a right-half-cut upper section view in vertical takeoff and landing in a ground and the like of the aircraft that a lift engine and a flight engine are integrated with, a side section view in which the aircraft is cut along 31B-31B, and a front view and a front section view in which the aircraft is cut along 31C-31C, respectively.

FIGS. 32A and 32B are horizontal section views useful for explaining operations of a lift and flight engine and its related components in a vertical takeoff and landing state and a flight state of the aircraft.

FIGS. 33A and 33B are a vertical section view showing operation state of a reaction control engine of the aircraft and a vertical section view showing in another section along 33B-33B.

FIG. 34A is a side plan view showing the movement around pitch axis of the aircraft.

FIGS. 34B-34D are a top view a side view and a front view showing an example of the clockwise movement of nose around yaw axis of the aircraft.

FIGS. 34E and 34F are a top view and a side view showing an example of the counterclockwise movement of nose around yaw axis of the aircraft.

FIG. 34G is a front view showing an example of the counterclockwise movement of nose around yaw axis of the aircraft.

FIG. 34H is a side view showing the movement around roll axis of the aircraft.

FIG. 35A is a side view showing forward movement of the aircraft.

FIG. 35B is a side view showing backward movement of the aircraft.

FIG. 35C is a front view showing rightward movement of the aircraft.

FIG. 35D is a front view showing a leftward movement of the aircraft.

FIG. 35E is a front view showing rising movement of the aircraft.

FIG. 35F is a front view showing lowering movement of the aircraft.

FIG. 36 is a block diagram showing fluid and electric system of the aircraft.

FIGS. 37A to 40 show a sixth embodiment.

FIGS. 37A and 37B show a side view and a top view in launching of a rocket booster and a rocket, respectively.

FIG. 38 is a side section view of the rocket booster in an activated state.

FIG. 39 is a side view useful for explaining a method for launching the rocket booster and the rocket.

FIG. 40 is a block diagram of fluid and electric system of the rocket booster.

FIGS. 41A to 44 show a seventh embodiment of the invention.

FIGS. 41A-41B show a side view and a top view in launching a first stage of rocket and second or more stages of rocket, respectively.

FIG. 42 shows a side section view of a first stage of rocket in an activated state.

FIG. 43 is a side view useful for explaining a method for launching the first stage of rocket and the second-stage rocket.

FIG. 44 is a block diagram of fluid and electric system of the first stage of rocket.

FIGS. 45A to 49 show an eighth embodiment.

FIGS. 45A and 45B are a side view and a top view in launching space shuttle vehicle 1h.

FIG. 46A is a side section view of the space shuttle vehicle in waiting for launching in a ground and the like.

FIG. 46B shows side section views of an inner-space subsonic-speed flight (left of the view) and an inner-space transonic-speed flight (right of the view) of the space shuttle vehicle.

FIG. 46C shows side section views of the space shuttle vehicle in an inner-space supersonic-speed flight state (left side) and an outer-space flight state (right side).

FIG. 46D shows side section views of the space shuttle vehicle in an outer-space payload-unloaded state (left) and an atmospheric reentry state (right).

FIG. 47A is a side view useful for explaining launching of the space shuttle vehicle.

FIG. 47B is a side view useful for explaining landing back of the space shuttle vehicle.

FIG. 47C is a side view useful for explaining landing back of the space shuttle vehicle in emergency.

FIGS. 48A and 48B are a vertical section view showing an activated state of a reaction control engine of the space shuttle vehicle and a vertical section view in another section along 48B-48B.

FIG. 49 is a block diagram of fluid and electric system of the space shuttle vehicle.

### DESCRIPTION OF THE PREFERRED EMBODIMENTS

A conventional fixed-wing flying body performing Conventional Take-off and Landing (CTOL), which belongs to an aircraft out of the flying bodies, has the following specific problems.

2.1 Because a speed for generating a lifting power by wing is required, a long and large airstrip for takeoff and landing are required. Thus, because a vast ground is required for construction of an airport, it is difficult to provide the airport in an urban area which is the most convenient, and the airport is occasionally provided in a suburb. The trouble of moving to the airport degrades convenience and speediness of the aircraft.

2.2 Because the speed in takeoff and landing is slow, the flying body is poor in an aerodynamic restorative force or a control force and is unstable. Thus, risk of causing an accident in takeoff and landing is high (critical eleven minutes).

2.3 Because the speed in takeoff and landing is small, time required for takeoff and landing is long. Moreover, because intervals of takeoff and landing between aircrafts should be separated to an extent, the number of the aircrafts being capable of taking off and landing per unit of time is limited. Thus, airspace around a main airport is being always congested. Additionally, boarding time is long, and comfort and speediness of boarding people is degraded.

2.4 In order to shorten a length of an airstrip and time required for takeoff and landing as much as possible, the CTOL fixed-wing flying body repeats rapid acceleration and deceleration per a flight. Thus, comfort of boarding people is degraded, and a life time of the body is shortened. Moreover, because frequent maintenance becomes required, the maintenance cost becomes high.

On the other hand, the above-described VTOL (Vertical Take-Off and Landing) fixed-wing flying body, which has been put into practical use for military affair and additionally for limited application, has the following specific problems.

2.5 Because the flying body is floated by a jet engine, the vertical takeoff and landing system becomes complex, and the flying body requires control such as an advanced engine or RCS of avoiding surge or stall of the engine and therewith synchronizing the body movement. Thus, handling or response is bad and the production cost is high.

2.6 Because the takeoff and landing system is complex, the probability of breakdown is high and risk is high. Moreover, because advanced maintenance is required, the maintenance cost is high.

2.7 Because shafts or ducts are disposed in the body, it is difficult to freely dispose equipment or payload and the degree of freedom of design is low.

2.8 Because hot exhaust gas is exhausted downward, the place for takeoff and landing is limited to airstrips and the like which are subjected to measures for preventing meltdown and have heat-resistance, and the degree of freedom of selecting the place for takeoff and landing is poor.

2.9 Because hot exhaust gas exhausted from the flying body itself is dispersed up near the ground, decrease of flotage due to Hot Gas Ingestion (HGI) of ingesting the hot exhaust gas again in itself, and the risk is high.

2.10 Because a combusted gas having a small oxygen content exhausted by itself, the gas is ingested again in itself, the oxygen amount becomes short and the combustion cannot be continued, and the risk that the engine is suddenly stopped is high.

2.11 Because a compressed air used for RCS of the flying body is extracted from the engine, degradation of the power output causes decrease of excess flotage. Thus, the payload becomes small and the economic property is bad.

Moreover, in conventional helicopters and the like which are rotary-wing aircrafts being capable of vertically taking off and landing, there are the following specific problems.

2.12 Because the rotor and the like is exposed and rotated, the aircrafts are weak in involvement of foreign objects such as an electric cable, and the operation environment is limited.

2.13 Because the rotor and the like during rotation have a large energy, the damage thereof has a high risk of causing a large disaster in the circumference.

2.14 Because it is difficult that a person approach the aircraft during rotation of the rotor and the like, it is difficult to rapidly unload persons or cargo or the like, and convenience is degraded.

2.15 Because low-frequency noise is generated by the rotation of the rotor and the like, comfort of the boarding people is degraded, environment or time for the operation is also limited.

2.16 Because the disc loading of the rotor and the like is small, there is a risk of charging into a vortex ring state, in which all of the control becomes impossible, in drastic movement. Thus, there is difficulty in mobility.

2.17 When the rotation plane of the rotor and the like corresponds approximately to the direction of the flight, there is limitation in tip speed of the rotor and the like, and thus, the flight speed has an upper limit. Thus, high-speed movement is impossible.

2.18 Because power of driving the rotor and the like is constantly required, consumption of fuel is inventive. Thus, the operation cost is high and the flying range is small.

2.19 Because travel by Instrument Flight Rule (IFR) is not sufficiently functioned and travel by Visual Flight Rule (VFR) is in large part, it is difficult to travel in bad weather or in night. Thus, environment or time for the operation is limited.

2.20 In particular, in Japan, because defects and the like of equipment and institution such as a heliport, landing near a hospital to which urgent patients and the like cannot be conveyed and an accident site is not occasionally permitted. Thus, Emergency Medical Service (EMS) framework is not sufficiently made, and penetration of helicopters is also low.

On the other hand, in the conventional VTOL flying bodies including the fixed-wing flying bodies and the rotary-wing aircrafts, there are the following specific problems.

2.21 In the fixed-wing flying bodies, there is only one engine of generating a main trust force, and also, RCS depends on the engine. Moreover, in the rotary-wing aircrafts, although a plurality of engines can be disposed, there is only one main component required minimally for flight such as a main rotor and a tail rotor. Thus, because failure of these flotage-generating devices leads to a serious accident such as lost of the rust force and control, the risk is high.

2.22 Because mobility control of the body using an air, time lag of the response is generated by the compressibility. Thus, the response is bad and the body cannot address outer rapid disturbance in a bad weather of gust and the like blowing or in swing of the containing cage and the like.

Furthermore, in a conventional aircraft including the CTOL body and the VTOL body, there are the following specific problems.

2.23 Because combustion is performed with sucking an air, oxygen concentration in the exhaust gas decreases and nitroxide concentration increases. Thus, the global environment degrades.

2.24 Because an air compressor constituted by fine channels is required, the aircraft is vulnerable to Foreign Object Damage (FOD) due to aspiration of foreign object, which is occasionally caused near the ground. Thus, the operation can be performed only in a place limited to airstrips and the like maintained to be clean so that FOD is not generated, and the operation environment is limited.

2.25 Because a power for compressing an air in starting the engine is required, when the engine is suddenly stopped, it is difficult to quickly restart the engine and the risk is high.

2.26 When temperature of the sucked air is high, because Turbine Inlet Temperature (TIT) is set to be constant, the fuel charge amount decreases, and thus the output power degrades. Accordingly, operation in a hot region is limited.

2.27 When density of the sucked air is low, because the amount of the air taken in decreases, the fuel charge amount decreases, and thus the output power degrades. Thus, operation in a high altitude is limited.

In a conventional rocket belonging to a spacecraft out of flying bodies, there are the following specific problems.

2.28 In particular, a large amount of air contaminant or toxic gas is contained in exhaust gas from a solid rocket, and the contaminant and the gas are exhausted to an atmosphere, frequency of launching is limited. Moreover, the effect of the toxic exhausted gas on the upper air having small circulation movement of the air is serious.

2.29 Because most of the rockets are used once and thrown away, a new rocket should be produced in every launching, rare resources are consumed away. Thus, the earth's environment degrades.

2.30 Because a new rocket should be produced every time, the production cost is high

2.31 Because most of the rockets are multi-stage systems and each of the stages is cut off after consuming a propellant and discarded sequentially, a large amount of dust are generated on the ground or in outer space, and the environment of earth or outer space is degraded. In particular, dust on a circumearth orbit is referred to as space debris, and crash at the dust has become a serious threat of causing destruction or loss in function of an artificial satellite, International Space Station (ISS), and the like.

2.32 When launching is failed, most of parts of the accident body cannot be collected, and thus, it is difficult to investigate and analyze the accident body to determine the cause of the trouble or to take preventive steps. Thus, the determination of the cause of the accident requires long time. Moreover, safety-foreseen design should be performed, and hence, the production cost.

2.33 Because the effect of the loss of gravity is suppressed to be minimum, the rocket is designed to reach outer space in a short time. Because large acceleration is applied to the rocket in the time, a large forced is applied to equipment, loaded payload, and the like. Accordingly, because the equipment, the payload, and the like require sufficient strength, increase of weight of the rocket or the payload is caused and the production cost is high.

2.34 Because the rocket moves at high speed, it is difficult to escape, collect, or the like in emergency, and hence, the risk is high.

2.35 Because the rocket moves at high speed, adjustment in the case of deflecting from the predetermined flight pathway is difficult, and the adjustment is failed, explosion and the like of the rocket itself is performed. Thus, in launching, the predetermined flight pathway is required to be clear, and communication to related countries and measures for preventing fishing crafts and the like from approaching the surrounding ocean area become required. In this case, because fishing compensation and the like are required, the operation cost increases. Moreover, the launching period is occasionally limited, depending on the harvest season, and rapid response is lacked.

2.36 Because the rocket moves at high speed in the air, the air resistance is large and driving energy is lost, and hence, the loadable payload is limited and the operation cost is high.

2.37 In order to reduce the air resistance as much as possible, shape of the rocket is limited to ones having the resistance, and degree of freedom of the design is poor.

2.38 Because the rocket moves at high speed, vibration is caused by friction with the air, and hence, sufficient vibration-proof measures are required for the equipment, the payload, and the like. This leads to increase of mass of the rocket or the payload, and the production cost is high.

2.39 Because the rocket is a complex system, launching place which is a complex facility for sufficiently exerting the function for launching is required. Because the construction and maintenance of the launching place require massive dose of funds, the construction cost and the maintenance cost is high.

2.40 Because the exhaust gas speed of the rocket is large, propulsion efficiency in an initial stage of launching is extremely bad and a large amount of propellant is required. Thus, loaded amount of the propellant or the body size is large.

Finally, in the flying bodies including the aircrafts or the spacecrafts, there are the following specific problems.

2.41 Because all the troubles should be addressed alone if troubles are caused in the engine or the wing or the like or serious failure such as loss of the thrust or the lifting power, safely going back and the like are extremely difficult. Accordingly, the risk is high.

2.42 Because the exhaust gas is at high speed, radio-frequency noise is generated, and hence, construction of airports or launching places, flight airspace and the like are limited.

2.43 Because temperature of the exhaust gas is high, radiation of Infra-Red (IR) is intensive. Thus, the body is easily set to be the target of a cheap IR guided weapon, and the survival rate is small.

It is desirable to provide a flying body which is capable of vertically taking off and landing so as to overcome all or part of the above problems.

An object of the present invention is to solve a problem or problems described above and to provide a safer flying body.

According to the invention, a safer flying body can be provided.

The invention is applicable to flying bodies of an aircraft capable of vertically taking off and landing, an aircraft capable of vertically taking off and landing that is detachable from a flying body, an aircraft capable of vertically taking off and landing which has a lift engine integrated with a flight engine, a rocket booster, a first stage of a rocket, and a space plane.

Embodiments of the invention will be described below with reference to drawings. It should be understood that shape, size, relative position and the like of components described in the embodiments are not intended to limit the scope of the invention and are merely examples. Devices or the like used in one embodiment may be combined with another embodiment, and a device other than the illustrated devices which has an equal function to any of the devices may be used.

### First Embodiment

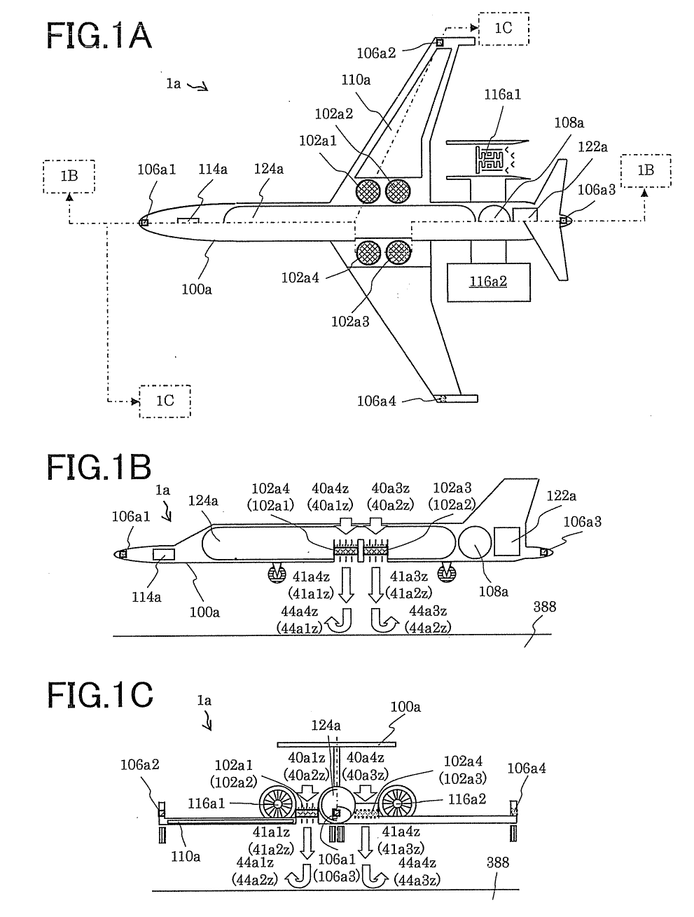

FIGS. 1A-1C show, a top plan view with a partially cut upper section of an aircraft capable of vertically taking-off and landing, a side sectional view of the aircraft cut along 1B-1B, and a front view with a partially cut a front section of the aircraft cut along 1C-1C, respectively, according to the first embodiment of the invention. Aircraft 1a has body 100a including general components such as flight engines 116a1-116a2, auxiliary power unit 122a, payload 124a, and fuel tank 110a, which are known. The aircraft further has short cylinder-shaped lift engines 102a1-102a4, reaction control engines 106a1-106a4 each having a shape of combination of two orthogonal cylinders, sphere-shaped oxider tank 108a, and rectangular-parallelepiped-shaped computer 114a, according to the invention.

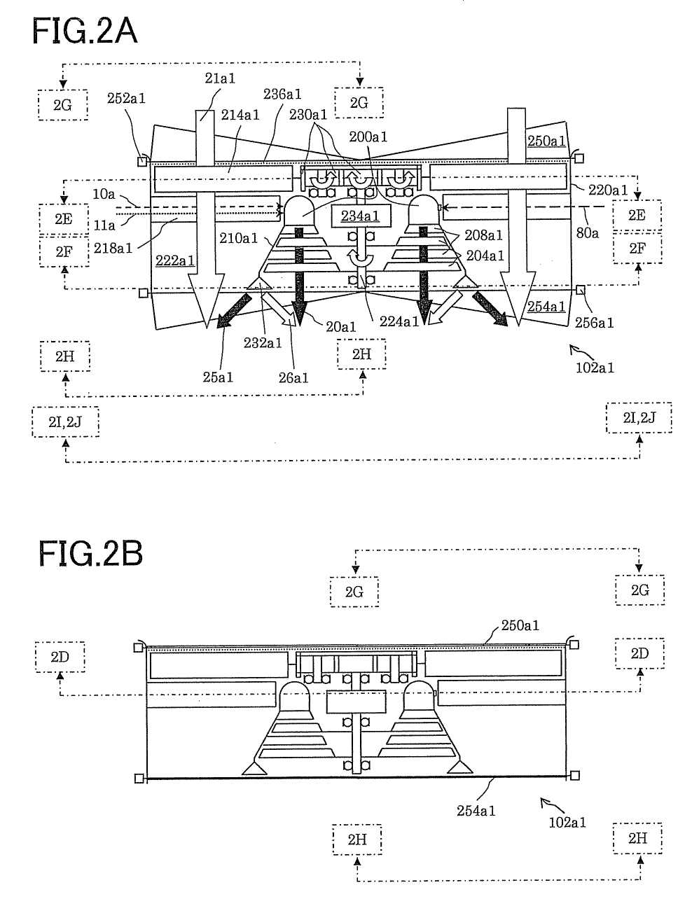

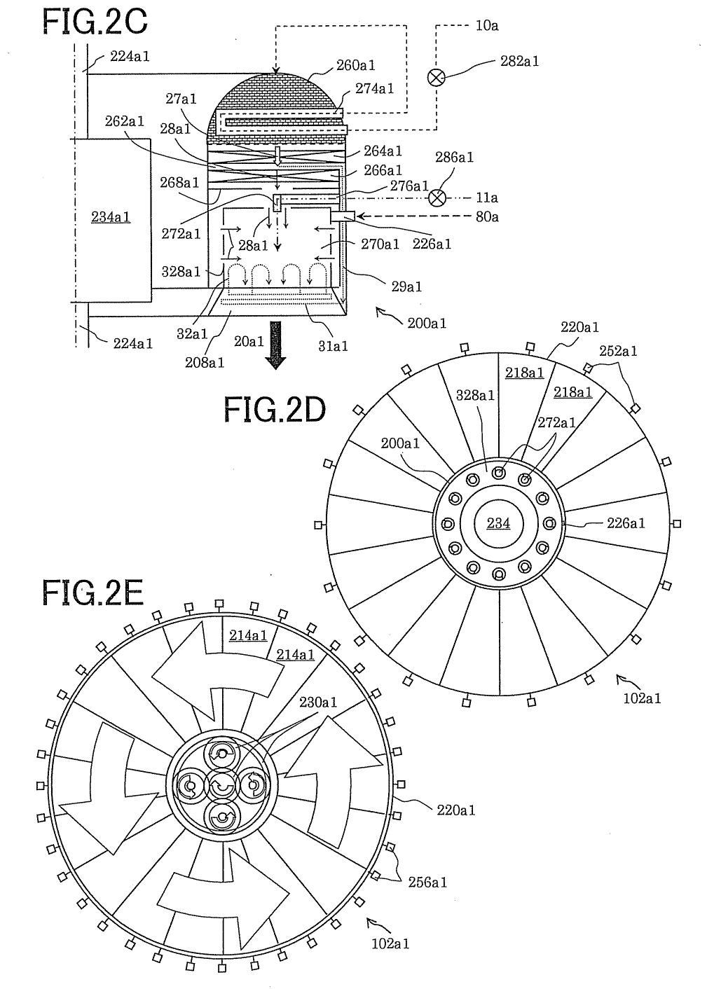

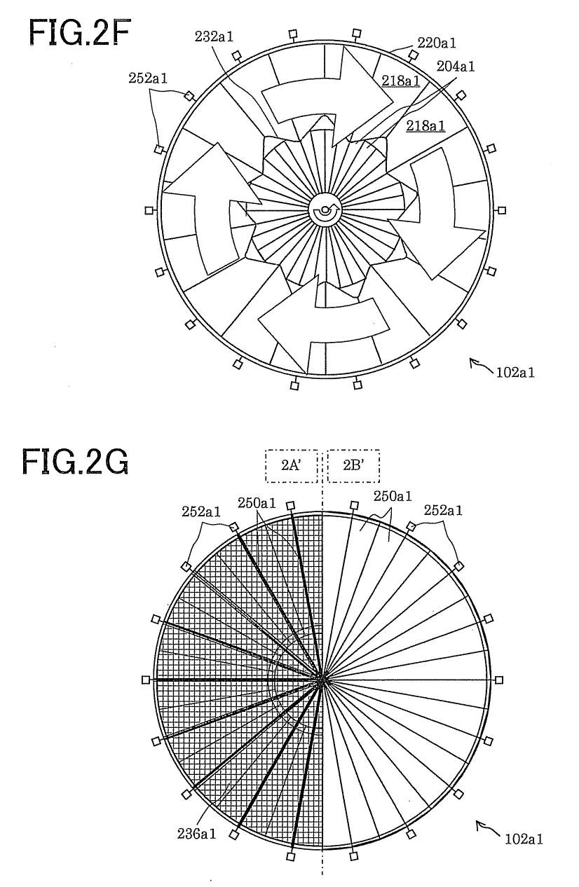

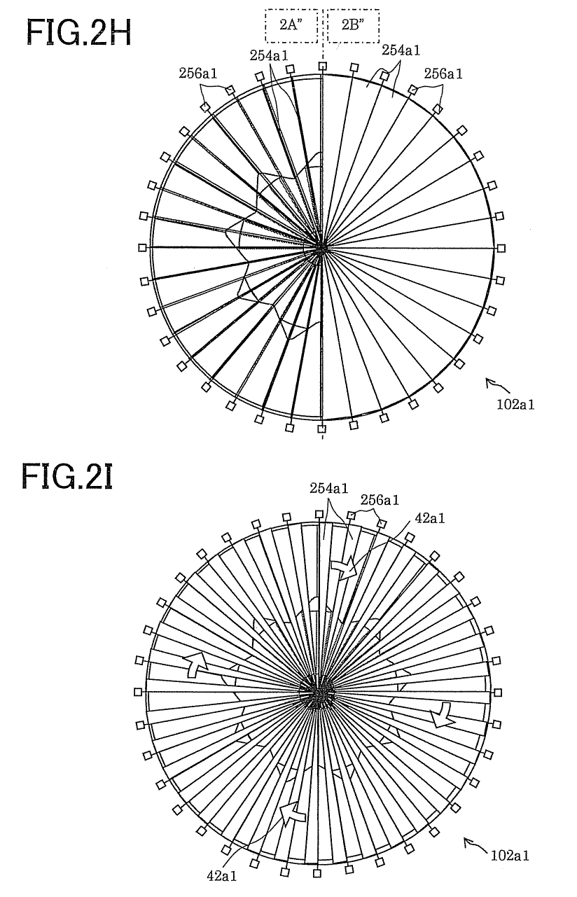

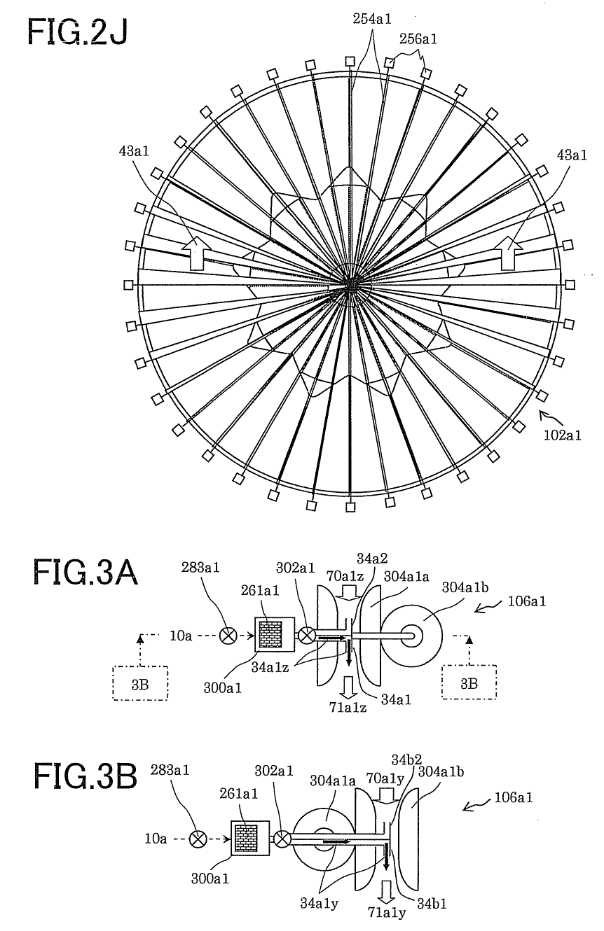

When aircraft 1a vertically takes off and lands, flight engines 116a1-116a2 are set to be stopped or to be in an idle state, and surrounding airs 40a1z-40a4z indicated by the white wide arrows are sucked along with performing detailed reaction control mainly by reaction control engines 106a1-106a4, and accelerated gas flows 41a1z-41a4z indicated by the white arrows along with performing rough reaction control, and the aircraft floats by the reactive force. In particular, exhaust gas flows 41a1z-4a4z reaching a non-maintained plain and the like 388 are dispersed up as gas flows 44a1z-44a4z indicated by white arrows containing foreign objects such as dust, sand granules, gravel stones, and ices, and occasionally, some of the foreign objects are sucked into lift engines 102a1-102a4 with airs 40a1z-40a4z. However, differently from general jet engines, as described later in FIG. 2, the lift engines 102a1-102a4 do not require to subject the sucked surrounding airs 40a1-40a4 to high-pressure compression and combustion, and the airs are used as media for merely providing momentum, and hence, the performance are not degraded drastically by respiration of the hot gas and the gas with small oxygen content. Moreover, because high-pressure pressurization compressor whose channel is narrow and fine is not required, the aircraft is extremely strong against FOD. In aircraft 1a, a plurality (four in the example) of independent lift engines 102a1-102a4 and a plurality (four in the example) of independent reaction control engines 106a1-106a4 are provided.

When aircraft 1a makes a flight, lift engines 102a1-102a4 and reaction control engines 106a1-106a4 becomes in a stopped state, and flight engines 116a1-116a2 are activated to obtain a thrust force of the forward direction, and thereby, the aircraft can make a flight at high speed by IFR as well as a general fixed-wing flying body.

As described above, it is not preferable in a conventional technique that lift engines 102a1-102a4 and reaction control engines 106a1-106a4, which are used mainly in vertical takeoff and landing, are loaded with flight engines 116a1-116a2 because the engines being not in use become a dead weight. However, lift engines 102a1-102a4 and reaction control engines 1061a-106a4 in the invention are small in size and weight as described later in FIG. 2 and FIG. 3, and the vertical takeoff and landing system is simple and it is easy to switch vertical takeoff and landing and general fRight, and self-contained turbine driven gas is momentarily consumed to be light, and hence, the aircraft has the surplus advantage with compensating the disadvantage. Furthermore, transition flight from the vertical takeoff and landing state to the flight state is easy, and there is also an advantage that two takeoff and landing modes, namely, the vertical takeoff and landing and general takeoff and landing such as a general aircraft can be freely selected.

FIGS. 2A and 2B show vertical section views of lift engine 102a1 in an activated state and in a stopped state of aircraft 1a, respectively. Lift engines 102a2-102a4 have the same structure as lift engine 102a1. In the view, fundamentally, the structure of lift engine 102a1 is rotational symmetry, for making the view concise, the same serial symbols are appended to the same respective components. Lift engine 102a1 has, an annular turbine driven gas generator 200a1 which has a vertical central axis of generating gas 20a1 for driving the turbine indicated by the black arrow and which has an annular opening, a plurality of coaxial radial turbine stator blades 208a1 for accelerating and turning gas 20a1, a plurality of coaxial radial turbine rotor blades 204a1 for taking mechanical work out of gas 20a1, coaxial truncated-cone-shaped turbine case 210a1 for preventing the broken pieces from scattering outside the engine if turbine rotor blade 204a1 is broken and scattered, a plurality of coaxial radial fan rotor blades 214a1 for sucking and accelerating the surrounding air, a plurality of coaxial radial fan stator blades 218a1 for converting speed of sucked air 21a1 indicated by the white arrow to pressure, coaxial cylindrical fan case 220a1 for preventing the broken pieces from scattering outside the engine if fan rotor blade 214a1 is broken or scattered, nozzle 222a1 which is provided in fan case 220a1 and which is formed between the coaxial cylinder (fan case 220a1) and the truncated cone (turbine case 210a1) and in which opening area of the bottom face is smaller than the opening area of the top face for accelerating air 21a1, shaft 224a1 on the central axis rotated by turbine rotor blade 204a1, transmission 230a1 in which gears and the like are combined to be rotational symmetry for transmitting the rotation from shaft 224a1 to fan rotor blade 214a1, radially-rippling folded robe-shaped mixer 232a1 for mixing some of gas 20a1 driving the turbine and some of sucked air 21a1 to equalize temperature and speed of the exhaust gas, columnar rotation control motor and electrical generator 234a1 which are activated as an electric generator or electric motor, netty foreign-object suction prevention net 236a1 for preventing large incoming objects from being sucked into fan rotor blade 214a1, a plurality of fan-shaped inlet-movable louvers 250a1 disposed in a radial shape which form upper faces of the wing and body 100a in storage and which form the pathways for sucked air 21a1 in expansion, a plurality of columnar inlet-movable-louver driving actuator 252a1 for driving the inlet-movable louvers 250a1, a plurality of fan-shaped exhaust-direction control louvers 254a1 disposed in a radial shape which form lower faces of the wing and the body in storage and which form pathways for exhaust gas 41a1 and individually and freely control the exhaust directions in expansion, and a plurality of columnar trust-direction-control-louver driving actuators 256a1 for driving thrust direction control louvers 254a1. In short, the lift engine 102a1 drives the turbine by gas generator system or device 200a1 to be described later and the gas from gas generator system 200a1 to obtain the power, and therewith exhausts the exhaust gas to a predetermined direction to utilize the gas for the thrust force, namely, the lift engine has, the first thrust system for obtaining the power along the way from the gas 20a1 for external work indicated by the black arrow and exhausts the gas, and the second thrust system for exhausting air 21a1 indicated by the white arrow, which is the surrounding gas sucked by the power, to the approximately same direction as the exhausting direction of the gas 20a1 to make the thrust force.

In FIG. 2A, gas 20a1 generated by reaction of oxider 10a and fuel 11a in gas generator 200a1 with receiving ignition signal 80a passes through the turbine 204a1 and 208a1, and thereby, the energy of the gas is given to the turbine rotor blades 204a1, and the gas itself becomes in a low-temperature and low-pressure state and reaches mixer 232a1. Turbine rotor blades 204a1 rotates shaft 224a1 to the direction of the white arrow to drive rotation control motor and electrical generator 234a1 and transmission 230a1. Transmission 230a1 rotates to the direction of the white arrow, and rotation of shaft 214a1 is decelerated and highly torqued to be transmitted to fan rotor blades 214a1. The fan 214a1 and 218a1 sucks and compresses air 21a1 passing through inlet-movable louver 250a1 and foreign-object suction prevention net 236a1. The air 21a1 is accelerated by nozzle 222a1 and reaches mixer 232a1. In mixer 232a1, some of gas 20a1 driving turbine and some of air 21a1 passing through the fan channel (25a1, 26a1) are mixed, and temperature and speed of the gas are more decreased, and a large amount of low-speed gas flow is formed and exhausted from lift engine 102a1.

As an advantage of exhausting a large amount of air 21a1 at low speed by a small amount of turbine driven gas 20a1 to obtain the flotage, lit engine 102a1 is more economical, has higher propulsion efficiency, and causes less noise and less contamination of environment due to exhaust of air contaminant than those of a conventional rocket exhausting a large amount of gas at high speed, in the range of air existing. Furthermore, some of turbine driven gas 20a1 and air 21a1 are mixed by mixer 232a1, and additionally, turbine driven gas 20a1 of small amount, high temperature, and high speed is rolled up with air 21a1 of large amount, low temperature, and low speed, and thereby, noise can be reduced and exhaust gas temperature can be low. By such low-noise characteristics, aboveground noise-suffering area in takeoff and landing near airports and the like can be drastically smaller than that of an existing aircraft. As means for exhausting a large amount of air 21a1 at low speed, as well as a method similar to the turbo fan engine with a high bypass ratio, it is possible to use another means such as, turboprop in which the fan is replaced to propeller, or compressor.

Lift engine 102a1 is operated in a state in which inlet movable louver 250a1 and exhaust direction control louver 254a1 are in open states, the direction of the thrust can be freely changed with variously controlling the direction of the exhaust gas by radially-disposed exhaust direction control louver 254a1.

Because turbine rotor blade 204a1 and fan rotor blade 214a1 of lift engine 102a1 are surrounded by turbine case 210a1 and fan case 220a1, there is no fear of, involvement of an electric cable and the like, surrounding damage in scattering, generation of low-frequency noise, and the like, and a person and the like can be loaded and unloaded, quickly.

Because the disc loading is larger than that of helicopter and the like, it is difficult to cause vortex ring, and rapid mobility can be performed in takeoff and landing.

In a conventional technique, there is caused a self-exiting phenomenon that stall or surge of the fan or compressor fluctuates amount of the air flown in the combustor, and causes fluctuation of turbine power, and the fluctuation becomes fluctuation of input to the fan or the compressor again and leads to stall or surge of the fan or the compressor. However, in the invention, because air 21a1 passing through the fan 214a1 and 218a1 does not flow in to the turbine 204a1 and 208a1, such self-exiting phenomenon is not caused. Thus, if an incoming object such as a large bird blocks foreign object suction prevention net 236a1 or excess rotation and the like in the rotational system causes stall or surge of the fan 214a1 and 218a1, loading of fan rotor blade 214a1 is reduced and rotation frequency of shaft 224a1 merely increases. Thus, the rotation is appropriately adjusted by loading of rotation control motor and electrical generator 234a1, which is activated as an electric generator, and thereby, safety can be ensured. Furthermore, the rotation control motor and electrical generator 234a1 performs autorotation by controlling the rotation appropriately in emergency, fan rotor blades 214a1 are driven to make a flare and immediately before contact with a ground, by the stored rotation energy or electric power, and thereby, safe landing becomes possible. In the case of a short time, vertical movement can be performed only by electric power.

Moreover, lift engine 102a1 can obtain thrust by reaction force of turbine driven gas 20a1 even in high altitude containing little air.

In a stopped state of FIG. 2B, in lift engine 102a1, aspiration of air 21a1 and generation of gas 20a1 are stopped, and inlet movable louver 250a1 and exhaust direction control louver 254a1 are closed to be a part of the wing and the body, and hence, the lift engine does not cause large resistance against aircraft 1a.

As described above, lift engine 102a1 does not require, a compressor which is essential for a general jet engine and has large weight and large volume, a high-pressure turbine for driving the compressor, and the like, and hence, drastic weight saving and reduction in size become possible, and all of the power obtained from turbine driven gas 20a1 can be used for acceleration of air 21a1.

FIG. 2C is an enlarged vertical section view of a right side part of a turbine driven gas generator 200a1 of the lift engine 102a1 in the activated state of FIG. 2A. Gas generator 200a1 has, cylindrical igniter 226a1 used for ignition of turbine driven gas 20a1, oxider decomposition catalyst 260a1 for lift engine having pathway of generated fluid and tubular oxider heating tube 374a1 therein, liquid separation gas chamber 262a1 formed by a plurality of coaxial radial liquid separate gas swirl vanes 264a1 and a plurality of coaxial radial gas counter-swirl vanes 266a1 and an annular restriction plate 268a1 having a restricted tube, tubular fuel heating tube 276a1, reaction chamber 270a1 formed by a plurality of cylindrical fuel nozzles 272a1 and annular liner having a plurality of openings.

Flow amount of oxider 10a is adjusted by oxider flow control valve 282a1 for lift engine, and then the oxider passes through oxider heating tube 274a1 and performs heat exchange with oxider decomposition of oxider and thereby is preeminently heated, and then decomposed into oxider decomposition. Then, oxider 10a is heated through oxider heating tube 274a1 and reaches liquid separation gas chamber 262a1. Flow 27a1 of oxider decomposition is revolved by liquid separate gas swirl vane 264, and liquid components of large density are separated to periphery (29a1). Oxider decomposition gas 28a1 that is a gaseous component of small density passes through gas counter-swirl vane 266 and thereby the revolved components are cancelled and then, the gas passes through restriction plate 268a1 for generating pressure difference for passing of the separated liquid 29a1 through the tube. Then, fuel 11a whose flow amount is adjusted by fuel flow control valve 286a1 for lift engine heats preliminary fuel-heating tube 276a1 through which the fuel flows, and then the fuel flows into reaction chamber 270a1 in liner 328a1, and the gas reacts with fuel 11a by ignition signal 80a provided by igniter 226a1, and heats turbine stator blade 208a1 and flows out On the other hand, liquid 29a1 contained in oxider decomposition separated in liquid separation gas chamber 262 is subjected to heat exchange with the reactive gas in turbine stator blade 208a1 to be heated (31a1) and then flows into reaction chamber 270a1 (32a1). At this time, when temperature of liquid 31a1 is overheated to saturated vapor temperature or more in the pressure in reaction chamber 270a1, the liquid is quicldy phase-changed into gas immediately after flowing into reaction chamber 270a1. The gas 32a1 is at lower temperature than that of the surrounding reactive gas, and hence heat-shields to roll up turbine stator blade 208a1, and then, the gas is mixed with the reactive gas to become turbine driven gas 20a1 and flow out to the downstream.

As described above, the turbine of lift engine 102a1 is driven by clean turbine driven gas 20a1 separated from surrounding air, and hence, the power can be obtained without being seriously affected by temperature or pressure or contamination degree or the like of the surrounding air, and also the contamination of turbine is small and hence, operating life of the turbine becomes long and Time Between Overhauls (Time Between Overhauls) also becomes long. Consequently, engine 102a1 can be operated in a high altitude and the like with rare atmosphere and in high-temperature region with much dust such as desert and maintenance cost can be reduced. Furthermore, in engine 102a1, flow amounts of the oxider and the fuel can be discretionally set, and the engine can be rapidly boosted and stopped easily, and because the turbine driven gas is directly increased or decreased, the response is good and sudden disturbance can also be sufficiently addressed. Furthermore, in engine 102a1, oxider 10a of liquid and fuel 11a of liquid are used, and hence, because of high density, tube arrangement is easy and the volume is small, the response is good because of no compressibility.

FIG. 2D is a lower section view along the upper horizontal plane 2D-2D of lift engine 102a1 in the stopped state of the FIG. 2B. It can be seen that a plurality of fuel nozzles 272a1 are provided at even intervals on a circumference through the opening of liner 328a1 in turbine driven gas generator 200a1.

FIG. 2E is an upper section view along 2E-2E of the upper horizontal plane 2E-2E of the lift engine 102a1 in the activated state of FIG. 2A. Fan rotor blade 214a1 is driven by transmission 230a1 rotating in the direction of the white arrows.

FIG. 2F is a lower section view along the lower horizontal view 2F-2F of the lift engine 102a1 of FIG. 2A. The shape of mixer 232a1 for mixing the respective gases passing through turbine rotor blade 204a1 and through fan stator blade 218a1 can be seen.

FIG. 2G is an upper plane view showing a fully open state and a fully closed state of inlet movable louvers 250a1 of lift engine 102a1. 2A′ of left half represents an activated state of lift engine 102a1, and inlet movable louvers 250a1 being radially divided becomes in a fully open state by inlet-movable-louver driving actuators 252a1, and foreign object suction prevention net 236a1 is disposed in the back thereof. By contrast 2B′ represents a stopped state of lift engine 102a1, and inlet-movable louvers 250a1 being radially divided becomes fully closed by inlet-movable-louver driving actuators 252a1 to form one plain face.

FIG. 2H is a lower plane view showing a fully open state and a fully closed state of an exhaust direction control louvers 254a1 of the lift engine 102a1. 2A″ of left half represents an activated state of lift engine 102a1, and exhaust direction control louvers 254a1 being radially divided becomes in a fully open state by exhaust-direction-control-louver driving actuators 256a1. By contrast, 2B″ represents a stopped state of the lift engine 102a1, and exhaust direction control louvers 254a1 being radially divided becomes fully closed by exhaust-direction-control-louver driving actuators 256a1 to form one plain face.

FIG. 2I shows a bottom view showing a state in which an exhaust gas from lift engine 102a1 is revolved to one rotational direction and subjected to a reaction force of the reverse rotational direction. All of exhaust direction control louvers 254a1 are uniformly inclined with respect to the exit surface. In the example of the view, all of exhaust direction control louvers 254a1 are inclined to clockwise direction on the page space, and along the inclination, exhaust gas 42a1 (exhaust gas 42a1 is not all described for giving priority to viewability of the view) indicated by the white arrows, and as the counteraction, the lift engine 102a1 is subjected to a rotational reaction force to counter-clockwise on the page space.

FIG. 2J is a lower plane view showing a state in which the exhaust gas from the lift engine 102a1 is direction-controlled to one direction and subjected to a reaction force of the reverse direction. Some of exhaust direction control louvers 254a1 are inclined mirror-symmetrically by exhaust-direction-control-louver driving actuators 256a1. In the example of the view, some of exhaust direction control louver 254a1 located in left and right are inclined to above directions of the page space bilateral-mirror-symmetrically, and exhaust gas 43a1 (exhaust gas 43a1 is not all described for giving priority to viewability of the view) indicated by the white arrows, and as the counteraction, the lift engine 102a1 is subjected to a reaction force to below direction of the page space. In this case, swirling to right and left of exhaust gas 43a1 is cancelled by exhaust direction control louver 254a1 of right and left. Thus, lift engine 102a1 is subjected only to a reaction force to below direction of the page space.

FIGS. 3A and 3B are vertical section view and a horizontal section view showing an activated state of a reaction control engine 106a1 of aircraft 1a. Reaction control engines 106a2-106a4 have the same structure as reaction control engine 106a1. Reaction control engine 106a1 has, oxider decomposition catalyst 261a1 for reaction control engine which contains pathway for generated liquid, cylindrical reaction control gas generator 300a1, oxider decomposition flow selecting valve 302a1 for selecting flow of oxide decomposition, and cylindrical ejectors 304a1a and 304a1b in which central axes are orthogonal to each other and which contain restricted pathways. Flow amount of oxider 10a is adjusted by oxider flow control valve 283a1 for reaction control engine, and then the oxider is decomposed by oxider decomposition catalyst 261a1 for reaction control engine in reaction control gas generator 300a1 to be oxider decomposition. In FIG. 3A, by oxider decomposition selecting valve 302a1, oxider decomposition flow 34a1z indicated by black arrows is selected to one of nozzles 34a1 and 34a2 whose ejecting directions are different (in this example, downward nozzle 34a1), and reaches ejector 304a1a. In ejector 304a1a, by oxider decomposition flow 34a1z ejecting at high speed, surrounding air 70a1z indicated by white wide arrows is sucked to ejector 304a1a to be a mixed gas 71a1z thereof indicated by white arrows and thereby exhausted. As a result, a reaction force is applied to reaction control engine 106a1 to the upward direction, which is the opposite direction. Moreover, by selecting the ejection direction of oxider decomposition flow 34a1z upward by oxider decomposition selecting valve 302a1, a downward reaction force can also be applied to reaction control engine 106a1 by ejection from upward nozzle 34a2.

Reaction control to the horizontal direction also becomes possible by ejector 304a1b. In FIG. 3B, by oxider decomposition selecting valve 302a1, oxider decomposition flow 34a1y indicated by black arrows is selected to one of nozzles 34b1 and 34b2 whose ejecting directions are different (in this example, downward nozzle 34a1) and reaches ejector 304a1b. In ejector 304a1b, by oxider decomposition flow 34a1y ejecting at high speed, surrounding air 70a1y indicated by white wide arrows is sucked to ejector 304a1b to be a mixed gas 71a1y thereof indicated by white arrow and thereby exhausted. As a result, a reaction force is applied to reaction control engine 106a1 to the upward direction, which is the opposite direction. Moreover, by selecting the ejection direction of the oxider decomposition flow upward by oxider decomposition selecting valve 302a1, a downward reaction force can also be applied to reaction control engine 106a1 by ejection from upward nozzle 34b2. The reaction control engine 106a1 can select thrust forces of four directions by selecting to four directions of up, down, left, and right. A fundamental structure for obtaining thrust of one direction is composed of a nozzle and an ejector. In short the fundamental structure has, a first thrust system or device of ejecting the gas from the nozzle to a predetermined direction to make a thrust force, and a second thrust system for sucking air which is surrounding gas, to the ejector by the ejection of the first thrust system and exhausting the mixed gas thereof to make a thrust force to be added to the thrust force of the first thrust system.

In such a manner, the reaction control engine 106a1 enables rapid increase and decrease of the reaction force by increase and decrease of the flow of oxider, which is incompressible fluid, response is good. Moreover, reaction control engine 106a1 dilutes to exhaust a small amount of oxider composition 34a1 with a large amount of air 70a1 to obtain the thrust, and hence, temperature or speed of the exhausted gas are lowered and the reaction control engine is economical and has high security, and the noise is small. Moreover, the reaction control engine 106a1 can obtain the thrust by the reaction force of oxider composition 34a1 even in high altitude containing little air.

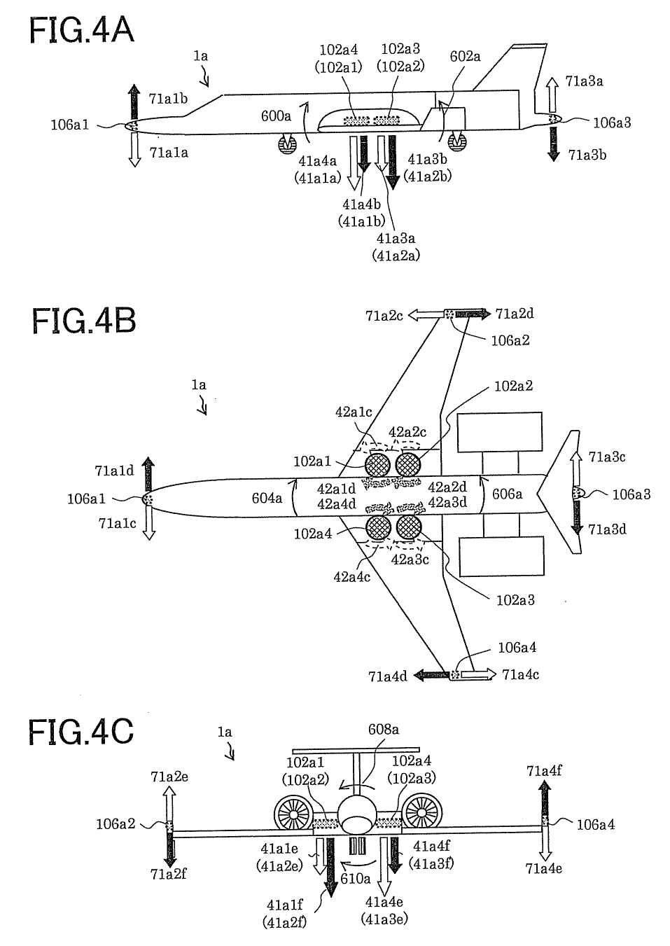

FIG. 4A is a side plan view showing the movement around pitch axis of the aircraft 1a Flow amount of gasses 41a4a and 41a1a indicated by white arrows accelerated by lift engines 102a4 and 102a1 is set to be relatively larger than flow amount of gases 41a3a and 41a2a indicated by white arrows accelerated by lift engines 102a3 and 102a2, or gas 71a1a indicated by white arrow is exhausted downward from reaction control engine 106a1 or gas 71a3a indicated by white arrow is exhausted upward from reaction control engine 106a3, or both of the actions are performed, and thereby, nose-up force 600a around pitch axis indicated by the arrow can be applied to aircraft 1a (after the present view, air flow sucked to each of the engines for giving priority to viewability of the view). By contrast, flow amount of gasses 41a3b and 42a1b indicated by black arrows accelerated by lift engines 102a3 and 102a2 is set to be relatively larger than flow amount of gases 41a4b and 41a1b indicated by black arrows accelerated by lift engines 102a3 and 102a2, or gas 71a1b indicated by black arrow is exhausted upward from reaction control engines 106a1 or gas 71a3b indicated by black arrow is exhausted downward from reaction control engine 106a3, or both of the actions are performed, and thereby, nose-down force 602a around pitch axis indicated by the arrow can be applied to aircraft 1a.

FIG. 4B is a top view showing an example of the movements around yaw axis of aircraft 1a Gasses 42a1c-42a4c indicated by white dash line arrows are swirled counterclockwise and exhausted downward from lift engines 102a1-102a4, or gases 71a1c-71a4c are exhausted counterclockwise to horizontal plane from reaction control engines 106a1-106a4, or both of the actions are performed, and thereby, clockwise force 604a around yaw axis indicated by the arrow can be applied to aircraft 1a. By contrast, gasses 42a1d-42a4d indicated by black-and-white dash line arrows are swirled clockwise and exhausted downward from lift engines 102a1-102a4, or gases 71a1d-71a4d indicated by black arrows are exhausted clockwise to horizontal plane from reaction control engines 106a1-106a4, or both of the actions are performed, and thereby, counterclockwise force 606a around yaw axis indicated by the arrow can be applied to aircraft 1a.

FIG. 4C is a front view showing the movement around roll axis of the aircraft 1a Flow amount of gasses 41a4e and 41a3e indicated by white arrows accelerated by lift engines 102a4 and 102a1 is set to be relatively larger than flow amount of gases 41a1e and 41a2e indicated by white arrows accelerated by lift engines 102a1 and 102a2, or gas 71a2e indicated by white arrow is exhausted upward from reaction control engine 106a2 or gas 71a4a indicated by white arrow is exhausted downward from reaction control engine 106a4, or both of the actions are performed, and thereby, right-roll force 608a around roll axis (counterclockwise in the view) can be applied to aircraft 1a. By contrast, flow amount of gasses 41a1f and 41a2f indicated by black arrows accelerated by lift engines 102a1 and 102a2 is set to be relatively larger than flow amount of gases 41a3f and 41a4f indicated by black arrows accelerated by lift engines 102a1 and 102a2, or gas 71a2f indicated by black arrow is exhausted downward from reaction control engine 106a2 or gas 71a4a indicated by black arrow is exhausted upward from reaction control engine 106a4, or both of the actions are performed, and thereby, left-roll force 610a around roll axis (clockwise in the view) can be applied to aircraft 1a.

In such manners, the respective movements around pitch axis, around yaw axis, and around roll axis, can be controlled by the independent multiple systems through adjustment of flow amount, direction, swirling, and the like of the exhaust gases by lift engines 102a1-102a4 and adjustment of flow amount and direction and the like of exhaust gases by reaction control engines 106a1-106a4, and if the function of one of the systems is lost by an accident and the like, the other systems can compensate the lost function and hence, functional redundancy is high and the aircraft has high security.

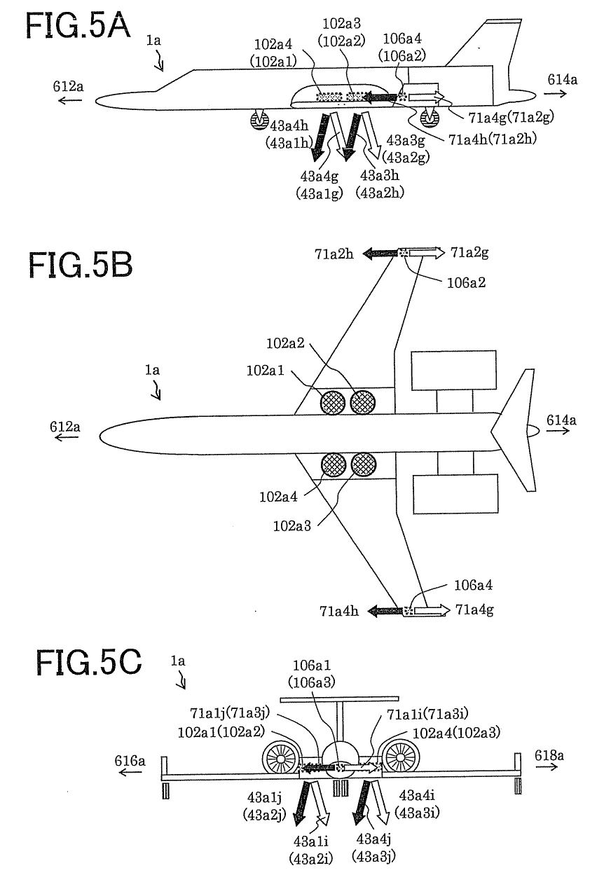

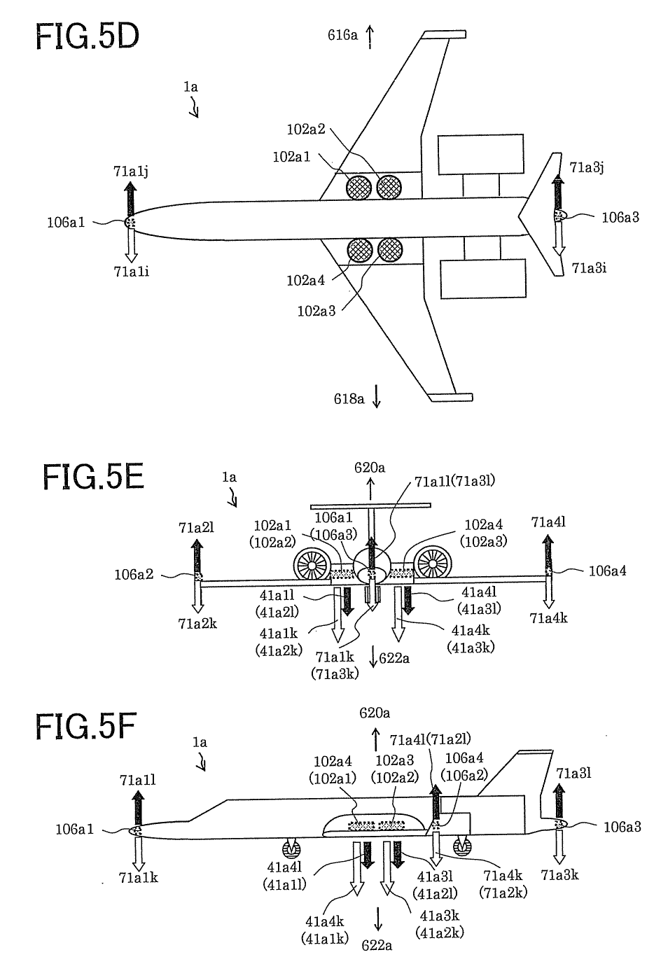

FIGS. 5A and 5B are a side view and an upper view showing backward and forward movement of the aircraft 1a Gases 43a1g-43a4g indicated by white arrows are direction-controlled backward and downward and exhausted from lift engines 102a1-102a4, or gases 71a4g and 71a2g indicated by white arrows are exhausted backward from reaction control engines 106a4 and 106a2, or both of the actions are performed, and thereby, aircraft 1a can be provided with forward force 612a By contrast gases 43a1h-43a4h indicated by black arrows are direction-controlled forward and downward and exhausted from lift engines 102a1-102a4, or gases 71a4h and 71a2h indicated by black arrows are exhausted forward from reaction control engines 106a4 and 106a2, or both of the actions are performed, and thereby, aircraft 1a can be provided with backward force 614a.

FIGS. 5C and 5D are a front view and a top view showing rightward and leftward movement of aircraft 1a Gasses 43a1i-43a4i indicated by white arrows is direction-controlled downward and leftward and exhausted from lift engines 102a1-102a4, or gases 71a1i and 71a3i indicated by white arrows is exhausted leftward from reaction control engines 106a1 and 106a3, or both of the actions are performed, and thereby, aircraft 1a can be provided with a force 616a for rightward movement. By contract, gasses 43a1j-43a4j indicated by black arrows are direction-controlled downward and rightward and exhausted from lift engines 102a1-102a4, or gases 71a1j and 71a3j indicated by black arrows are exhausted rightward from reaction control engines 106a1 and 106a3, or both of the actions are performed, and thereby, aircraft 1a can be provided with a force 618a for leftward movement.

FIGS. 5E and 5F are a front view and a side view showing moving up and down of aircraft 1a Flow amount of gasses 41a1k-41a4k indicated by white arrows exhausted from lift engines 102a1-102a4 is set to be larger than that in hovering, or gases 71a1k-71a4k indicated by white arrows are exhausted downward from reaction control engines 106a1-106a4, or both of the actions are performed, and thereby, aircraft 1a can be provided with a force 620a for moving up. By contrast, flow amount of gasses 41a1l-41a4l indicated by black arrows exhausted from lift engines 102a1-102a4 is set to be smaller than that in hovering, or gases 71a1l-71a4l indicated by black arrows is exhausted upward from reaction control engines 106a1-106a4, or both of the actions are performed, and thereby, aircraft 1a can be provided with a force 622a for moving down.

In such manners, the respective movements of backward and forward, rightward and leftward, and upward and downward along roll axis, pitch axis, and yaw axis can be controlled by the independent multiple systems through adjustment of flow amount, direction, swirling, and the like of the exhaust gases by lift engines 102a1-102a4 and adjustment of flow amount and direction and the like of the exhaust gases by reaction control engines 106a1-106a4, and if the function of one of the systems is lost by an accident and the like, the other systems can compensate the lost function and hence, functional redundancy is high and the aircraft has high security.

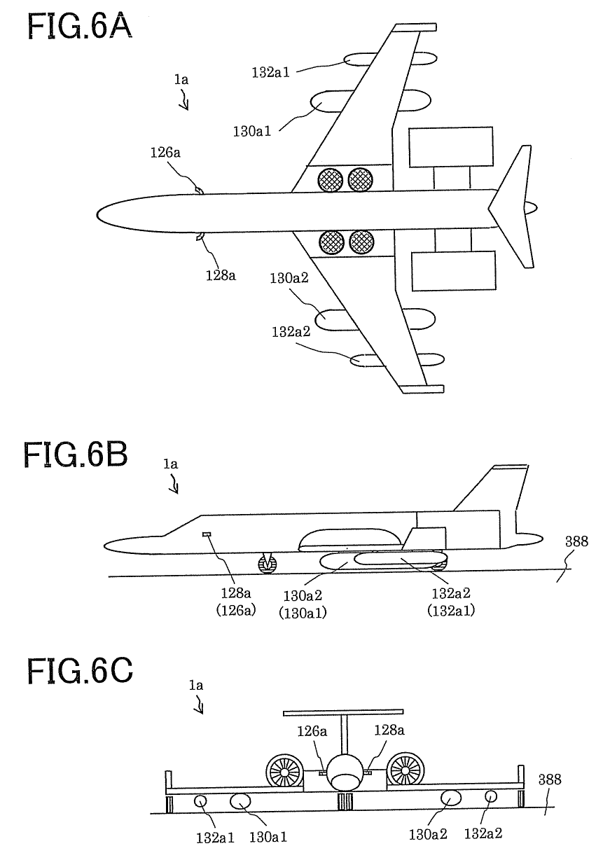

FIGS. 6A-6C are a top view, a side view, and a front view in a ground alert state of aircraft 1a on which in-air refilling probe 126a for refilling an oxider in the air, in-air refueling probe 128a for refilling a fuel in the air, external oxider tanks 130a1, and external fuel tanks 132a are loaded. The provision of in-air refilling probe 126a, in-air refueling probe 128a, external oxider tanks 130a1, and external fuel tanks 132a enables extension of cruising distance, increase of loaded payload, and the like of aircraft 1a.

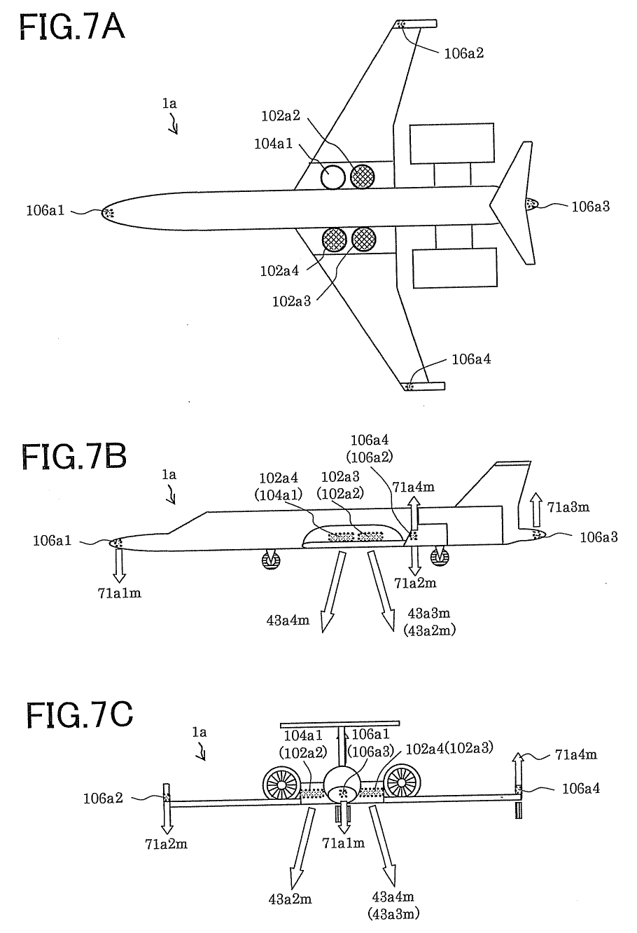

FIGS. 7A-7C illustrate a top view, a side view, and a front view in a state in which one lift engine (104a1 in the example) is stopped in vertical takeoff and landing of aircraft 1a. In this case, in aircraft 1a, large amounts of gases 43a2m-43a4m indicated by white arrows are direction-controlled and exhausted from the other lift engines 102a2-102a4 so that the engines compensate the stopped lift engine 104a1, or gases 71a1m and 71a2m indicated by white arrows are exhausted downward from reaction control engines 106a1 and 106a2, or gases 71a3m and 71a4m indicated by white arrows are exhausted upward from reaction control engines 106a3 and 106a4, or both of the actions are performed, and thereby, even in a state that one lift engine 104A is stopped, aircraft 1a can continue safe takeoff and landing.

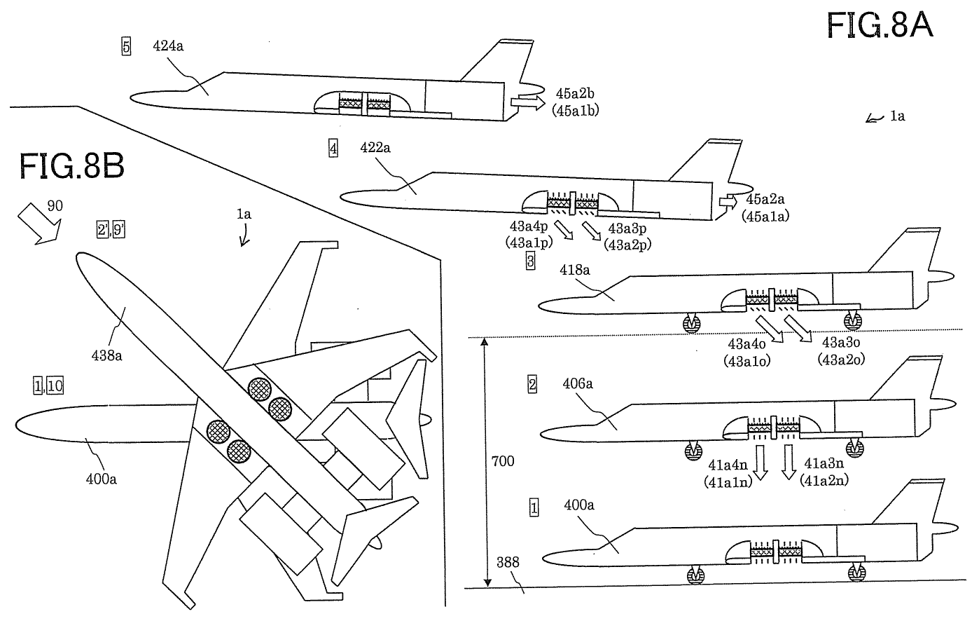

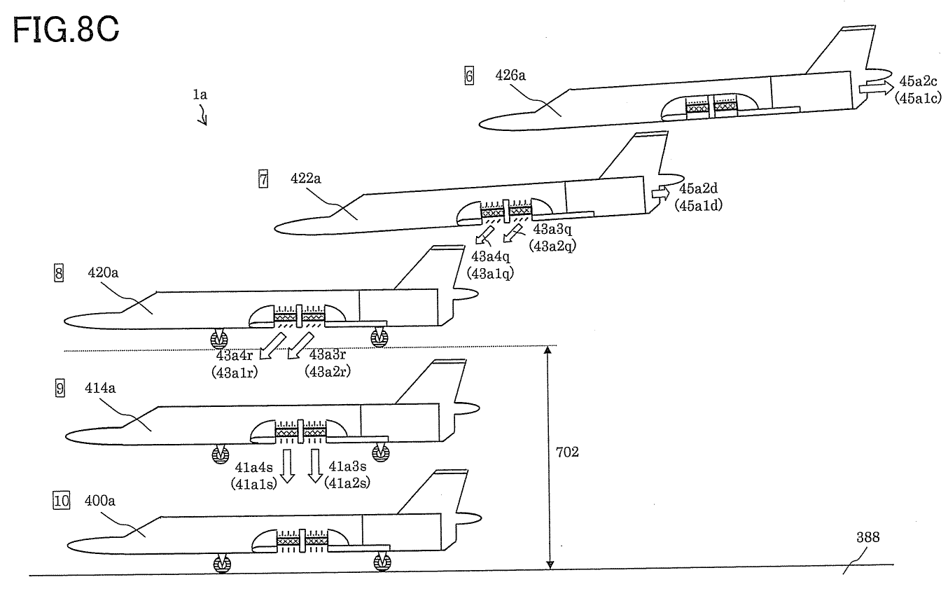

FIGS. 8A-8C are a side view and a top view containing a partial section that are useful for explaining vertical takeoff and landing of aircrafts. Digits 1-10 surrounded by rectangles indicate the respective processes of vertical takeoff and landing.

In FIG. 8A, aircraft 1a activates the lift engines to downward exhaust gases 41a1n-41a4n indicated by white arrows from a plain and the like 388 and thereby moves up (406a), and reaches a predetermined takeoff altitude 700 (418a). Then, gases 43a1o-43a4o indicated by white arrows are direction-controlled downward and backward and exhausted from the lift engines to transfer to forward and upward movement, gases 45a1a-45a2a indicated by the white arrow are exhausted from flight engines, and therewith, gases 43a1p-43a4p indicated by white arrows from the lift engines are direction-controlled downward and backward and exhausted with reducing flow amounts of the gases. Then, after sufficient lifting powers are generated in the wings, the lift engines are stopped and gasses 45a1a-45a2a indicated by white arrow from the flight engines are exhausted to perform general up.

FIG. 8B is a top view showing aircraft 1a in vertical takeoff and landing of aircraft 1a when wind direction is changed up in the air. If wind direction 90 indicated by white wide arrow is changed suddenly in vertical takeoff and landing, the nose is soon steered upwind and thereby, the aircraft is not fanned by crosswind and is safe, and can perform the most appropriate takeoff and landing so as to face to the wind.

In FIG. 8C, aircraft 1a exhausts gases 45a1c-45a2c indicated by white arrow from flight engines to perform general lowering (426a), and gases 43a1q-43a4q indicated by white arrows from the lift engines are direction-controlled downward and forward and exhausted with increasing flow amounts of the gases and therewith the aircraft moves down forward and downward (422a), and gases 43a1r-43a4r indicated by white arrows from the lift engines are exhausted downward with increasing further the amount of the gases and therewith the flight engines are stopped and thereby the aircraft reaches a predetermined altitude 702 (420a). Then, the aircraft lowers with controlling the flow amount of gasses 41a1s-41a4s indicated by white arrows from the lift engines (414a), and then lands on a plain and the like 388 (400a).

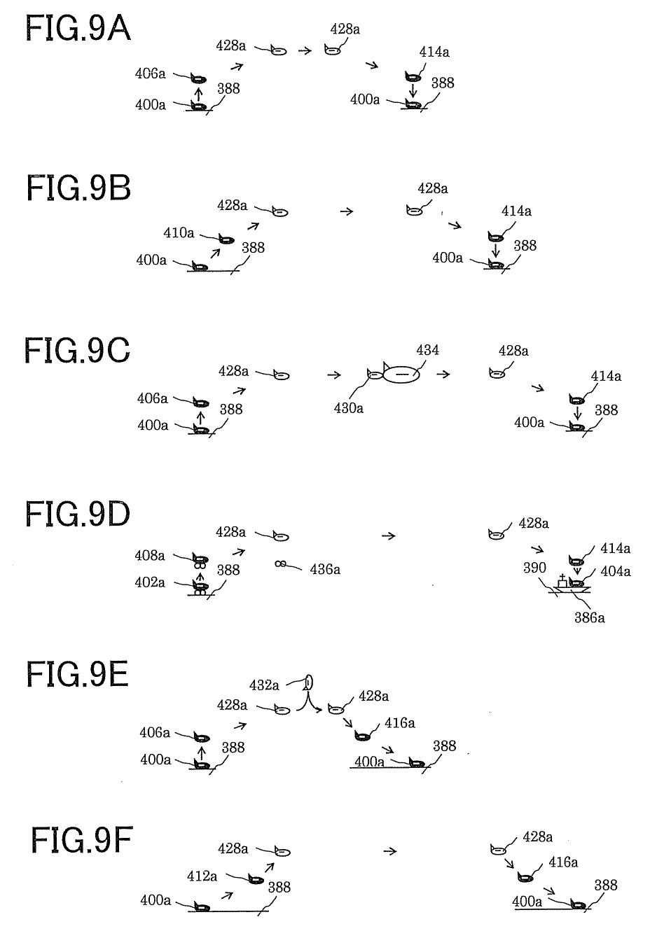

FIG. 9A is a side view showing a method for operating the aircraft as a VTOL body. It is shown that from a plain and the like 388 (400a), the aircraft vertically takes off (406a) and performs cruise flight (428a) and then, vertically lands on a plain and the like 388 (414a).

FIG. 9B is a side view showing a method for operating the aircraft as a STOLVL (Short Take-Off and Vertical Landing) body. It is shown that from a plain and the like 388 (400a), the aircraft glides in short distance to take off (410a) and thereby can perform cruise flight glide in a longer distance than that of the operation as a VTOL body glide (428a), and then lands vertically on a plain and the like 388 (414a). Moreover, in the case of performing cruise flight of the same distance as the VTOL body, more amount of payload can be loaded or loaded amount of fuel or oxider can be more saved.

FIG. 9C is a method for operating aircraft 1a as a VTOL body when the body receives refueling or refilling in the air in a flight. It is shown that from a plain and the like 388 (400a), the aircraft takes off vertically (406a) with minimum necessary fuel and oxider (406a), and on the way of cruse flight (428a), the aircraft receives refill of fuel and oxider from refueling and refilling mother aircraft 434 in the air (430a) and thereby performs flight in a longer distance than that of the operation as a VTOL body, and then lands vertically on a plain and the like 388 (414a). Moreover, in the case of performing cruse flight in the same distance as the operation as a VTOL body, more amount of payload can be loaded than that of the operation as a VTOL body.

FIG. 9D is a side view showing a method for operating aircraft 1a as a VTOL body utilizing external oxider tank and external fuel tank. It is shown that from a plain and the like 388 (402a), the aircraft takes off vertically with fuel and oxider contained in the external fuel tank and the external oxider tank (408a) and then throws away the external fuel tank and the external oxider tank (436a) and thereby performs cruise flight in a longer distance than that of the operation as a VTOL body (428a), and then lands vertically on a ship and the like 386a on a water surface and the like 390 (414a).

FIG. 9E is a side view showing a method for operating aircraft 1a as a VTOCL (Vertical Take-Off and Conventional Landing) body performing manuva or the like. It is shown that from a plain and the like 388 (400a), the aircraft takes off vertically (406a) and performs cruise flight (428a) and then, the aircraft performs high-angle-of-attack flight, manuva under stall speed, flight in the upper air whose atmosphere is rare, or the like (432a), and then lands on a plain and the like 388 by gliding in general distance (416a).

FIG. 9F is a side view showing a method for operating aircraft 1a as a CTOL body. It is shown that from a plain and the like 388 (400a), the aircraft takes off by gliding in general distance (412a) and performs cruse flight in a longer distance than that of the operation as a VTOL body and then, lands on a plain and the like 388 by gliding in general distance (416a). Moreover, in the case of performing cruse flight in the same distance as the operation as a VTOL body, more amount of payload can be loaded than that of the operation as a VTOL body.

In such manners, because aircraft 1a can perform the same takeoff and landing as general aircrafts, safe takeoff and landing is possible even if a plurality of lift engines and/or reaction engines are crashed.

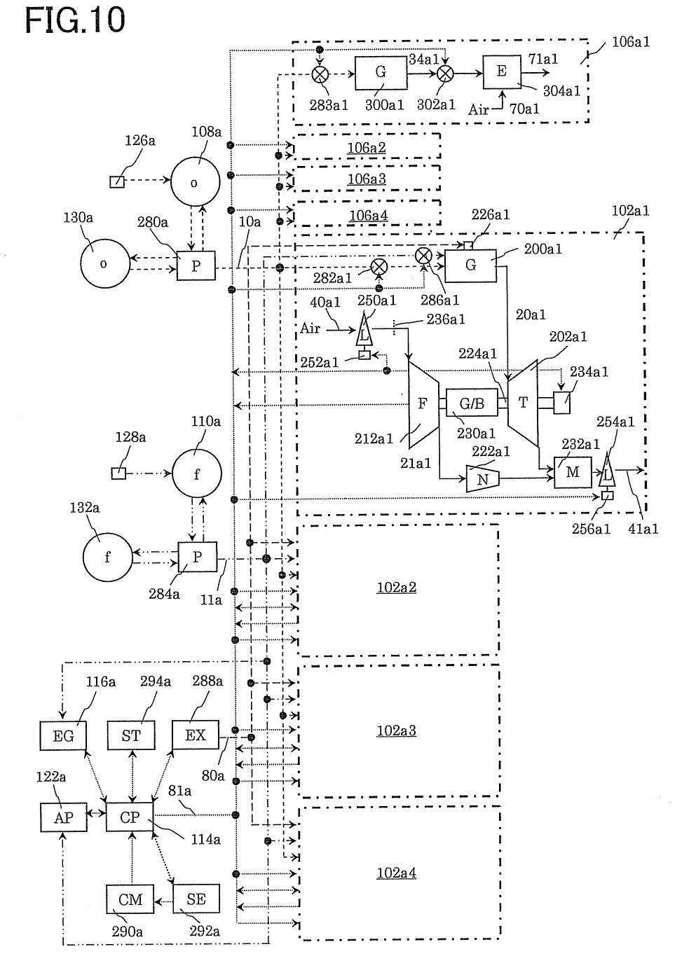

FIG. 10 is a block diagram of fluid and electric system of aircraft 1a

In aircraft 1a, oxider 10a stored in external oxider tank 130a or in oxider tank 108a preliminary or through in-air refilling probe 126a is pressurized by oxider pressurizing system or device 280a, and supplied to turbine driven gas generators 200a1-200a4 of lift engines 102a1-102a4 and to reaction control gas generators 300a1-300a4 of reaction control engines 106a1-106a4, through oxider flow control valves 282a1-282a4 for lift engines or through oxider flow control valves 283a1-283a4 for reaction control engines. On the other hand, fuel 11a stored in external fuel tank 132a or in fuel tank 110a preliminary or through in-air refueling probe 128a is pressurized by fuel pressurizing system or device 284a, and supplied to turbine driven gas generators 200a1-200a4 of lift engines 102a1-102a4 and to flight engines 116a and to auxiliary power unit 122a, through fuel flow control valves 286a1-286a4 for lift engines. The structures of lift engines 102a2-102a4 are similar to the structure of lift engine 102a1, and hence lift engine 102a1 will be described here. In lift engine 102a1, turbine driven gas 20a1 generated in turbine driven gas generator 200a1 drives turbine 202a1 and then reaches mixer 232a1.

The power obtained in turbine 202a1 drives transmission 230a1 and rotation control motor and electrical generator 234a1, through shaft 224a1. Transmission 230a1 drives fan 212a1. Fan 212a1 sucks surrounding air 40a1 passing through inlet movable louver 250a1 and foreign object suction prevention net 236a1. Then, air 21a1 is pressurized by fan 212a1 and reaches nozzle 222a1. In nozzle 222a1, pressure of air 21a1 is converted into speed and thereby air 21a1 is accelerated to reach mixer 232a1. In mixer 232a1, some of turbine driven gas 20a1 and air 21a1 are mixed and passed through exhaust direction control louver 254a1 and exhausted (41a1) and thereby, a reaction force is generated in lift engine 102a1. Loading on turbine 202a1 is adjusted by rotation control motor and electrical generator 234a1 so that stall or surge of the fan is not caused by effect that large foreign objects in surrounding air 40a1 are captured by foreign object suction prevention net 236a1. If turbine driven gas 20a1 comes not to be generated, fan 212a1 is driven temporarily by rotation control motor and electrical generator 234a1, and aircraft 1a is made to land safely as much as possible by driving fan 212a1.

The structures of reaction control engines 106a2-106a4 are similar to the structure of reaction control engine 106a1, and hence reaction control engine 106a1 will be descried here. In reaction control engine 106a1, channels of oxider decomposition 34a1 generated in reaction control gas generator 300a1 are changed by oxider decomposition flow selecting value 302a1, and then surrounding air 70a1 is sucked and exhausted (71a1) by ejector 304a1.

Control system or device 290a assigns charge to computer 114a according to information of sensor 292a detecting various states of the body and the like. According to the charge, computer 114a controls lift engines 102a1-102a4, reaction control engines 106a1-106a4, flight engine 116a, auxiliary power unit 122a, ignition system or device 288a, steering system or device 294a and the like, through control signal 81a. Ignition system 288a generates ignition signals 80a to igniters 226a1-226a4 to ignite turbine driven gas generators 200a1-200a4.

It is preferable that the oxider and the fuel are liquids of normal temperature and high density in the aspects of storage stability and storage quality, but the oxider and the fuel are not limited thereto in the same manner as the other embodiments. The liquid oxider and the liquid fuel are used to reduce volume of tubes and the like for introducing the oxider and the fuel to lift engines 102a1-102a4 and reaction control engines 106a1-106a4, and degree of freedom of the system arrangement is improved.

Different kinds of oxider may include hydrogen peroxide, nitric acid, red fuming nitric acid, dinitrogen monoxide, nitrogen dioxide, dinitrogen trioxide, dinitrogen tetraoxide, dinitrogen pentaoxide, nitrous oxide, mixed nitrogen oxide, fluorochloric acid, aqueous solutions thereof, oily solutions thereof, and the like. Among them, hydrogen peroxide or an aqueous solution thereof is preferable because of not generating harmful substance at all. Hydrogen peroxide aqueous solutions of various concentrations can be used, and the hydrogen peroxide aqueous solution whose concentration by weight is 3-70% by weight is low-risk and can be easily handled. The solution is of high density, has storage quality, and is low-cost because of being easily obtainable.

For oxider decomposition catalyst 260a for lift engine and for oxider decomposition catalyst 261 for reaction control engine, appropriate catalyst components are selected according to the oxider to be used. For example, when the oxider is hydrogen peroxide or an aqueous solution thereof, a catalyst component such as, a platinum group metal such as platinum or palladium, or manganese oxide may be used. Moreover, the catalysts can be replaced to a heater for pyrolyzing the oxider.

Different kinds of the fuel may include, an alcohol such as ethyl alcohol and methyl alcohol, and an aqueous solution thereof, hydrocarbon fuel (containing Gal To Liquid fuel (GTL)) such as jet fuel, a hydrazine such as monomethylhydrazine, an aqueous solution of the hydrazine, an oily solution of the hydrazine, an amine such as ethylenediamine, a borane such as diborane and pentaborane, an aqueous solution of the borane, an oily solution of the borane, a propylene, an aqueous solution of the propylene, a ketone, an aqueous solution of the ketone, a benzene, a xylene, a toluene, an acetic acid, a pyridine, an ester, an aqueous solution of the ester, a propionic acid, an aqueous solution of the propionic acid, an acrylic acid, an aqueous solution of the acrylic acid, a creosote oil, an aniline, a nitrobenzene, an ethylene glycol, an aqueous solution of the ethylene glycol, a glycerin, an aqueous solution of the glycerin, ammonium, and an aqueous solution of ammonium, a flammable fat, and additionally fuels in which the fuels are appropriately mixed. In particular, a bioalcohol and an solution of the bioalcohol are preferable because of not generating environmental pollutants at all (According to a special rule of the 3rd Conference of Parties of THE UNITED NATIONS FRAMEWORK CONVENTION ON CLIMATE CHANGE at Kyoto in December, 1997, rediffusion of carbon dioxide due to carbonate metabolism by a plant is not taken as generation of new carbon dioxide: carbon neutral). Hydrocarbon fuels such as coal oil and gasoline are low-risk, easily handled, and low-cost because of being easily obtainable. In Recent years, the hydrocarbon fuels of them has been started to generate from raw material such as natural gas, whose amount of deposit is rich.

In addition, in the first embodiment, the turbines are used as the first thrust systems, and the fans and the nozzles are used as the second thrust systems, but both of or one of the devices may be replaced to reciprocating units of operating by the gas from the gas generator.

### Second Embodiment

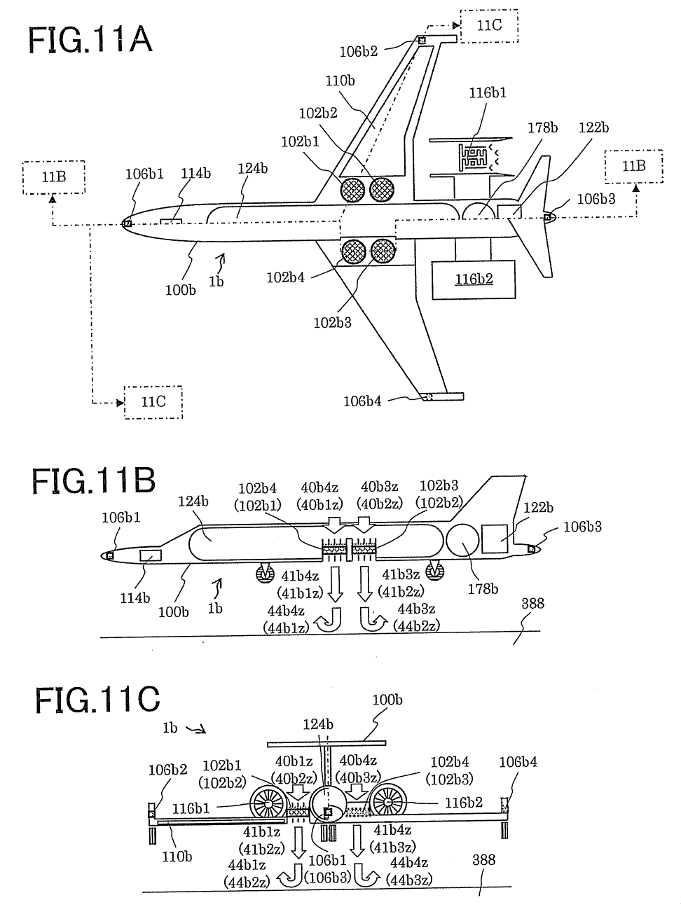

FIGS. 1A-11C show, a top view and a right-half-cut upper section view in takeoff and landing of an aircraft according to the second embodiment of the invention, a side section view in which the aircraft is cut along 11B-11B, and a front view and a front section view in which the aircraft is cut along 11C-11C, respectively. Aircraft 1b has body 100b including general components such as flight engines 116a1-116a2, auxiliary power unit 122b, payload 124b, and fuel tank 110b, which are known, and additionally the aircraft has short cylinder-shaped lift engines 102b1-102b4, reaction control engines 106b1-106b4 each having a shape of combination of two orthogonal cylinders, sphere-shaped oxider tank 178a, and rectangular-parallelepiped-shaped computer 114a, which are according to the invention.

The present embodiment is different from the first embodiment in method for generating driving gases. That is, in the first embodiment, the driving gases are generated by reaction of oxider and fuel, and by contrast, in the second embodiment, the driving gases are generated by reaction of reactant. The embodiment is the same as the first embodiment in the other parts and has the same advantages.

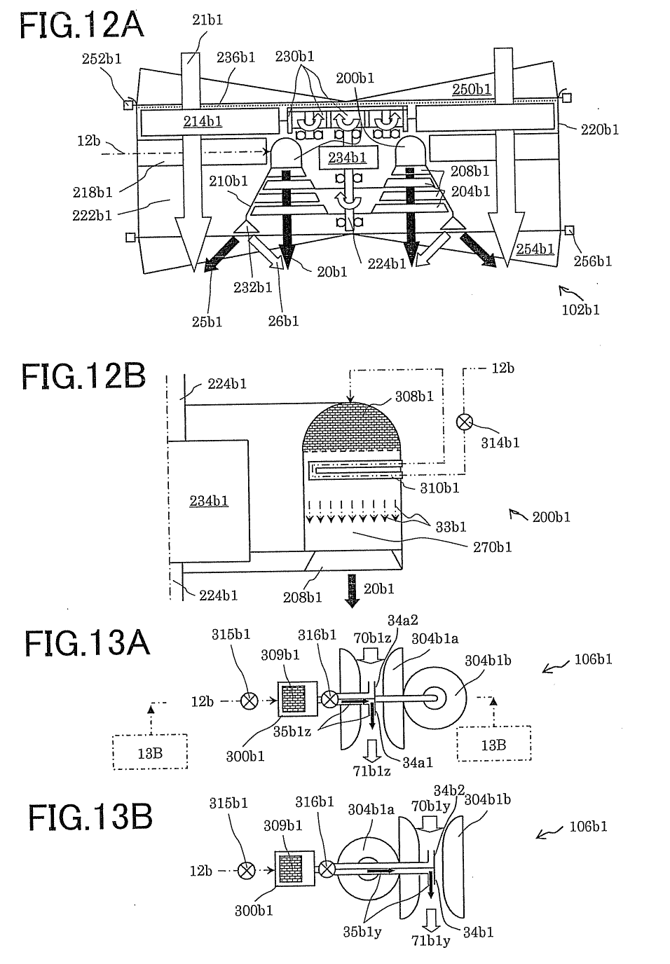

FIG. 12A shows a vertical section view of a lift engine in an activated state of aircraft 1b. Lift engines 102b2-102b4 have the same structure as lift engine 102b1. In the view, fundamentally, the structure of lift engine 102b1 is rotational symmetry, for making the view concise, the same serial symbols are appended to the same respective components.

In the same manner as lift engine 102a1 of the first embodiment, lilt engine 102b1 has, an annular turbine driven gas generator 200b1 which has a vertical central axis of generating gas 20b1 for driving the turbine indicated by the black arrow and which has an annular opening, a plurality of coaxial radial turbine stator blades 208b1 for accelerating and turning gas 20b1, a plurality of coaxial radial turbine rotor blades 204b1 for taking mechanical work out of gas 20b1, coaxial truncated-cone-shaped turbine case 210b1 for preventing the broken pieces from scattering outside the engine if a turbine rotor blade 204b1 is broken or scattered, a plurality of coaxial radial fan rotor blades 214b1 for sucking and accelerating the surrounding air, a plurality of coaxial radial fan stator blades 218b1 for converting speed of sucked air 21b1 indicated by the white arrow to pressure, coaxial cylindrical fan case 220b1 for preventing the broken pieces from scattering outside the engine if fan rotor blade 214b1 is broken or scattered, nozzle 222b1 which is provided in fan case 220b1 and which is formed between the coaxial cylinder (fan case 220b1) and the truncated cone (turbine case 210b1) and in which opening area of the bottom face is smaller than the opening area of the top face for accelerating air 21b, shaft 224b1 on the central axis rotated by turbine rotor blade 204b1, transmission 230b1 in which gears and the like are combined to be rotational symmetry for transmitting the rotation from shaft 224b1 to fan rotor blade 214b1, radially-rippling folded robe-shaped mixer 232b1 for mixing some of gas 20b1 driving the turbine and some of sucked air 21b1 to equalize temperature and speed of the exhaust gas, columnar rotation control motor and electrical generator 234b1 which is activated as electric generator or electric motor, netty foreign-object suction prevention net 236b1 for preventing large incoming objects from being sucked into fan rotor blade 214b1, a plurality of fan-shaped inlet-movable louvers 250b1 disposed in a radial shape which form upper faces of the wing and body 100b in storage and which form the pathways for sucked air 21b1 in expansion, a plurality of columnar inlet-movable-louver driving actuator 252b1 for driving the inlet-movable louvers 250b1, a plurality of fan-shaped exhaust-direction control louvers 254b1 disposed in a radial shape which form lower faces of the wing and the body in storage and which form pathways for exhaust gas 41b1 and individually and freely control the exhaust directions in expansion, and a plurality of columnar thrust-direction-control-louver driving actuators 256b1 for driving the thrust direction control louvers 254b1.

The operation of the lift engine 102b1 is similar to that of lift engine 102a1, and hence is not described again.

FIG. 12B is an enlarged vertical section view of a right side part of a turbine driven gas generator of the lift engine in the activated state of FIG. 2A. The gas generator 200b1 has, reactant decomposition catalyst 308b1 for lift engine containing pathway for generated fluid, tubular reactant heating pathway 310b1, and ring-shaped reaction chamber 270b1. Flow amount of reactant 12b is adjusted by reactant flow amount control valve 314b1 for lift engine, and then the reactant passes through reactant heating tube 310b1 to be heat-exchanged with reactant decomposition 33b1 and thereby is preheated, and decomposed into reactant decomposition 33b1 with reactant decomposition catalyst 308b1 for lift engine, and heats reactant 12b through reactant heating tube 310b1 and reaches reaction room 270b1, and becomes turbine driven gas 20b1 and passes through.

The operation of the lift engine 102b1 is similar to that of lift engine 102a1 and hence is not described again.

FIGS. 13A and 13B are a vertical section view and a horizontal section view showing an activated state of reaction control engine 106b1 of aircraft 106b1. Reaction control engines 106b2-106b4 have the same structure as reaction control engine 106b1. Reaction control engine 106b1 has, reactant decomposition catalyst 309b1 for reaction control engine which contains pathway for generated liquid, cylindrical reaction control gas generator 300b1, reactant decomposition flow selecting valve 316b1 for selecting flow of oxide decomposition, and cylindrical ejectors 304b1a and 304b1b in which central axes are orthogonal to each other and which contain restricted pathways. Flow amount of reactant 12b is adjusted by reactant flow control valve 315b1 for reaction control engine, and then the reactant is decomposed by reactant decomposition catalyst 309b1 for reaction control engine in reaction control gas generator 300b1 to be reactant decomposition. In FIG. 13A, by reactant decomposition selecting valve 316b1, ejecting direction of reactant decomposition flow 35b1z indicated by black arrows is selected (in this example, downward), and the flow reaches ejector 304b1a. In ejector 304b1a, by reactant decomposition flow 35b1z ejecting at high speed, surrounding air 70b1z indicated by white wide arrows is sucked to ejector 304b1a to be a mixed gas 71b1z thereof indicated by white arrows and thereby exhausted. As a result, a reaction force is applied to reaction control engine 106a1 to the upward direction, which is the opposite direction. Moreover, by selecting the ejection direction of reactant decomposition flow 35b1z upward by reactant decomposition selecting valve 316b1, a downward reaction force can also be applied to reaction control engine 106a1.

Reaction control to the horizontal direction also becomes possible by ejector 304b1b. In FIG. 13B, by reactant decomposition selecting valve 302a1, ejecting direction of reactant decomposition flow 35b1y indicated by black arrows is selected (in this example, downward) and the flow reaches ejector 304b1b. In ejector 304b1b, by reactant decomposition flow 35b1y ejecting at high speed, surrounding air 70b1y indicated by white wide arrows is sucked to ejector 304b1b to be a mixed gas 71b1y thereof indicated by white arrow and thereby exhausted. As a result, a reaction force is applied to reaction control engine 106b1 to the upward direction, which is the opposite direction. Moreover, by selecting the ejection direction of the reactant decomposition flow upward by reactant decomposition selecting valve 316b1, a downward reaction force can also be applied to reaction control engine 106b1.

The operation of reaction control engine 106b1 is similar to that of reaction control engine 106a1, except for the method for generating the reaction control gas.

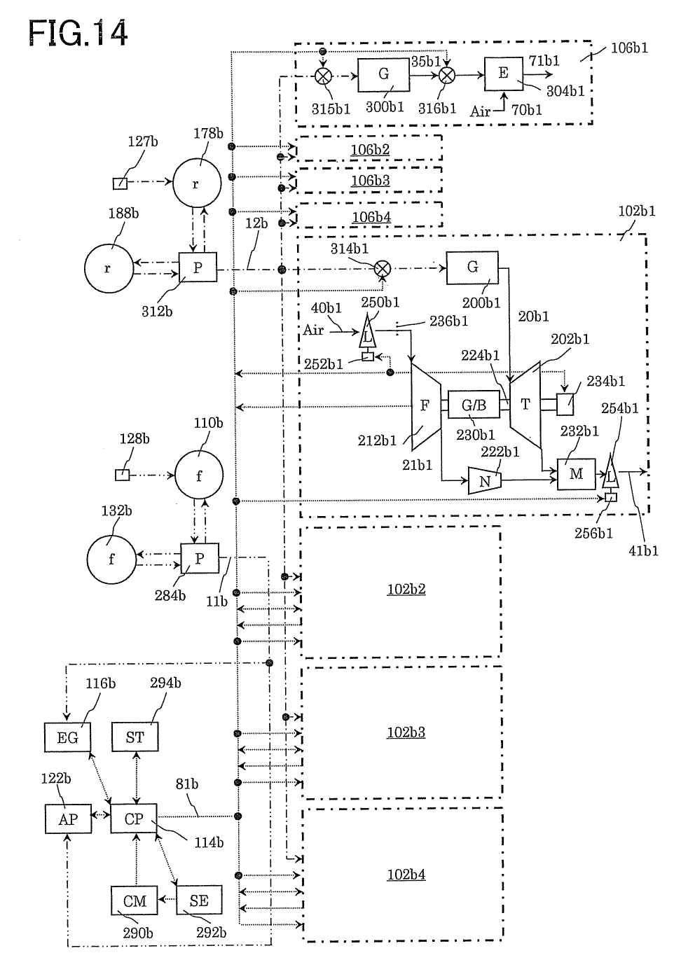

FIG. 14 is a block diagram of fluid and electric system of the aircraft. In aircraft 1b, reactant 12b stored in external reactant tank 188b or in reactant tank 178b preliminary or through in-air refilling probe 127b is pressurized by reactant pressuring system or device 312b, and supplied to turbine driven gas generators 200b1-200b4 of lift engines 102b1-102b4 and to reaction control gas generators 300b1-300b4 of reaction control engines 106b1-106b4, through reactant flow control valves 314b1-314b4 for lift engines or through reactant flow control valves 315b1-315b4 for reaction control engines. On the other hand, fuel 11b stored in external fuel tank 132b or in fuel tank 110b preliminary or through in-air refueling probe 128b is pressurized by fuel pressurizing system or device 284b, and supplied to flight engines 116b and to auxiliary power unit 122b. The structures of lift engines 102b2-102b4 are similar to the structure of lift engine 102b1, and hence lift engine 102b1 will be described here. In lift engine 102b1, turbine driven gas 20b1 generated in turbine driven gas generator 200b1 drives turbine 202b1 and then reaches mixer 232b1. The power obtained in turbine 202b1 drives transmission 230b1 and rotation control motor and electrical generator 234b1, through shaft 224b1. Transmission 230b1 drives fan 212b1. Fan 212b1 sucks surrounding air 40b1 passing through inlet movable louver 250b1 and foreign object suction prevention net 236b1. Then, air 21b1 is pressurized by fan 212b1 and reaches nozzle 222b1. In nozzle 222b1, pressure of air 21b1 is converted into speed and thereby air 21b1 is accelerated to reach mixer 232b1. In mixer 232b1, some of turbine driven gas 20b1 and air 21b1 are mixed and passed through exhaust direction control louver 254b1 and exhausted (41b1) and thereby, a reaction force is generated in lift engine 102b1. Loading on turbine 202b1 is adjusted by rotation control motor and electrical generator 234b1 so that stall or surge of the fan is not caused by effect that large foreign objects in surrounding air 40b1 are captured by foreign object suction prevention net 236b1. If turbine driven gas 20b1 comes not to be generated, fan 212b1 is driven temporarily by rotation control motor and electrical generator 234b1, and aircraft 1b is made to land safely as much as possible by driving fan 212b1.

The structures of reaction control engines 106b2-106b4 are the same as the structure of reaction control engine 106b1, and hence reaction control engine 106b1 will be described here. In reaction control engine 106b1, channels of oxider decomposition 35b1 generated in reaction control gas generator 300b1 are changed by oxider decomposition flow selecting value 316b1, and then surrounding air 70b1 is sucked and exhausted (71b1) by ejector 304b1.

The operations of the other fluid and electric system are similar to those of the first embodiments.

It is preferable that the reactant is liquid of normal temperature and high density in the aspects of storage stability and storage quality, but the reactant is not limited thereto in the same manner as described repeatedly in the other embodiments. The liquid reactant is used to reduce volume of tubes and the like and also, degree of freedom of the system arrangement is improved.

Different kinds of reactant may include hydrogen peroxide, hydrazine, hydrazine derivative, ethylene oxide, n-propylnitrate, ethylnitrate, methylnitrate, nitromethane, tetanitromethane, nitroglycerin, aqueous solutions of the reactants, oily solutions of the reactants, water, and ice. Among them, hydrogen peroxide or an aqueous solution thereof is preferable because of not generating harmful substance at all. Among them, a hydrogen peroxide aqueous solution whose concentration by weight is 30-80% by weight is relatively low-risk and can be easily handled. The hydrogen peroxide aqueous solution and hydrogen peroxide of higher density (HTP: High Test Peroxide) can also be put into practical use with being appropriately handled.

For reactant decomposition catalyst 308b for lift engine and for reactant decomposition catalyst 309b for reaction control engine, appropriate catalyst components are selected according to the reactant to be used. For example, when the reactant is hydrogen peroxide or a hydrazine, a catalyst component such as a platinum group metal such as iridium or rhodium may be used. Moreover, the catalysts can be replaced to a heater for pyrolyzing the reactant.

### Third Embodiment

FIGS. 15A-15C are a top view and a right-half-cut top view in ground alert of an aircraft that can detach from and attach to a flying body and can vertically take off and land according to the third embodiment of the invention, a side section view in which the aircraft is cut along 15B-15B, and a front view and a front section view in which the aircraft is cut along 15C-15C, respectively. Aircraft 1c has, a body 100c including known general components as an aircraft, and additionally has disc-shaped lift engines 102c1-102c4, cylindrical reaction control engines 106c1-106c4, rectangular-parallelepiped-shaped computer 114c, rectangular-parallelepiped-flame-shaped attaching and detaching system or device 134c, reactant tanks 178c each having hemispheroidal double ends and a cylindrical central portion, and decomposer tanks 190c each having hemispheroidal double ends and a cylindrical central portion.

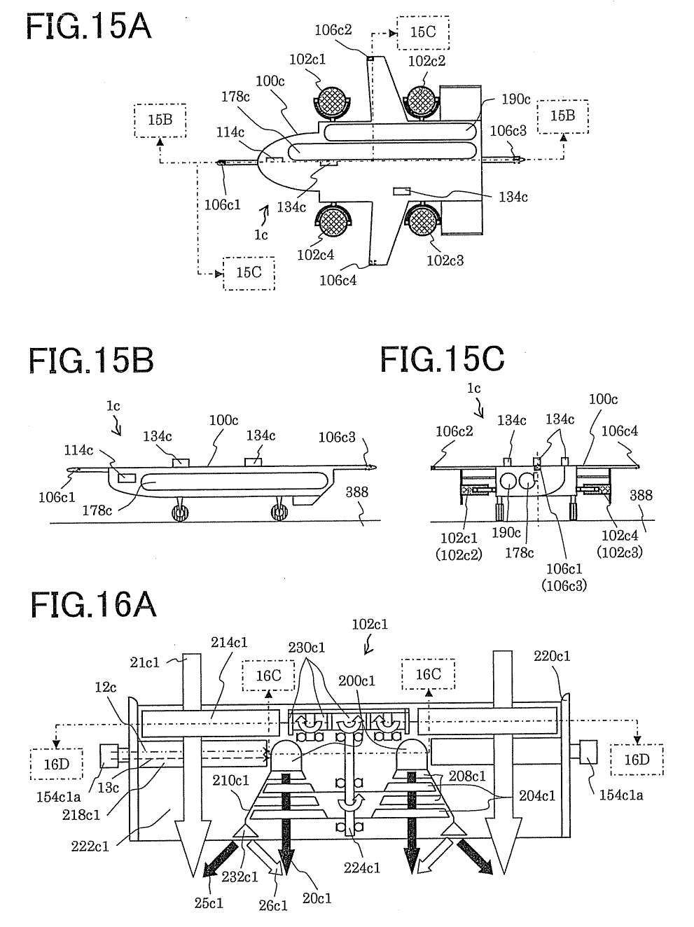

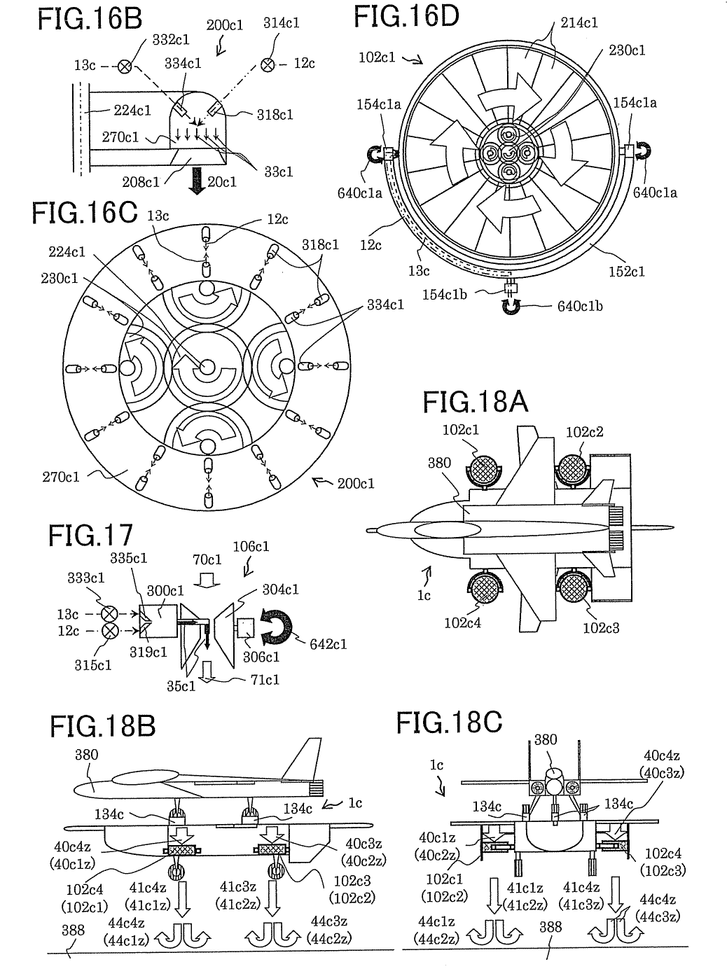

FIG. 16A shows a vertical section view of lift engine 102c1 of aircraft 1c in an activated state. Lift engines 102c2-102c4 have the same structure as lift engine 102c1. In the view, fundamentally, the structure of lift engine 102c1 is rotational symmetry, for making the view concise, the same serial symbols are appended to the same respective components. In the same manner as the first embodiment, lift engine 102c1 has, an annular turbine driven gas generator 200c1 which has a vertical central axis of generating gas 20c1 for driving the turbine indicated by the black arrow and which has an annular opening, a plurality of coaxial radial turbine stator blades 208c1 for accelerating and turning gas 20c1, a plurality of coaxial radial turbine rotor blades 204c1 for taking mechanical work out of gas 20c1, coaxial truncated-cone-shaped turbine case 210c1 for preventing the broken pieces from scattering outside the engine if a turbine rotor blade 204c1 is broken or scattered, a plurality of coaxial radial fan rotor blades 214c1 for sucking and accelerating the surrounding air, a plurality of coaxial radial fan stator blades 218c1 for converting speed of sucked air 21c1 indicated by the white arrow to pressure, coaxial cylindrical fan case 220c1 for preventing the broken pieces from scattering outside the engine if fan rotor blade 214c1 is broken or scattered, nozzle 222c1 which is provided in fan case 220c1 and which is formed between the coaxial cylinder (fan case 220c1) and the truncated cone (turbine case 210c1) and in which opening area of the bottom face is smaller than the opening area of the top face for accelerating air 21c, shaft 224c1 on the central axis rotated by turbine rotor blade 204c1, transmission 230c1 in which gears and the like are combined to be rotational symmetry for transmitting the rotation from shaft 224c1 to fan rotor blade 214c1, radially-rippling folded robe-shaped mixer 232c1 for mixing the gas 20c1 driving the turbine and the sucked air 21c1 to equalize temperature and speed of the exhaust gas, and further columnar lift engine direction control actuator 154c1a for direction-controlling the entirety of lift engine 102c1. The other operation of the lift engine 102c1 are similar to that of lift engine 102a1 of the first embodiment and is not described again.

FIG. 16B is an enlarged vertical section view of a right side part of a turbine driven gas generator of lift engine 102c1 in the activated state of FIG. 16A. Gas generator 200c1 has a plurality of cylindrical reactant nozzles 318c1 for lift engine, a plurality of cylindrical decomposer nozzles 334c1 for lift engine, and ring-shaped reaction chamber 270c1. The respective flow amounts of reactant 12c and decomposer 13c are adjusted by reactant flow control valve 314c1 for lift engine and decomposer flow control valve 332c1 for lift engine, and then the reactant and the decomposer are crashed to each other in reaction room 270c1 through reactant nozzle 318c1 for lift engine and decomposer nozzle 334c1 for lift engine, and thereby, reactant decomposition 33c1 to be turbine driven gas 20c1 is generated.

FIG. 16C is a partial lower section view of a turbine driven gas generator of the lift engine in the activated state of FIG. 16A, in which the gas generator is cut along 16C-16C. It is shown that reactant nozzle 318c1 for lift engine and decomposer nozzle 334c1 for lift engine are opposite to each other and disposed radially.

FIG. 16D is a top view showing an attachment part of the lift engine 102c1 to aircraft 1c of FIG. 16A. Lift engine 102c1 is attached to aircraft 1c by direction control actuator 154c1a, 154c1b for lift engine and lift engine support arm 152c1. Lift engine 102c1 can rotate by with lift engine direction control actuator 154c1b with respect to support arm 152c1. The lift engine support arm 152c1 can rotate with respect to aircraft 1c by aircraft 1c. The entirety of lift engine 102c1 is direction-controlled by lift engine direction control actuator 154c1a, 154c1b, and thereby, the direction of the exhaust gas is variously direction-controlled and the direction of the trust can be freely direction-controlled.

FIG. 17 is a vertical section view showing an activated state of a reaction control engine of the aircraft. Reaction control engines 106c2-106c4 have the same structure as reaction control engine 106c1. Reaction control engine 106c1 has, cylindrical reaction control gas generator 300c1, cylindrical reactant nozzle 319c1 for reaction control engine, cylindrical decomposer nosle 335c1 for reaction control engine, cylindrical reaction control engine direction control actuator 306c1, and ejector 304c1. The respective flow amounts of reactant 12c and decomposer 13c are by reactant flow control valve 315c1 for reaction control engine and decomposer flow control valve 333c1 for reaction control engine, and then the reactant and the decomposer are crashed to each other to be decomposed by reactant nozzle 318 for reaction control engine and decomposer nozzle 334 for reaction control engine in reaction control gas generator 300c1. Reactant decomposer flow 35c1 indicated by black arrow reaches ejector 304c1 and a surrounding air 70c1 indicated by white wide arrow is sucked in ejector 304c1 and mixed gas 71c1 of the both gases indicated by white arrow. As a result, a reaction force is applied to reaction control engine 106c1 to the upward direction, which is the opposite direction. Ejector 304c1 can rotate freely by reaction control engine direction control actuator 306c1 and reaction control to a discretionary direction is possible. Reaction control engine 106c1 has the same functions and advantages as the engine 106a1 of the first embodiment.

FIGS. 18A-18C shows a vertical takeoff and landing in a ground and the like of aircraft 1c to which another aircraft is fixed. In this way, aircraft 1c can perform vertical takeoff and landing and general take off and landing in a state with fixing another aircraft 380. By scheming the shape of attaching and detaching system 134c, aircraft 1c can be freely attached to and detached from not only another normal general aircraft but also a flying body such as an aircraft and a spacecraft which have heavy troubles. By performing takeoff and landing in the state that such a flying body is fixed thereto, the flying can be taken off and landed, safely.

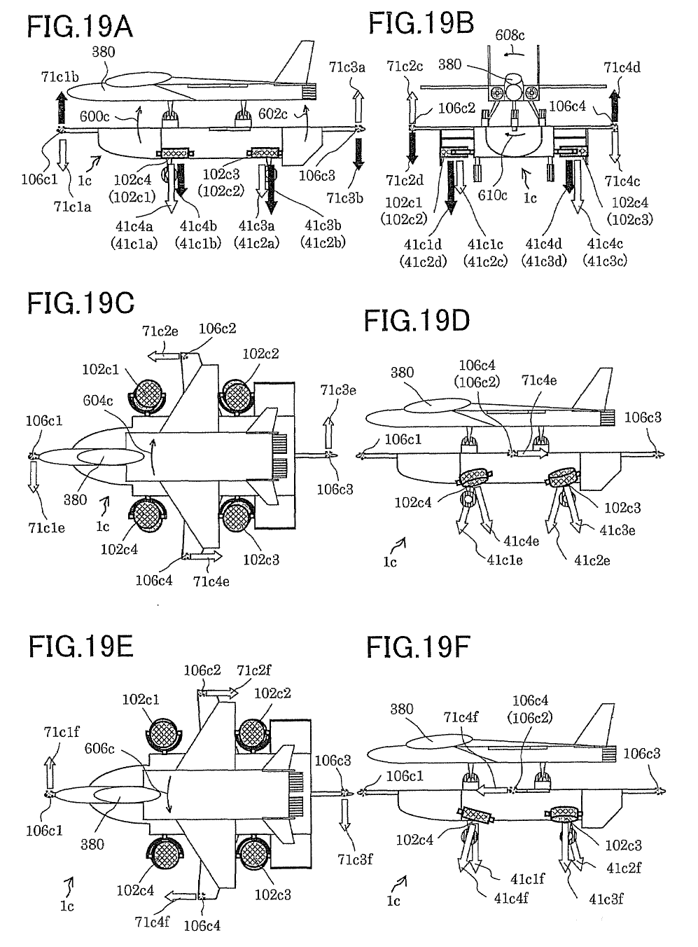

FIG. 19A is a side view showing the movement around pitch axis of aircraft 1c to which another aircraft 380 is fixed. Flow amount of gasses 41c4a and 41c1a indicated by white arrows accelerated by lift engines 102c4 and 102c1 is set to be relatively larger than flow amount of gases 41c3a and 41c2a indicated by white arrows accelerated by lift engines 102a3 and 102a2, or gas 71c1a indicated by white arrow is exhausted downward from reaction control engine 106c1 or gas 71c3a indicated by white arrow is exhausted upward from reaction control engine, 106a3, or both of the actions are performed, and thereby, nose-up force 600c around pitch axis indicated by the arrow can be applied to aircraft 1c. By contrast flow amount of gasses 41c3b and 41c2b indicated by black arrows accelerated by lift engines 102c3 and 102c2 is set to be relatively larger than flow amount of gases 41c4b and 41c1b indicated by black arrows accelerated by lift engines 102c3 and 102c2, or gas 71c1b indicated by black arrow is exhausted upward from reaction control engines 106c1 or gas 71c3b indicated by black arrow is exhausted downward from reaction control engine 106a3, or both of the actions are performed, and thereby, nose-down force 602c around pitch axis indicated by the arrow can be applied to aircraft 1c.

FIG. 19B is a front view showing the movement around roll axis of aircraft 1c to which aircraft 380 is fixed. Flow amount of gasses 41c4c and 41c3c indicated by white arrows accelerated by lift engines 102c4 and 102c3 is set to be relatively larger than flow amount of gases 41c1c and 41c2c indicated by white arrows accelerated by lift engines 102c1 and 102c2, or gas 71c2c indicated by white arrow is exhausted upward from reaction control engine 106c4 or gas 71c4c indicated by white arrow is exhausted downward from reaction control engine 106a4, or both of the actions are performed, and thereby, right-roll force 608c around roll axis can be applied to aircraft 1a. By contrast flow amount of gasses 41c1d and 41c2d indicated by black arrows accelerated by lift engines 102c1 and 102c2 is set to be relatively larger than flow amount of gases 41c4d and 41c3d indicated by black arrows accelerated by lift engines 102c4 and 102c3, or gas 71c2d indicated by black arrow is exhausted downward from reaction control engine 106c2 or gas 71c4a indicated by black arrow is exhausted upward from reaction control engine 106c4, or both of the actions are performed, and thereby, left-roll force 610c around roll axis can be applied to aircraft 1c.

FIGS. 19C and 19D are a top view and a side view showing an example of the clockwise movement of nose around yaw axis of aircraft 1c to which aircraft 380 is fixed. Gasses 41c1e-41c4e indicated by white arrows are exhausted counterclockwise and downward from lift engines 102c1-102c4, or gases 71c1e-71c4e are exhausted counterclockwise to horizontal plane from reaction control engines 106c1-106c4, or both of the actions are performed, and thereby, clockwise force 604c around yaw axis indicated by the arrow can be applied to aircraft 1c to which aircraft 380 is fixed.

FIGS. 19E and 19F are an upper view and a side view showing an example showing an example of the counterclockwise movement of nose around yaw axis of aircraft 1c to which aircraft 380 is fixed. Gasses 41c1f-41c4f indicated by white arrows are exhausted clockwise and downward from lift engines 102c1-102c4, or gases 71c1f-71c4f are exhausted clockwise to horizontal plane from reaction control engines 106c1-106c4, or both of the actions are performed, and thereby, counterclockwise force 606c around yaw axis indicated by the arrow can be applied to aircraft 1c to which aircraft 380 is fixed.

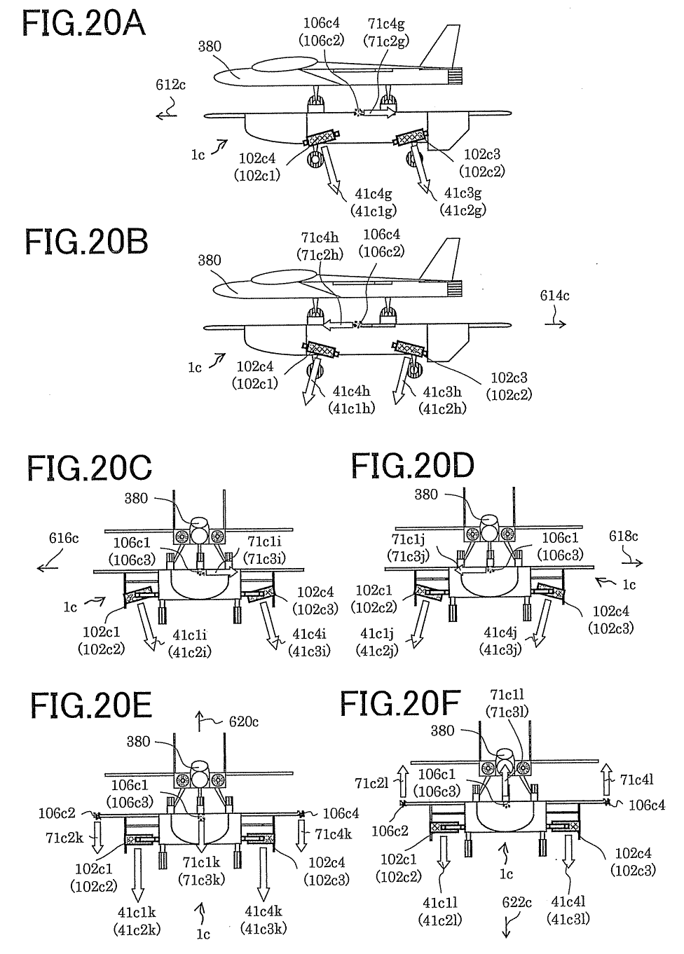

FIG. 20A is a side view showing forward movement of aircraft 1c to which aircraft 380 is fixed. Gases 41c1g-41c4g indicated by white arrows are exhausted backward and downward from lift engines 102c1-102c4, or gases 71c4g and 71c2g indicated by white arrows are exhausted backward from reaction control engines 106c4 and 106c2, or both of the actions are performed, and thereby, aircraft 1c can be provided with forward force 612c.

FIG. 20B is a side view showing backward movement of aircraft 1c to which aircraft 380 is fixed. Gases 41c1h-41c4h indicated by white arrows are exhausted forward and downward from lift engines 102c1-102o4, or gases 71c4h and 71c2h indicated by white arrows are exhausted forward, or both of the actions are performed, and thereby, aircraft 1c can be provided with backward force 614c.

FIG. 20C is a front view showing rightward movement of aircraft 1c to which aircraft 380 is fixed. Gasses 4c1i-41c4i indicated by white arrows are direction-controlled downward and leftward and exhausted from lift engines 102c1-102c4, or gases 71c1i and 71c3i indicated by white arrows are exhausted leftward from reaction control engines 106c1 and 106c3, or both of the actions are performed, and thereby, aircraft 1c to which aircraft 380 is fixed can be provided with a force 616c for rightward movement.

FIG. 20D is a front view showing leftward movement of aircraft 1c to which aircraft 380 is fixed. Gasses 41e1j-41c4j indicated by white arrows are direction-controlled downward and rightward and exhausted from lift engines 102c1-102c4, or gases 71c1j and 71c3j indicated by white arrows are exhausted rightward from reaction control engines 106c1 and 106c3, or both of the actions are performed, and thereby, aircraft 1c to which aircraft 380 is fixed can be provided with a force 618c for leftward movement.

FIG. 20E is a front view showing moving up of aircraft 1c to which aircraft 380 is fixed. Flow amount of 41c1k-41c4k indicated by white arrows exhausted from lift engines 102c1-102c4 is set to be larger than that in hovering, or gases 71c1k-71c4k indicated by white arrows are exhausted downward from reaction control engines 106c1-106c4, or both of the actions are performed, and thereby aircraft 1c to which aircraft 380 is fixed can be provided with a force 620c for moving up.

FIG. 20F is a front view showing moving down of aircraft 1c to which aircraft 380 is fixed. Flow amount of 41c1l-41c4l indicated by white arrows exhausted from lift engines 102c1-102c4 is set to be smaller than that in hovering, or gases 71c1l-71c4l indicated by white arrows are exhausted upward from reaction control engines 106c1-106c4, or both of the actions are performed, and thereby, aircraft 1c to which aircraft 380 is fixed can be provided with a force 622c for moving down.

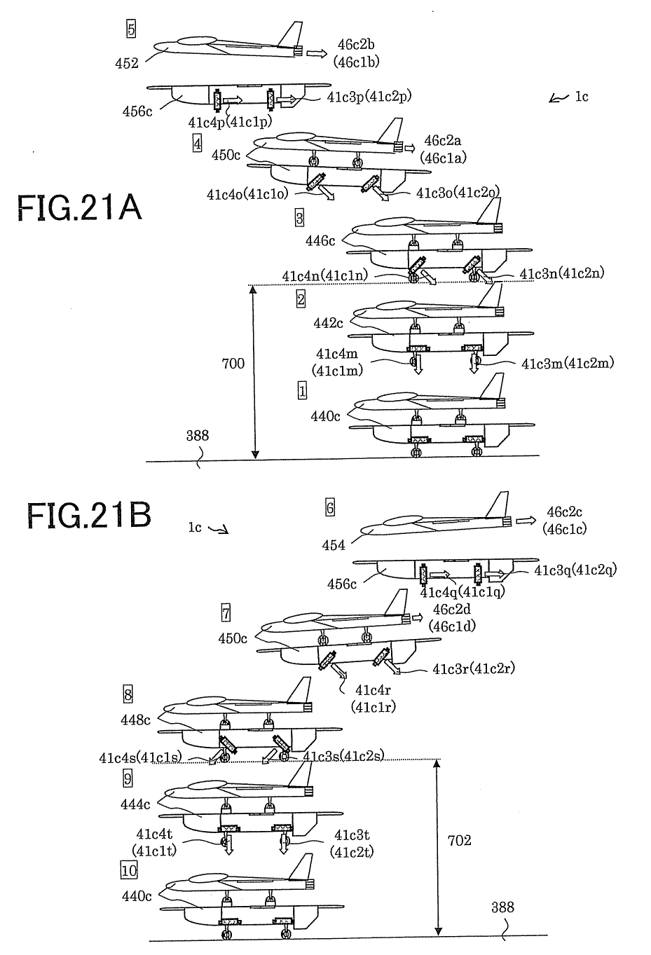

FIGS. 21A and 21B are side views which are useful for explaining vertical takeoff and landing of, aircraft 1c being capable of detaching from and attaching to a flying body and of vertically taking off and landing, and aircraft 380. Digits 1-10 surrounded by rectangles indicate the respective processes of vertical takeoff and landing states.

In FIG. 21A, aircraft 1c activates the lift engines to downward exhaust gases 41c1m-41c4m indicated by white arrows from a plain and the like 388 and thereby moves up (442c), and reaches a predetermined takeoff altitude 700 (446c). Then, gases 41c1n-41c4n indicated by white arrows are exhausted downward and backward from the lift engines to transfer to forward and upward movement gases 46c1a-46c2a indicated by white arrow are generally exhausted from aircraft 380, and therewith, gases 41c1o-41c4o indicated by white arrows from the lift engines are exhausted downward and backward to move up forward and upward. Then, after sufficient lifting powers are generated in the wings of aircraft 380, aircraft 380 is detached from the vertical takeoff and landing aircraft 1c being capable of detaching from and attaching to a flying body, by attaching and detaching system 134c (450c). The vertical takeoff and landing aircraft 1c being capable of detaching from and attaching to a flying body performs flight with backward exhausting gases 41c1p-41c4p indicated by white arrows from the lift engines (456c), and aircraft 380 continues general moving up (452) with exhausting gases 46c1b-46c2b indicated by white arrow.

In FIG. 21B, aircraft 380 exhausts gases 46c1c-46c2c indicated by white arrow from flight engines to perform general moving down (454), and the vertical takeoff and landing aircraft 1c being capable of detaching from and attaching to a flying body performs flight with backward exhausting gases 41c1q-41c4q indicated by white arrows from the lift engines (456c). Aircraft 380 generally reduces gases 46c1d-46c2d indicated by white arrow, and the aircraft 1c being capable of detaching from and attaching to a flying body moves down with adjusting movement to that of aircraft 380 and with controlling forward and downward and exhausting gases 41c1r-41c4r indicated by white arrow, and then contacts aircraft 380 (450c). Then, by attaching and detaching system 134c, aircraft 380 is fixed to the vertical takeoff and landing aircraft 1c being capable of detaching from and attaching to a flying body, and with adjusting movement to that of aircraft 380, and gases 41c1s-41c4s indicated by white arrow are controlled front-forward and exhausted and the forward movement is reduced, and therewith, the aircrafts reaches a predetermined landing altitude 702 (448c). Then, the aircraft 1c being capable of detaching from and attaching to a flying body lowers with controlling the flow amount of gasses 41a1s-41a4s indicated by white arrows from the lift engines (444c), and then lands on a plain and the like 388 (440c).

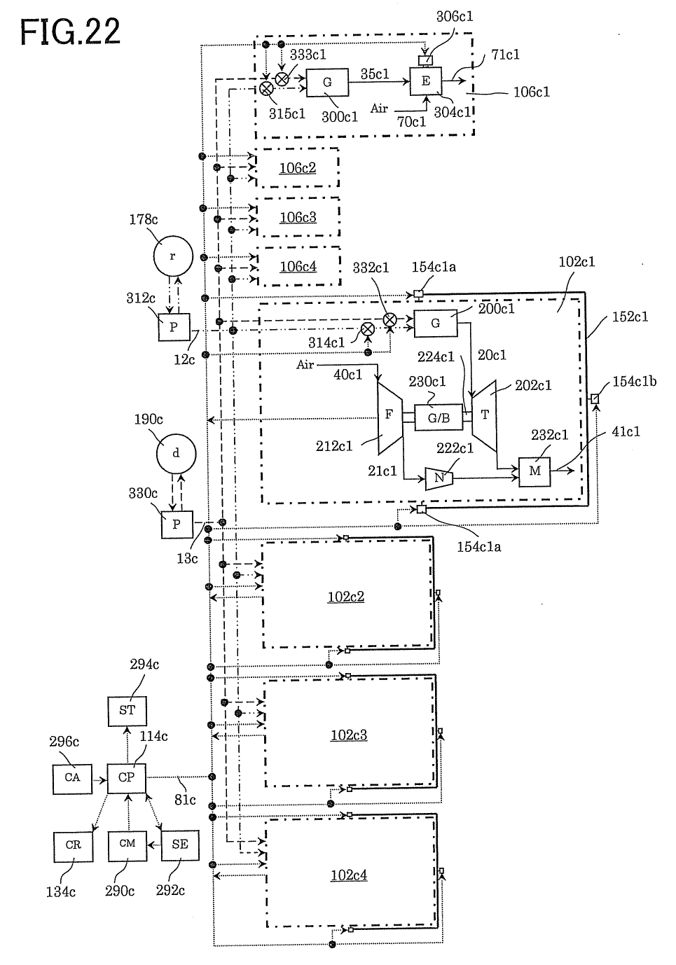

FIG. 22 is a block diagram of fluid and electric system of aircraft 1c. In aircraft 1c, reactant 12c stored in reactant tank 178c is pressurized by reactant pressurizing system or device 312c, and supplied to turbine driven gas generators 200c1-200c4 of lift engines 102c1-102c4 and to reaction control gas generators 300c1-300c4 of reaction control engines 106c1-106c4, through reactant flow control valves 314c1-314c4 for lift engines or through reactant flow control valves 315c1-315c4 for reaction control engines. On the other hand, decomposer 13c stored in decomposer tank 190c is pressurized by decomposer pressuring system or device 330c, and supplied to turbine driven gas generators 200c1-200c4 of lift engines 102c1-102c4 and to reaction control gas generators 300c1-300c4 of reaction control engines 106c1-106c4, through decomposer flow control valves 332c1-332c4 for lift engines or through decomposer flow control valves 333c1-333c4 for reaction control engines. The structures of lift engines 102c2-102c4 are similar to the structure of lift engine 102c1, and hence lift engine 102c1 will be described here. In lift engine 102c1, turbine driven gas 20c1 generated in turbine driven gas generator 200c1 drives turbine 202b1 and then reaches mixer 232c1. The power obtained in turbine 202c1 drives fan 212c1 through shaft 224c1 and transmission 230c1. Fan 212c1 sucks surrounding air 40c1. Air 21c1 pressurized fan 212c1 and reaches nozzle 222c1. In nozle 222c1, pressure of air 21b1 is converted into speed and thereby air 21b1 is accelerated to reach mixer 232c1. In mixer 232c1, some of turbine driven gas 20c1 and air 21c1 are mixed and passed through exhaust direction control louver 254b1 and exhausted (41c1) and thereby, a reaction force is generated in lift engine 102c1.

The structures of reaction control engines 106c2-106c4 are similar to the structure of reaction control engine 106c1, and hence reaction control engine 106c1 will be described here. In reaction control engine 106c1, reactant decomposition 35c1 generated in reaction control gas generator 300c1 sucks surrounding air 70b1 and is exhausted, by ejector 304c1 (71c1), and thereby, reaction force is generated. Direction ofejector 304c1 can be freely direction-controlled by reaction control engine direction control actuator 306c1.

Control system or device 290c assigns charge to computer 114c according to information of sensor 292c detecting various states of the body and the like. According to the charge, computer 114c controls lift engines 102c1-102c4, reaction control engines 106c1-106c4, reaction control engines 106c1-106c4, attaching and detaching system or device 134c, steering systems or devices 294c, and the like.

It is preferable that the reactant and the decomposer are liquids of normal temperature and high density in the aspects of storage stability and storage quality, but the reactant and the decomposer are not limited thereto in the same manner as the other embodiments. The liquid reactant and the liquid decomposer are used to reduce volume of tubes and the like for introducing the oxider and the fuel to lift engines 102c1-102c4 and reaction control engines 106c1-106c4, and degree of freedom of the system arrangement is improved.

Different kinds of reactant may include hydrogen peroxide, an aqueous solutions thereof, hydrazine, a derivative thereof, and the like. Among them, hydrogen peroxide or an aqueous solution thereof is preferable because of not generating harmful substance at all. As described above, a hydrogen peroxide aqueous solution whose concentration by weight is 30-80% by weight is relatively low-risk and can be easily handled. The hydrogen peroxide aqueous solution or the hydrogen peroxide aqueous solution of higher concentration and hydrogen peroxide are advantageous in practical use.

When the reactant is hydrogen peroxide or an aqueous solution thereof, Kinds of the decomposer may be potassium iodide, permanganic salt, or aqueous solutions thereof and the like, an alkaline solution, or an enzyme alkaline solution such as catalase or peroxidase, or the like.

### Fourth Embodiment

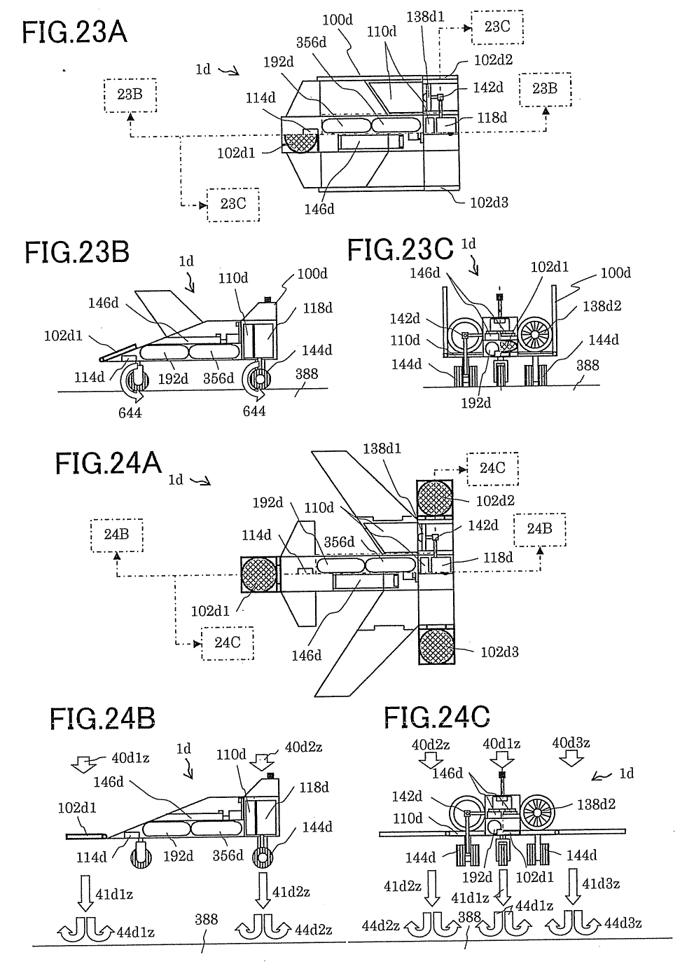

FIGS. 23A to 23C show a top view and aright-half-cut upper section view in taxing of the aircraft being capable of taxing and vertically taking off and landing according to the fourth embodiment of the invention, a side section view in which the aircraft is cut along 23B-23B, and a front view and a front section view in which the aircraft is cut along 23C-23C, respectively. Aircraft 1d has body 100d including, fuel tank 110d and the like which are general components of an aircraft and driving wheel 144d and the like which are general components of an automobile, and additionally the aircraft has thin rectangle-shaped lift engines 102d1-102d3, rectangular-parallelepiped-shaped computer 114d, rectangular-parallelepiped-shaped run and flight engine 118d, disc-shaped flight fans 138d1-138d2, rectangular-parallelepiped-shaped power switch system or device 142d, rectangle-shaped rescue bed 146d, compression oxider gas canister 192d whose both ends have hemispheroidal shapes and whose central part has a cylindrical shape, and compressed fuel gas canister 356d whose both ends have hemispheroidal shapes and whose central part has a cylindrical shape. The power generated in run and flight engine 118d is transmitted to driving wheel 144d through power switch system 142d, and the aircraft can run on plain and the like 388. For performing taxing, wings and lift engines 102d1-102d3 of aircraft 1d are in states of being folded.

Aircraft 1d is a flying body in which an automobile and a vertical takeoff and landing aircraft are merged, and can be assigned in a fire station, a hospital, a remote area, and the like, which do not have facilities such as a heliport. When aircraft 1d is used, a seriously-injured person or suddenly ill person requiring prompt action can be more rapidly transferred than using a conventional conveyance such as an ambulance or an EMS helicopter, without being subjected to excess load. Aircraft 1d can be operated in a disaster site, a fire site, a tall building, and a tall-building.

FIGS. 24A-24C show, a top view and a right-half-cut upper section view in takeoff and landing of aircraft 1d, a side section view in which the aircraft is cut along 24B-24B, and a front view and a front section view in which the aircraft is cut along 24C-24C, respectively. For performing vertical takeoff and landing, the aircraft is in a state that wings of aircraft 1d and lift engines 102d1-102d3 are unfolded and activated.

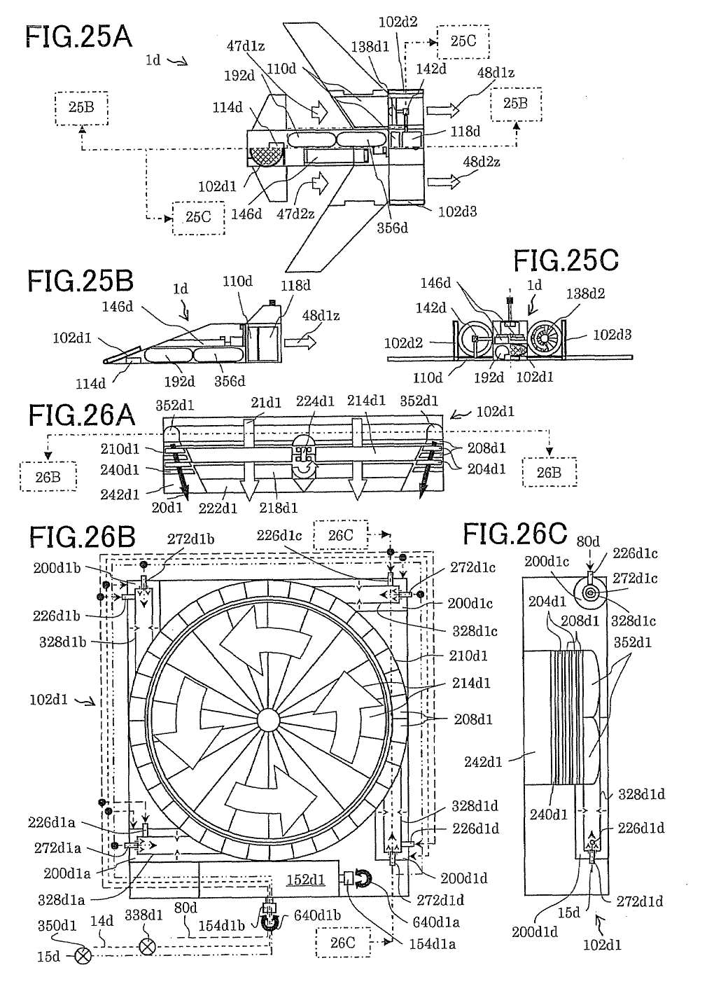

FIGS. 25A-25C show a top view and a right-half-cut upper section view in a flight state of aircraft 1d, a side section view in which the aircraft is cut along 25B-25B, and a front view and a front section view in which the aircraft is cut along 25C-25C, respectively. The power generated in run and flight engine 118d is activated with being transmitted flight fans 138d1-138d2 through power switch system 142d. For performing flight, the aircraft is in the states that lift engines 102d1-103d3 of aircraft 1d are folded so as not to cause harmful resistance and that driving wheel 144d is also housed.

FIGS. 26A-26C are a vertical section view and a horizontal section view of lift engine 102d1 in an activated state of aircraft 1d. Lift engines 102d2-102d3 have the same structure as lift engine 102d1. In the view, fundamentally, the structure of lift engine 102d1 is rotational symmetry, for making the view concise, the same serial symbols are appended to the same respective components. Lift engine 102d1 has, a can-shaped turbine driven gas generators 200d1a-200d1d of generating gas 20d1 for driving the turbine indicated by the black arrow, annular turbine driven gas manifold 352d1 which gathers gas 20d1 generated in turbine driven gas generators 200d1a-200d1d and which has a vertical central axis and has an annular openings to the lower direction, cylindrical liners 328d1a-328d1d which are provided in each of turbine driving gas generators 200d1a-200d1d and which have columnar igniters 226d1a-226d1d used for ignition of turbine driven gas 20d1 and columnar fuel nozzles 272d1a-272d1d for lift engine for ejecting fuel gas 15d and a plurality of openings, a plurality of coaxial radial turbine stator blades 208d1 for accelerating and turning gas 20d1, a plurality of coaxial radial turbine rotor blades 204d1 for taking mechanical work out of gas 20d1, coaxial cylindrical turbine case 210d1 for preventing the broken pieces from scattering outside the engine if a turbine rotor blade 204d1 and fan rotor blade 214d1 are broken and scattered, a plurality of coaxial radial direction control vane 240d1 for calibrating to the axial direction the biased flow of gas 20d1 after driving turbine rotor blade 204d1, diffuser 242d1 of which the opening area of the bottom face is larger than the opening area of the upper face for converting speed of gas 20d1 to pressure and which is formed by the interval between the coaxial cylinder (turbine case 210d1) and reverse truncated cone, a plurality of coaxial radial fan rotor blades 214d1 for sucking and accelerating surrounding air, a plurality of coaxial radial fan stator blades 240d1 for converting speed of sucked air 21d1 indicated by the white arrow to pressure, coaxial reverse-truncated-cone shaped nozzle 222d1 whose opening area of the bottom face is smaller than the opening area of the top face, coaxial shaft 224d1 to be a rotational center of turbine rotor blade 204d1 and fan rotor blade 214d1, lift engine support arm 152d1 having a movable portion and supporting lift engine 102d1, and lift engine direction-control actuators 154d1a-154d1b for controlling the direction of lift engine 102d1.

The respective flow amounts of oxider gas 14d and fuel gas 15d are adjusted by oxider gas flow control valve 338d1 and fuel gas flow control valve 350d1, and then the gases arrive inside gas generators 200d1a-200d1d. Fuel gas 15d passes through fuel nozzle 272d1a-272d1d for lift engine and is ejected to liners 328d1a-328d1d and reacted with oxider gas 14d by igniters 226d1a-226d1d receiving ignition signal 80d and thereby generates turbine driven gas 20d1. Flows of turbine driven gas 20d1 join together in turbine driven gas manifold 352d1 and then passes through turbines 204d1 and 208d1 and thereby, the energy that the gas has in itself decreases and the flow biased by direction control vane 240d1 is calibrated to axial direction, and then residual excess speed energy is converted into pressure energy in diffuser 242d1, and the gases are exhausted from lift engine 102d1. Turbine rotor blade 204d1 transmits the power to fan rotor blade 214d1 in which the same shaft 224 is set to the rotational center, and air 21d1 is sucked and compressed in fans 214d1 and 218d1. The air 21d1 is accelerated by nozzle 222d1 and then exhausted from lift engine 102d.

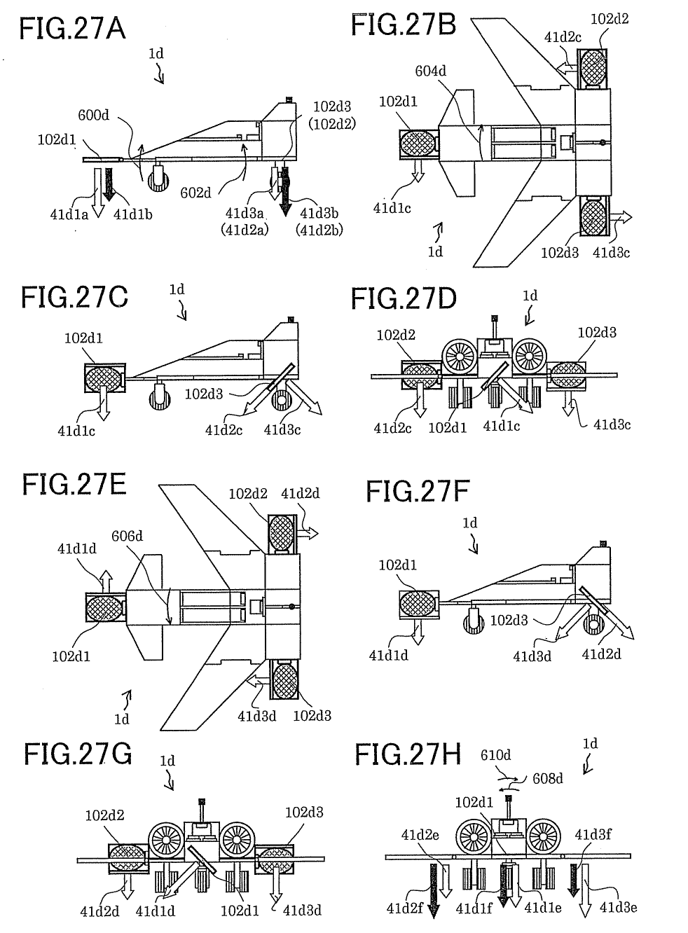

FIG. 27A is a side view showing the movement around pitch axis of aircraft 1d. Flow amount of gas 41d1a indicated by white arrow accelerated by lift engine 102d1 is set to be relatively larger than flow amount of gases 41d3a and 41d2a indicated by white arrows accelerated by lift engine 102d3 and lift engine 102d2 existing at a symmetric position thereof, and thereby, nose-up force 600d around pitch axis indicated by the arrow can be applied to aircraft 1d. By contrast, flow amount of gasses 41d3b and 42d1b indicated by black arrows accelerated by lift engines 102d3 and 102d2 is set to be relatively larger than flow amount of gas 41d41b indicated, and thereby, nose-down force 602d around pitch axis indicated by the arrow can be applied to aircraft 1d.

FIGS. 27B and 27D are a top view, a side view, and a front view showing the clockwise movement of nose around yaw axis of aircraft 1d. Gasses 41d1d-41d3c indicated by white arrows are exhausted counterclockwise and downward from lift engines 102d1-102d3, and thereby, clockwise force 604d around yaw axis indicated by the arrow can be applied to aircraft 1d.

FIGS. 27E-27G are a top view, a side view, and a front view showing the counter clockwise movement of nose around yaw axis of aircraft 1d. Gasses 41d1d-41d indicated by white arrows are exhausted clockwise and downward from lift engines 102d1-102d3, and thereby, counterclockwise force 606d around yaw axis indicated by the arrow can be applied to aircraft 1d.

FIG. 27H is a front view showing the movement around roll axis of aircraft 1d. Flow amount of gas 41d3e indicated by white arrow accelerated by lift engine 102d3 is set to be relatively larger than flow amount of gas 41d2e indicated by white arrow accelerated by lift engine 102d2, and thereby, right-roll force 608d around roll axis can be applied to aircraft 1d. By contrast, flow amount of gas 41d2f indicated by black arrow accelerated by lift engine 102d2 is set to be relatively larger than flow amount of gas 41d2f indicated by black arrow accelerated by lift engine 102d2, and thereby, left-roll force 610d around roll axis can be applied to aircraft 1d.

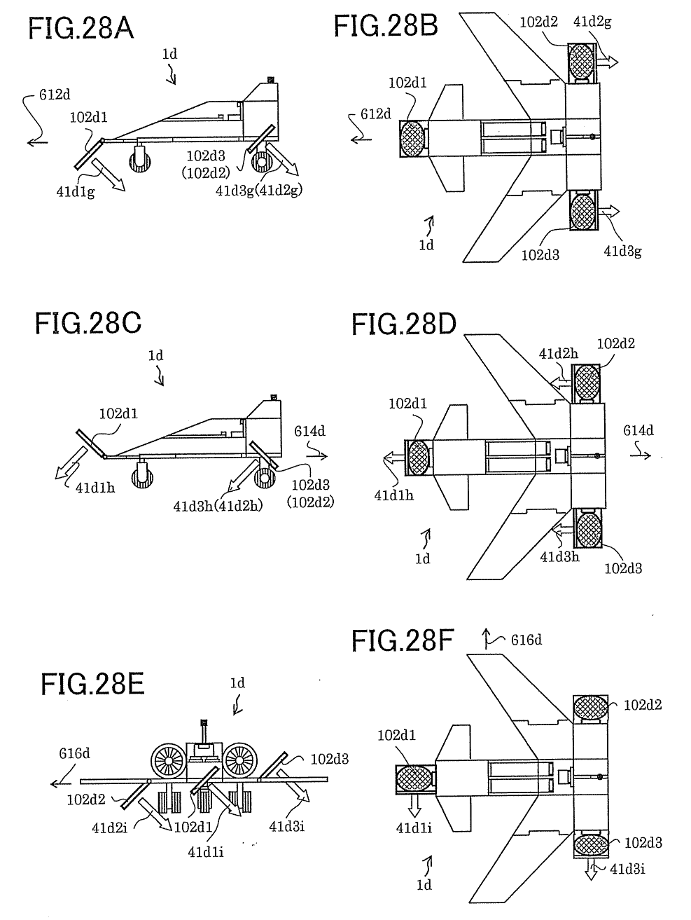

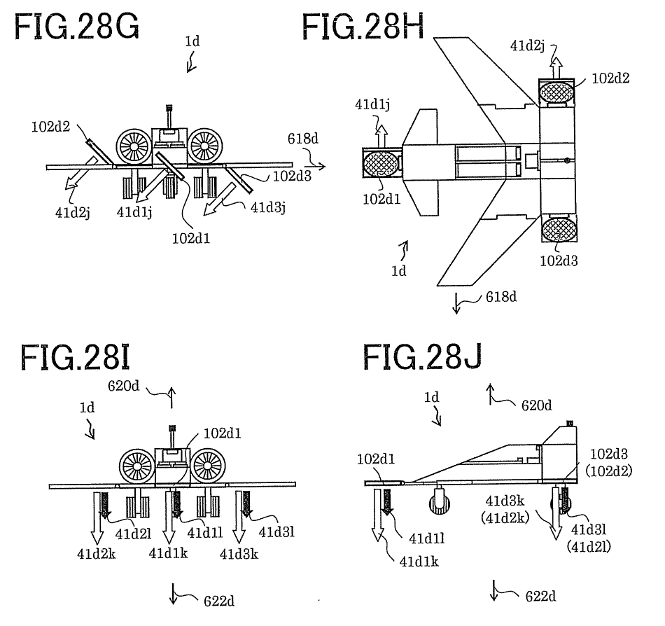

FIGS. 28A and 28B are a side view and a top view showing forward movement of aircraft 1d. Gases 41d1g-41d3g indicated by white arrows are exhausted backward and downward from lift engines 102d1-102d3, and thereby, aircraft 1d can be provided with forward force 612d.

FIGS. 28C and 28D are a side view and a top view showing backward movement of aircraft 1d. Gases 41d1h-41d3h indicated by black arrows are exhausted forward and downward from lift engines 102d1-102d3, and thereby, aircraft 1d can be provided with backward force 614d.

FIGS. 28E and 28F are a front view and a top view showing the rightward movement of aircraft 1d. Gasses 41d1i-41d3i indicated by white arrows is direction-controlled downward and leftward and exhausted from lift engines 102d1-102d3, and thereby, aircraft 1d can be provided with a force 616d for rightward movement.

FIGS. 28G and 28H are a front view and a top view showing a left movement of aircraft 1d. Gasses 41d1j-41d3j indicated by white arrows are direction-controlled downward and rightward and exhausted from lift engines 102d1-102d3, and thereby, aircraft 1d can be provided with a force 618d for leftward movement.

FIGS. 28I and 28J are a front view and a side view showing moving up of aircraft 1d. Flow amount of gasses 41d1k-41d3k indicated by white arrows exhausted from lift engines 102d1-102d3 is set to be larger than that in hovering, aircraft 1d can be provided with a force 620d for moving up. On the other hand, flow amount of gasses 41d1l-41d3l indicated by black arrows exhausted from lift engines 102d1-102d3 is set to be smaller than that in hovering, aircraft 1d can be provided with a force 622d for moving down.

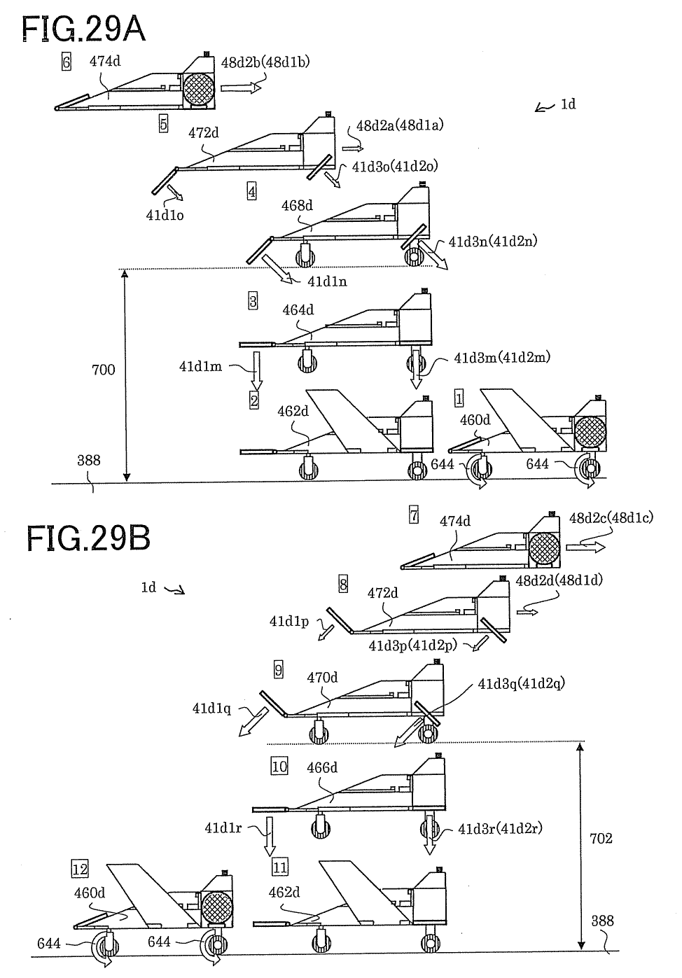

FIGS. 29A and 29B are useful for explaining vertical takeoff and landing of aircraft 1d. Digits 1-12 surrounded by rectangles indicate the processes from a taxing state through a vertically taking-off state to a flight state of aircraft 1d and from a flight state through a vertically landing state to a taxing state thereof.

FIG. 29A, aircraft 1d taxies on a plain and the like 388 by using driving wheels and the like (460d) and reaches the takeoff site and unfolds lift engines (462d). Then, the lift engines are activated to exhaust downward gases 41d1m-41d3m indicated by white arrows and thereby, the aircraft moves up, and the wings are unfolded at an altitude in which the aircraft does not interfere with a building and the like (464d), and then, the aircraft reaches a predetermined takeoff altitude 700 (468d). Then, gases 41d1n-41d3n indicated by white arrows are exhausted downward and backward from the lift engines to transfer to forward and upward movement, gases 48d1a-48d2a indicated by white arrow are generally exhausted from flight fans, and therewith, gases 41d1o-41d3o indicated by white arrows from the lift engines are exhausted downward and backward to move up forward and upward with generally reducing flow amounts of the gases (472d), and eventually, the lift engines of aircraft 1d are folded after stopped, gases 48d1b-48d2b indicated by white arrows are exhausted and then the aircraft performs general flight (474d).

In FIG. 29B, aircraft 1d exhausts gases 48d1c-48d2c indicated by white arrow from the flight fans and thereby to performed general flight (474d), and gases 48d1d-48d2d indicated by white arrow are generally reduced and gases 41d1p-41d3p indicated by white arrows are generally increased and exhausted forward and downward from the lift engines and therewith the aircraft moves down (472d). Then, the aircraft stops the flight fans and exhausts gases 41d1q-41d3q indicated by white arrows forward and downward and reaches predetermined landing altitude 702 (470d). Then, with controlling flow amounts of gases 41d1r-41d3r indicated by white arrows, aircraft 1d moves down with folding the wings at an altitude in which the aircraft does not interfere with a building and the like (466d), and the aircraft lands on plain and the like 388 (462d), and then, after the lift engines are folded, the aircraft taxies on a plain and the like 388 by using driving wheels and the like (460d).

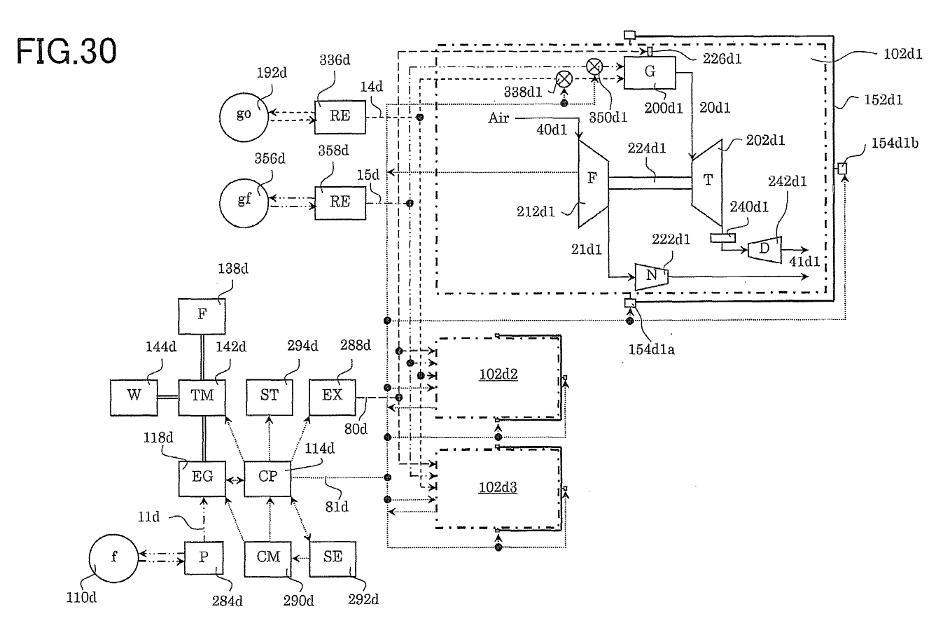

FIG. 30 is a block diagram of fluid and an electric system of aircraft 1d. Oxider gas 14d stored in compression oxider gas canister 192d is decompressurized by oxider gas decompressurizing system or device 336d, and flow amount of the gas is controlled by oxider gas flow control valves 338d1-338d3 of lift engines 102d1-102d3, and then the gas is supplied to turbine driven gas generators 200d1-200d3. Moreover, fuel gas 15d stored in compressed fuel gas canister 356d is decompressurized by fuel gas decompressurizing system or device 358d, and the flow amount of the gas is controlled by fuel gas flow control valves 350d1-350d3, and then the gas is supplied to turbine driven gas generators 200d1-200d3. On the other hand, fuel 11d stored in fuel tank 110d is pressurized by fuel pressuring system or device 284d and supplied to run and flight engine 118d. The structures of lift engines 102d1-102d3 are similar to the structure of lift engine 102d1, and hence lift engine 102d1 will be described here. In lift engine 102d1, turbine driven gas 20d1 generated in turbine driven gas generator 200d1 drives turbine 202d1 and then passes through direction control vane 240d1 and reaches diffuser 242d1 and is exhausted (41d1). The power obtained in turbine 202d1 drives fan 212d1 through shaft 224d1 and sucks surrounding air 40d1. Air 21d1 pressurized by fan 212d1 reaches nozzle 222d1 and pressure thereof is converted into speed and exhausted (41d1). The respective lift engines 102d1-102d3 are connected to aircraft 1d through lift engine support arms 152d1-152d3 and lift engine direction control actuator 154d1a-154d3a and 154d1b-154d3b, the thrust plane can be freely direction-controlled.

Control system 290d assigns charge to computer 114a according to information of sensor 292d detecting various states of the body and the like. According to the charge, computer 114d controls lift engines 102d1-102d3, run and flight engine 118d, power switch system 142d, steering system 294d, ignition system 288d, and the like, through control signal 81d. Ignition system 288d generate ignition signals 80d to igniters 226d1-226d3 to ignite turbine driven gas generators 200d1-200d3. In power switch system 142d, the power from run and flight engine 118d is switched to flight fan 138d or driving wheel 144d, according to flight state or taxing state.

When the oxider gas or the fuel gas is compressed and filled at a higher pressure, volume of compression oxider gas canister 192d or compressed fuel gas canister 356d becomes small.

Different kinds of oxider gas may include oxygen or air. Air has an advantage of being capable of being easily refilled only by introducing compressor and the like onto the aircraft.

Different kinds of the fuel gas may include hydrogen, natural gas, propane, and methane. The combination of hydrogen and oxygen has an advantage of not generating harmful substance at all.

By any possibility, compressed gas such as air or helium gas can also be used instead of the oxider gas or the fuel gas, to perform short-time vertical takeoff and landing only by utilizing the expansion power of the gas.

Different kinds of the fuel may include, hydrocarbon fuel such as gasoline (including GTL), mixed fuel of hydrocarbon fuel and an alcohol and an aqueous solution thereof, and the like. In particular, mixed fuel of a bioalcohol and an aqueous solution thereof generates little environmental pollutant containing carbon dioxide is small. Hydrocarbon fuels such as coal oil and gasoline is low-risk and can be easily handled and is low-cost because of being easily obtainable.

### Fifth Embodiment

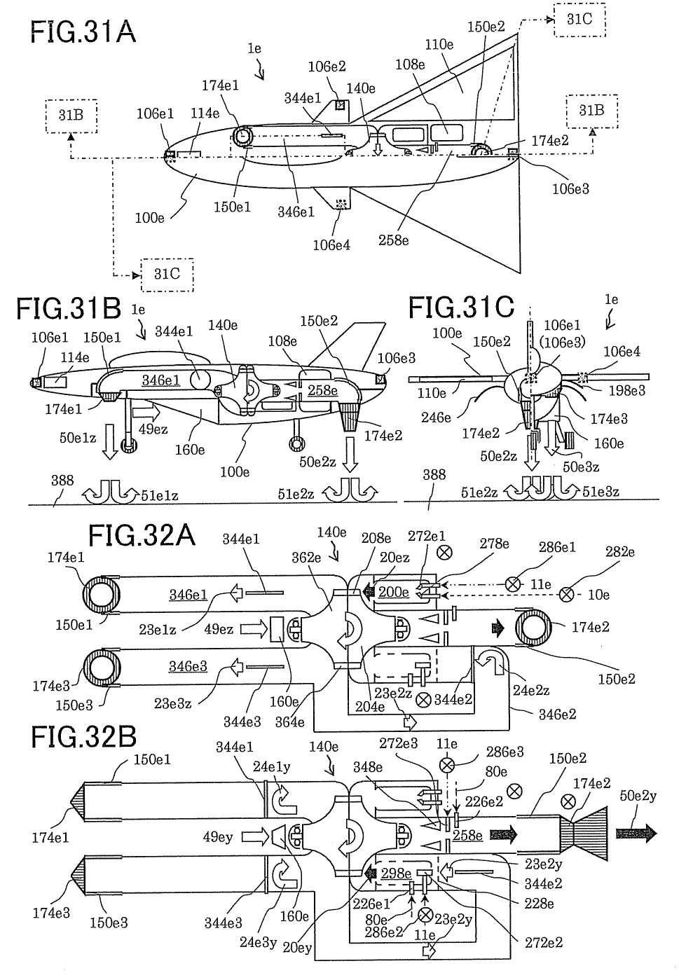

FIGS. 31A to 31C are an upper view and a right-half-cut upper section view in vertical takeoff and landing in a ground and the like of the aircraft that a lift engine and a flight engine according to the fifth embodiment of the invention are integrated with, a side section view in which the aircraft is cut along 31B-31B, and a front view and a front section view in which the aircraft is cut along 31C-31C, respectively. Aircraft 1e has body 100e including fuel tank 110e and the like which are general components of an aircraft, and additionally the air craft has lift and flight engine 140e having an abacus bead shape, reaction control engines 106e1-106e4 each having a shape in which two orthogonal cylinders are combined crisscross, rectangular-parallelepiped-shaped oxider tank 108e, rectangular-parallelepiped-shaped computer 114e, bendable tubular flexible ducts 150e1-150e3, rectangle-shaped changeable air intake lamp 160e that can change, truncated-cone-shaped changeable area exhaust direction control nozzles 174e1-174e3 whose areas of throat portions and exits for exhaust gas can be discretionarily changed, movable shell-shaped exhaust nozzle contain doors 198e1 and 198e3, movable shell-shaped flexible duct contain doors 246e, operative disc-shaped air flow control valves 344e1-344e3, and tubular ducts 346e1-346e3. Air 49ez taken in from changeable air intake lamp 160e is compressed in lift and flight engine 140e and flow amount of the air is controlled by air flow control valves 344e1 and 344e3 and then, the air sequentially passes through ducts 346e1 and 346e3, flexible ducts 150e1 and 150e3, changeable area exhaust direction control nozzles 174e1 and 174e3 and then is exhausted (50e1z and 50e3z). Moreover, the gas driving lift and flight engine 140e sequentially passes through, tubular afterburner 258e (non-combustion at this time), flexible duct 150e2, and changeable area exhaust direction control nozzle 174e2, and then is exhausted (50e2z). If these exhaust gases 50e1z-50e3z are dispersed up on plain and the like 388 (51e1z-51e3z) and some of the gases are mixed in air 49ez again, the output can be freely control with being hardly subjected to the effect and hence, safe vertical takeoff and landing is possible. In FIGS. 31B and 31C, there can be seen the state in which exhaust nozzle contain doors 198e1 and 198e3 and flexible duct contain door 146e are opened and changeable area exhaust direction control nozzles 174e1-174e3 is exposed downwardly. Shapes of lamp 160e and exhaust nozzles 174e1-174e3 are appropriately changed according to flight speed and use status. Aircraft 1e is a flying body whose weight is saved by integrating the lift engine and the flight engine, and can perform active maneuver, supersonic flight, and the like.

FIGS. 32A-32B are horizontal section views useful for explaining operations of lift and flight engine 140e and its related components in a vertical takeoff and landing state and a flight state of the aircraft 1e. Lift and flight engine 140e has, turbine driven gas generator 200e, combustion chamber 298e, columnar igniters 226e1-226e2, cylindrical fuel nozzles 272e1-272e3, oxider nozzle 278e, half-abacus-bead-shaped turbine rotor blade 204e having a rotational axis, a plurality of stator blades 208e having channels on the periphery, coaxial half-abacus-bead-shaped compressor rotor blade 362e connected to turbine rotor blade 204e1, a plurality of compressor stator blades 364e having channels on the periphery, net-like diffusion plate 228e, and a plurality of wedge-shaped flame holders 348e. The compressor formed by compressor rotor blade 362e and compressor stator blade 364e is a fan for compression with a high pressure.

The related components in a vertical takeoff and landing state of the aircraft 1e will be described. In FIG. 32A, the respective flow amounts of oxider 10e and fuel 11e having autoignition property are controlled by oxider flow control valve 282e for lift engine and fuel flow control valve 286e1 for lift engine and then, are crashed to each other in turbine driven gas generator 200e1 through oxider nozzle 278 and fuel nozzle 272 and thereby to generate turbine driven gas 20ez indicated by black arrow. Gas 20ez drives turbine rotor blade 204e to the direction indicated by white arrow through turbine stator blade 208e, and then is direction-controlled downward (backward with respect to the page space) through flexible duct 150e2 and passes through changeable area exhaust direction control nozzle 174e2 and is exhausted outward (50e2z of FIGS. 31B and 31C). On the other hand, the power obtained in the turbine rotor blade 204e drives compressor rotor blade 362e to the direction indicated by white arrow. Air 49ez indicated by white arrow, which passes through changeable air intake lamp 160e and is sucked, is compressed by the compressor 362e and 364e (23e1z-23e3z), reaches air flow control valves 344e1-344e3. Here, because air flow control valve 344e2 is closed, air 242e2z indicated by white arrow in duct 346e2 is stopped, and alternatively, airs 23e1z and 23e3z indicated by white arrows pass through opened air flow control valves 344e1 and 344e3. The respective airs 23e1z and 23e3z pass through ducts 346e1 and 346e3 and direction-controlled downwardly (backward with respect to the page space) through flexible ducts 150e1 and 150e3 and pass through changeable area exhaust direction control nozzles 174e1 and 174e3, and exhausted outward (50e1z and 50e3z of FIGS. 31B and 31C). Aircraft 1e is subjected to the reaction forces of the flows of the gases and airs and thereby to obtain the upward force (frontward with respect to the page space) to perform vertical takeoff and landing.

Next, the related components in a flight state of the aircraft 1e will be described. In FIG. 32B, air 49ey indicated by white arrow passes through changeable air intake lamp 160e is compressed by the compressor 362e and 364e and reaches air flow control valves 344e1-344e3. Here, because air flow control valves 344e1 and 344e3 are closed, airs 24e1y and 24e3y indicated by white arrows are stopped, and alternatively, air 23e2y indicated by white arrow passes through duct 344e2 and through opened air flow control valve 344e2. Air 23e2y is flow-controlled to be spatially uniform flow by diffusion plate 228e, and then reaches combustion chamber 298e. In combustion chamber 298e, flow amount of fuel 11e is controlled by fuel flow control valve 286e2 for lift engine and then sucked through fuel nozzle 272e2 and reacted with air 23e2y by igniter 226e1 receiving ignition signal 80e and thereby turbine driven gas 20ey is generated. Turbine driven gas 20ey drives turbine rotor blade 204e to the direction indicated by white arrow through turbine stator blade 208e and then reaches afterburner 258e. On the other hand, the power obtained in turbine rotator 204e drives compressor rotor blade 362e to the direction of white arrow.

In after burner 258e, flow amount of fuel 11e is controlled by fuel flow control valve 286e3 for lift engine, and then, added from fuel nozzle 272e3 located in a downstream of flame holder 348e for stably holding flame, and reacted with air 20e1 by igniter 226e2 receiving ignition signal 80e. Then, the gas passes through flexible duct 150e2 and is outward exhausted backward (rightward with respect to the page space) through changeable area exhaust direction control nozzle 174e2 (50e2y). Aircraft 1e is subjected to the reaction force of the flow of the gas 50e2y and obtains the frontward (leftward with respect to page space) force to perform flight. In addition, turbine driven gas generator 200e can also be used as an initiation starter. In addition, the lift and flight engine 140e can also perform vertical takeoff and landing only by fuel 11e without using oxider 10e (turbine driven gas 20e1z is generated from combustion chamber 298e), and alternatively, flight can also be performed by using oxider 10e and fuel 11e (turbine driven gas 20e1y is generated from turbine driven gas generator 298).

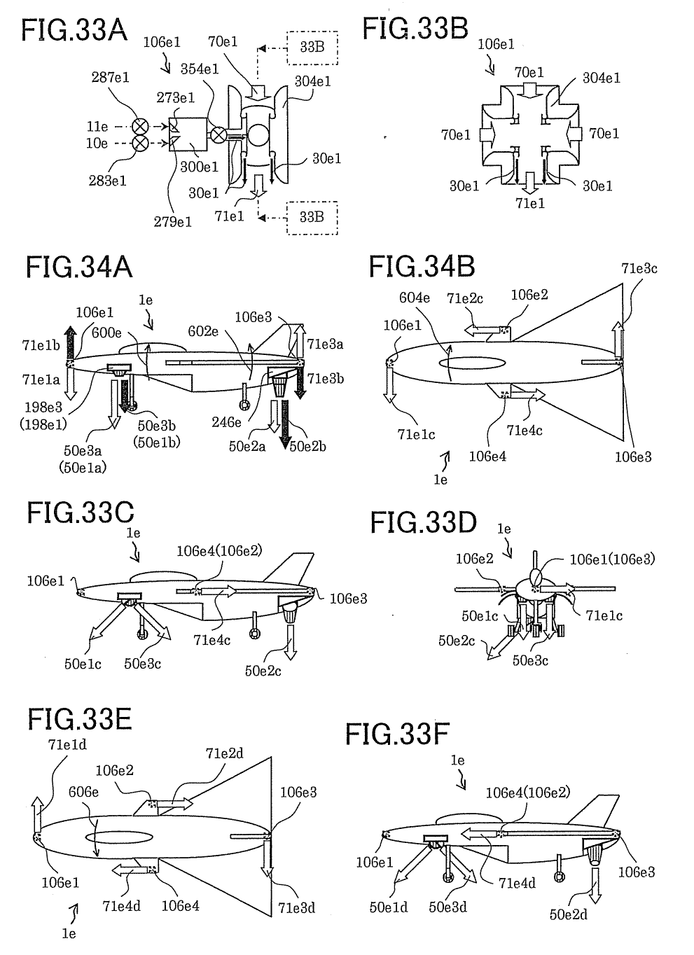

FIGS. 33A-33B are a vertical section view showing operation state of a reaction control engine 106e1 of aircraft 1e and a vertical section view showing in another section along 33B-33B. Reaction control engines 106e2-106e4 have the same structure as reaction control engine 106e1. Reaction control engine 106e1 has, cylindrical reaction control gas generator 300e1, cylindrical oxider nozzle 279e1 for reaction control engine, cylindrical fuel nozzle 273e1 for reaction control engine, reaction gas flow selecting valve 354e1 for selecting flow of reaction gas, and ejector 304e1 having a shape in which two orthogonal cylinders are crisscross combined. The respective flow amounts of oxider 10e and fuel 11e are controlled by oxider flow control valve 283e1 for reaction control engine and fuel flow control valve 387e1 for reaction control engine, and then, the oxider and the fuel are ejected and crashed to each other to be reaction gas 30e1. The ejection direction of flow 30e1 of the reaction gas indicated by black arrow is selected by reaction gas flow selecting valve 354e1 and reaches ejector 304e1. In ejector 304e1, surrounding air 70e1 indicated by white wide arrows is sucked from three directions of ejector 304e1 with flow 30e1 of the reaction gas ejecting at a high speed and exhausted as mixed gas 71e1 of the both gases indicated by white arrow. As a result, reaction control engine 106e1 is subjected to the reaction force to the opposite direction. By selecting reaction gas flow selecting valve 354e1, reaction control to a discretionary direction is possible. In this manner, in reaction control engine 106e1, rapid increase and decrease of the reaction force are possible by increase and decrease of the flow amounts of the oxider and the fuel, and hence, the reactivity is good. Moreover, reaction control engine 106e1 obtains the thrust by diluting a small amount of reaction gas 30e1 with a large amount of air 70e1 and then exhausting the gas, and hence, the exhaust temperature and the exhaust speed are lowered and the noise is small.

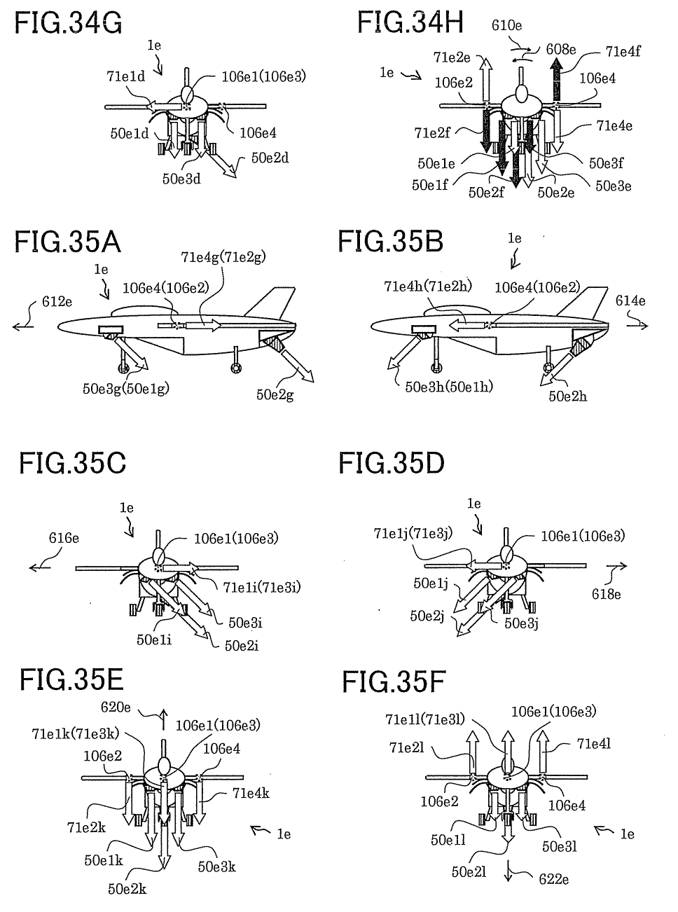

FIG. 34A is a side plan view showing the movement around pitch axis of aircraft 1e. Flow amount of gasses 50e3a and 50e1a indicated by white arrows accelerated by lift and flight engine 140e and the like is set to be relatively larger than flow amount of gases 50e2a indicated by white arrow, or gas 71e1a indicated by white arrow is exhausted downward from reaction control engine 106e3 or gas 71e3a indicated by white arrow is exhausted upward from reaction control engine 106e3, or both of the actions are performed, and thereby, nose-up force 600e around pitch axis indicated by the arrow can be applied to aircraft 1e. By contrast, flow amount of gasses 50e2b indicated by black arrow accelerated by lift and flight engine 140e and the like is set to be relatively larger than flow amount of gases 50e3b and 50e1b indicated by black arrows accelerated by lift and flight engines 140 and the like, or gas 71e1b indicated by black arrow is exhausted upward from reaction control engines 106e1, or gas 71e1b indicated by black arrow is exhausted upward from reaction control engine 106e1 or gas 71e1b indicated by black arrow is exhausted downward from reaction control engine 106e3, or both of the actions are performed, and thereby, nose-down force 602e around pitch axis indicated by the arrow can be applied to aircraft 1e.

FIGS. 34B-34D are a top view, a side view and a front view showing an example of the clockwise movement of nose around yaw axis of aircraft 1e. Gasses 50e1d-50e3d indicated by white arrows are exhausted counterclockwise and downward from lift and flight engine 140e and the like, or gases 71e1c-71e4c are exhausted counterclockwise to horizontal plane from reaction control engines 106e1-106e4, or both of the actions are performed, and thereby, clockwise force 604e around yaw axis indicated by the arrow can be applied to aircraft 1e.

FIGS. 34E-34G are a top view and a side view showing an example of the counterclockwise movement of nose around yaw axis of aircraft 1e. Gasses 50e1d-50e3d indicated by white arrows are exhausted clockwise and downward from lift and flight engine 140e and the like, or gases 71e1d-71e4d indicated by white arrows are exhausted clockwise to horizontal plane from reaction control engines 106e1-106e4, or both of the actions are performed, and thereby, counterclockwise force 606e around yaw axis indicated by the arrow can be applied to aircraft 1e.

FIG. 34H is a side view showing the movement around roll axis of aircraft 1e. Flow amount of gas 50e3e indicated by white arrows accelerated by lift and flight engine 140e and the like is set to be relatively larger than flow amount of gases 50e3e indicated by white arrow, or gas 71e2e indicated by white arrow is exhausted upward from reaction control engine 106e2 or gas 71e4e indicated by white arrow is exhausted downward from reaction control engine 106e4, or both of the actions are performed, and thereby, right-roll force 608a around roll axis (counterclockwise in the view) can be applied to aircraft 1e. By contrast, flow amount of gas 71e2f indicated by black arrow accelerated by lift and flight engine 140e and the like is set to be relatively larger than flow amount of gas 50e3f indicated by black arrow accelerated by lift and flight engine 140e and the like, or gas 71e2f indicated by black arrow is exhausted downward from reaction control engine 106e2 or gas 71e4f indicated by black arrow is exhausted upward from reaction control engine 106e4, or both of the actions are performed, and thereby, left-roll force 610e around roll axis can be applied to aircraft 1e.

FIG. 35B is a side view showing forward movement of aircraft 1e. Gases 50e1g-50e3g indicated by white arrows are exhausted backward and downward from lift and flight engine 140e and the like, or gases 71e4g and 71e2g indicated by white arrows are exhausted backward from reaction control engines 106e4 and 106e2, or both of the actions are performed, and thereby, aircraft 1e can be provided with forward force 612e.

FIG. 35B is a side view showing backward movement of aircraft 1e. Gases 50e1h-50e3h indicated by white arrows are exhausted forward and downward from lift and flight engine 140e and the like, or gases 71e4h and 71e2h indicated by white arrows are exhausted forward, or both of the actions are performed, and thereby, aircraft 1e can be provided with backward force 614e.

FIG. 35C is a front view showing rightward movement of aircraft 1e. Gasses 50e1i-50e3i indicated by white arrows are direction-controlled downward and leftward and exhausted from lift and flight engine 140e and the like, or gases 71e1i and 71e3i indicated by white arrows are exhausted leftward from reaction control engines 106e1 and 106e3, or both of the actions are performed, and thereby, aircraft 1e can be provided with a force 616e for rightward movement.

FIG. 35D is a front view showing a leftward movement of aircraft 1e. Gasses 50e1j-50e3j indicated by white arrows are direction-controlled downward and rightward and exhausted from lift and flight engine 140e and the like, or gases 71e1j and 71e3j indicated by white arrows are exhausted rightward from reaction control engines 106e1 and 106e3, or both of the actions are performed, and thereby, aircraft 1c to which aircraft 380 is fixed can be provided with a force 618e for leftward movement.

FIG. 35E is a front view showing rising movement of aircraft 1e. Flow amount of gases 50e1k-50e3k indicated by white arrows exhausted from lift and flight engine 140e and the like is set to be larger than that in hovering, or gases 71e1k-71e4k indicated by white arrows are exhausted downward from reaction control engines 106e1-106e4, or both of the actions are performed, and thereby aircraft 1e can be provided with a force 620e for moving up.

FIG. 35F is a front view showing lowering movement of aircraft 1e. Flow amount of gases 50e1l-50e3l indicated by white arrows exhausted from lift and flight engine 140e and the like is set to be smaller than that in hovering, or gases 71e1l-71e4l indicated by white arrows are exhausted upward from reaction control engines 106e1-106e4, or both of the actions are performed, and thereby, aircraft 1e can be provided with a force 622e for moving down.

In such manners, aircraft 1e has the same advantages as aircraft 1a of the first embodiment.

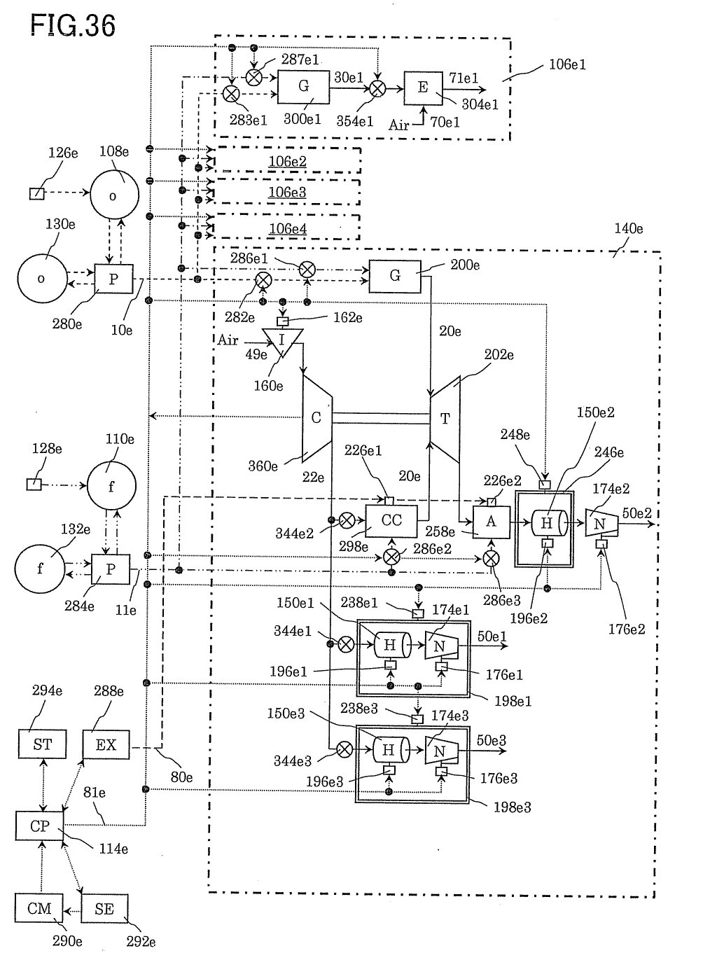

FIG. 36 is a block diagram showing fluid and electric system of aircraft 1e. In aircraft 1e, oxider 10e stored in external oxider tank 130e or in oxider tank 108e preliminary or through in-air refilling probe 126a is pressurized by oxider pressurizing system 280e, and supplied to turbine driven gas generator 200e of lift and flight engine 140e and to reaction control gas generators 300e1-300e4 of reaction control engines 106e1-106e4, through oxider flow control valve 282e for lift engine or through oxider flow control valve 283e for reaction control engine. On the other hand, fuel 1e stored in external fuel tank 132e or in fuel tank 110e preliminary or through in-air refueling probe 128e is pressurized by fuel pressurizing system 284e, and supplied to turbine driven gas generators 200e and combustion chamber 298e of lift and flight engine 140e, to afterburner 258e, and to reaction control gas generators 300e1-300e4 of reaction control engines 106e1-106e4, through fuel flow control valves 286e1-286e3 for lift engines or fuel flow control valves 287e1-287e4. In lift and flight engine 140e, turbine driven gas 20e generated in turbine driven gas generator 200e or combustion chamber 298e drives turbine 202e and then reaches afterburner 258e. The power obtained in turbine 202e drives compressor 360e and sucks surrounding air 49e through changeable air intake lamp 160e. Then, air 22e pressurize by compressor 360e reaches air flow control valves 344e1-344e3 and is directed to combustion chamber 298e or flexible ducts 150e1 and 150e3 located in the downstream after flow amount thereof is controlled. In combustion chamber 298e, fuel 11e is thrown in air 22e, and then the reaction is performed by igniter 226e1. The direction of air 22e is appropriately controlled by flexible ducts 150e1 and 150e3, and then, accelerated through changeable area exhaust direction control nozzles 174e1 and 174e3 and then exhausted outward (50e1, 50e3). On the other hand, in afterburner 258e, fuel 1e is thrown in turbine driven gas 20e again according to need, and the reaction is performed by igniter 226e2. Then, the direction of the gas is appropriately controlled through flexible duct 150e2, and then accelerated through changeable area exhaust nozzle 174e2 and then exhausted outward (50e2). According to flight form, exhaust nozzle contain doors 198e1 and 198e3 and flexible duct contain door 246e can open and close.

The structures of reaction control engines 106e2-106e4 are similar to the structure of reaction control engine 106e1, and hence reaction control engine 106e1 will be described here. In reaction control engine 106e1, channels of reaction gas 30e1 generated in reaction control gas generator 300e1 are changed by reaction gas flow selecting value 354e1, and then surrounding air 70a1 is sucked and exhausted (71e1) by ejector 304e1.

Control system 290e assigns charge to computer 114e according to information of sensor 292e detecting various states of the body and the like. According to the charge, computer 114e controls lift and flight engine 140e, reaction control engines 106e1-106e4, ignition system 288e, steering system 294e, and the like, through control signal 81e. Ignition system 288e generates ignition signals 80e to igniters 226e1-226e4 to ignite turbine driven gas generators 200a1-200a4.

It is preferable that the oxider and the fuel have autoignition properties, and are liquids of normal temperature and high density in the aspects of storage stability and storage quality, but the oxider and the fuel are not limited thereto. The liquid oxider and the liquid fuel are used to reduce volume of tubes and the like for introducing the oxider and the fuel to engine 140e and reaction control engines 106e1-106e4, and degree of freedom of the system arrangement is improved.

For the combination of the oxider and the fuel, for example, the fuel when the oxider is chlorine trifluoride includes ammonium and an aqueous solution thereof, an aniline, an alcohol such as ethyl alcohol and methyl alcohol and an aqueous solution thereof, a hydrazine such as monomethylhydrazine and an aqueous solution thereof and an oily solution thereof, hydrocarbon fuel (containing Gal To Liquid fuel (GTL)) such as jet fuel, and the like. When the fuel is aniline and hydrazine such as monomethylhydrazine or an aqueous solution thereof and an oily solution thereof or the like, the oxider includes white fuming nitric acid or an aqueous solution thereof, red fuming nitric acid, dinitrogen tetraoxide, and the like.

### Sixth Embodiment

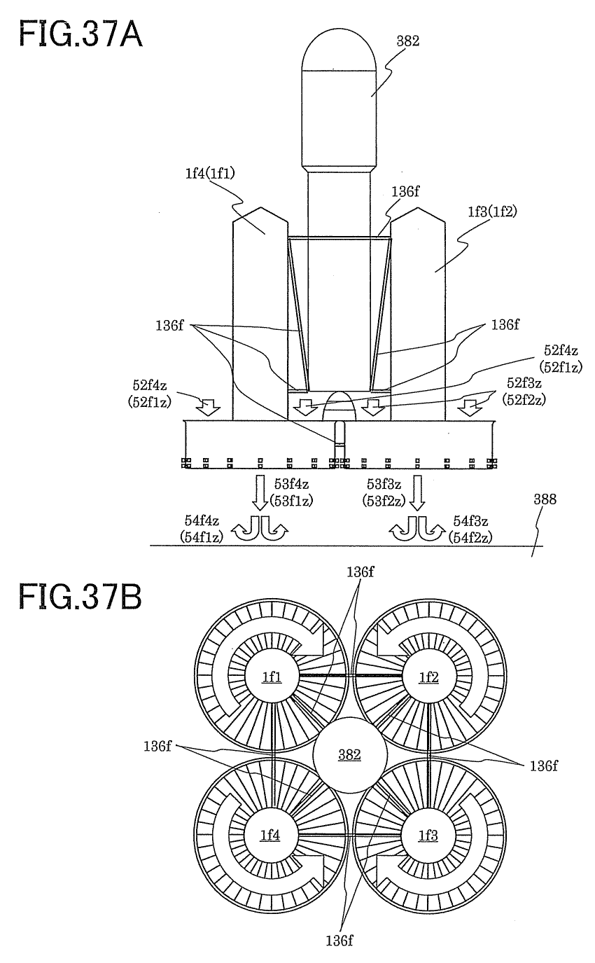

FIGS. 37A-37B show a side view and a top view in launching of a rocket booster 1f1-1f4 and a rocket 382 according to the sixth embodiment of the invention, respectively. Rocket boosters 1f1-1f4 having a shape in which cylinders having different sizes are combined are disposed so as to surround known rocket 382 and fixed to rocket 382 with separation system 136f, and thrust is transmitted to rocket 382 generated in rocket boosters 1f1-1f4.

Boosters 1f1-1f4 are the flying body generating thrust in the aerosphere in launching rocket 382, noise and air contaminant are drastically reduced. The booster 1f1-1f4 do not accelerate by ejecting a large amount of high-speed exhaust gas in the same manner as a known rocket booster to shoot through the inner space but a large amount of surrounding air is not burned and ejected at a low speed and hence, the structure weight of the rocket and the like can be reduced, and undesirable acceleration, vibration, and the like applied to mounted satellite and the like can also be minimum. That is, moving speed in the aerosphere is also slow and hence, the time till the rocket reaches a predetermined altitude can be lengthened, but air resistance and aerodynamic heating that are generated in the rocket are small, and a structure and a fairing and the like are more weight-saved and high propulsive efficiency can be maintained till the last. Because of a low speed, control or course correction is also easy and they can be collected and recycled.

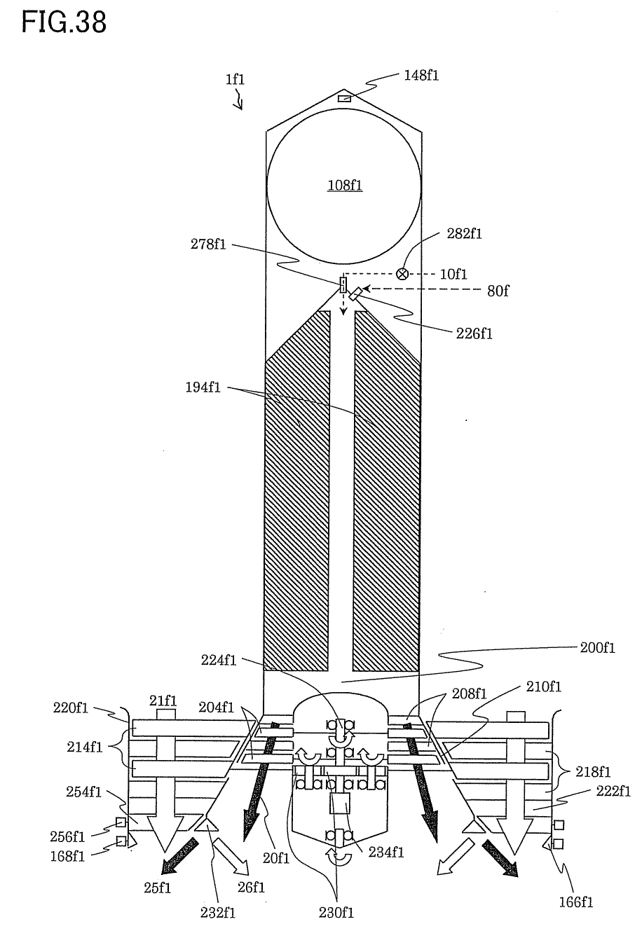

FIG. 38 is a side section view of the rocket booster 1f1 in an activated state. Rocket booster 1f1 has, sphere-shaped oxider tank 108f1, rectangular-parallelepiped-shaped parachute 148f1 that can be contained with being folded, turbine driven gas generator 200f1 having a can shape with a cone at a top thereof that generates gas 20f1 for driving turbine and has a vertical central axis and has a downward opening with an annular shape, solid fuel 194f1 with a hollow-bamboo form, cylindrical igniter 226f1 ignited by ignition signal 80f, cylindrical oxider nozzle 278f1 for dispersing oxider 10f1, a plurality of coaxial radial turbine stator blades 208f1 for accelerating and direction-controlling gas 20f1, a plurality of coaxial radial turbine rotor blades 204f for taking out mechanical work from gas 20f, a plurality of coaxial truncated-cone-shaped turbine cases 210f1 for preventing the broken pieces from scattering outside the engine if turbine rotor blades 204f1 are broken or scattered, nozzle 222f1 which is provided in fan case 220f1 and which is formed between the coaxial cylinder (fan case 220f1) and the truncated cone (turbine case 210f1) and in which opening area of the bottom face is smaller than the opening area of the top face, shaft 224f1 on the central axis rotated by turbine rotor blade 204f1, transmission 230f1 in which gears and the like are combined to be rotational symmetry for transmitting the rotation from shaft 224f1 to fan rotor blade 214f1, radially-rippling folded robe-shaped mixer 232f1 for mixing some of gas 20f1 driving the turbine and some of sucked air 21f1 to equalize temperature and speed of the exhaust gas, columnar rotation control motor and electrical generator 234f1 which is activated as electric generator or electric motor, a plurality of exhaust-direction control louvers 254f1 having a radial shape which can freely control the exhaust directions by changing the direction of flow of the surrounding air, driving actuator 256f1 for driving exhaust-direction control louvers 254f1, changeable area exhaust nozzle 166f1 in which areas of throat portions and exits of the exhaust nozzle are discretionarily changed, and driving actuator 168f1 for driving changeable area exhaust nozzle 166f.

Flow amount of oxider 10f is adjusted by oxider flow control valve 282f1 for lift engine, and then the oxider is dispersed by oxider nozzle 278f1 inside turbine driven gas generator 200f1 and then reacts on the surface of solid fuel 194f1 with energy supplied by igniter 226f1 receiving ignition signal 80f and thereby generates turbine driven gas 20f1. The gas 20f1 passes through turbine 204f1 and 208f1 and thereby becomes in a low-temperature and low-pressure state with reducing the energy that the gas has in itself, and reaches mixer 232f1. Turbine rotor blades 204f1 rotates shaft 224f1 to the direction of the white arrow to drive rotation control motor and electrical generator 234f1 and transmission 230f1. Transmission 230f1 decelerates the rotation and thereby to drive fan rotor blades 214, and air 21f1 is sucked and compressed by fans 214f1 and 218f1. Air 21f1 is accelerated by nozzle 222f1 to reach exhaust direction control louver 254f1, and the thrust is direction-controlled by changing the direction of flow of air 21f1, and then reaches mixer 232f1. Some of gas 20f1 (25f1) driving the turbine is mixed with some of air 21f1 (26f1) passing through the fan channel by mixer 232f1, and the temperature and the speed of the gas are further reduced and the gas forms a large amount of low-speed gas flow and is exhausted from rocket booster 1f1. The rotation of shaft 41f is appropriately adjusted by the loading of rotation control motor and electrical generator 234f1. Rocket booster 1f1 obtains the thrust with exhausting a large amount of air 21f1 at a low speed by a small amount of turbine driven gas 20f1, and hence, has higher economic efficiency than that of a conventional rocket the propulsive efficiency is high, and the amount and the noise of the gas 20f1 to be exhausted are small. As a means for exhausting the large amount of air 21f1 at a low speed, turboprop, compressor, or the like can also be used. Rocket booster 1f1 can efficiently obtain the thrust by changing the areas of throat portion and exit of changeable area exhaust nozzle 166f1 even in a high altitude and the like with rare atmosphere, and the direction of the thrust can be freely changed by appropriately controlling exhaust direction control louver 254f1 or by cooperatively controlling the thrust with the other rocket boosters 1f2-1f4.

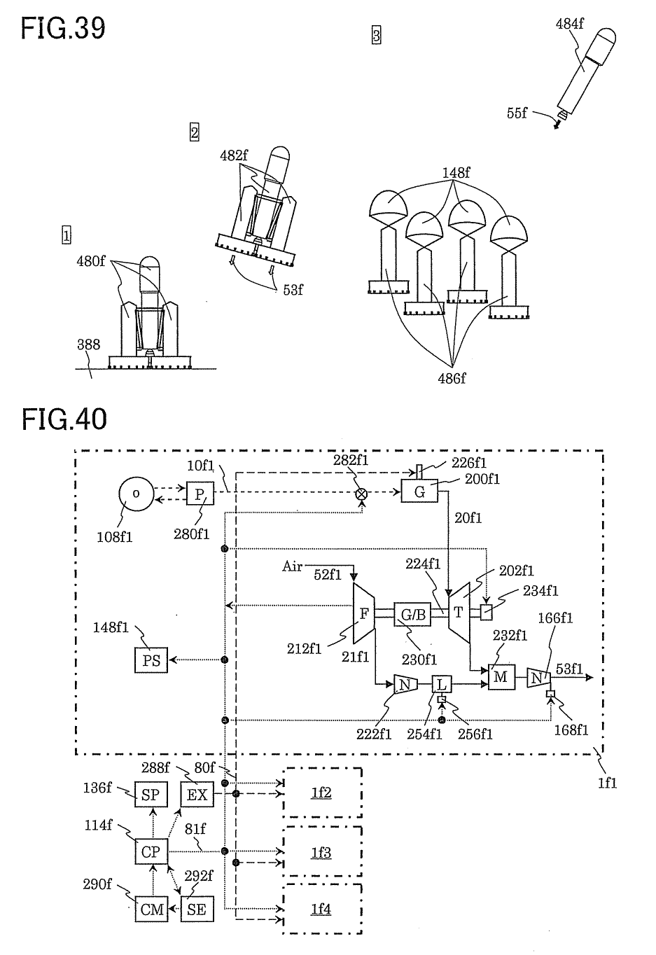

FIG. 39 is a side view useful for explaining a method for launching the rocket boosters 1f1-1f4 and the rocket 382. Digits 1-3 surrounded by rectangles indicate the order of launching of rocket boosters 1f1-1f4 and rocket 382. In the state that rocket boosters 1f1-1f4 and rocket 382 are fixed one another, from a plain and the like 388 (480f), they move up by exhausting downward gas 53f indicated by white arrows (482f), and then rocket boosters 1f1-1f4 and rocket 382 are separated one another by separation system 136f. Rocket 382 exhausts gas 55f to continue moving up (484f), rocket boosters 1f1-1f4 after use expands parachute 148f and slowly lowers (486f) and is collected and recycled.

FIG. 40 is a block diagram of fluid and electric system of rocket booster 1f1-1f4. The rocket boosters 1f2-1f4 have the same structures as the rocket booster 1f1, and hence rocket booster 1f1 and associated parts thereof will be described here. In rocket booster 1f1, oxider 10f1 stored preliminarily in oxider tank 108f1 is pressurized by oxider pressurizing system 280f1, and the flow amount thereof is controlled by oxider flow control valve 282f1, and then, the oxider is supplied to turbine driven gas generators 200f1. Turbine driven gas 20f1 generated in turbine driven gas generator 200f1 drives turbine 202f1 and then reaches mixer 232f1. The power obtained in turbine 202f1 drives transmission 230f1 and rotation control motor and electrical generator 234f1, through shaft 224f1. Transmission 230f1 drives fan 212f1. Fan 212f1 sucks surrounding air 52f1, and the pressurized air 21f1 reaches nozzle 222f1. In nozzle 222f1, pressure of air 21f1 is converted into speed and thereby air 21f1 is accelerated, and the thrust thereof is direction-controlled by exhaust direction control louver 254f1, and then reaches mixer 232f1. In mixer 232f1, some of turbine driven gas 20f1 and air 21f1 are mixed and passed through changeable area exhaust nozzle 166f1 and then exhausted (53f1). Loading on shaft 224f1 is controlled by rotation control motor and electrical generator 234f1 so that stall or surge of the fan is not caused. If turbine driven gas 20f1 comes not to be generated, fan 212f1 is driven temporarily by rotation control motor and electrical generator 234f1, and rocket boosters 1f1-1f4 and rocket 382 are soft-landed as softly as possible. This is a collection method that never be realized in a method of shooting through the aerospace at a high speed in the same manner as a general rocket booster and a general rocket.

Control system 290f assigns charge to computer 114f according to information of sensor 292f detecting information of the body and the like. According to the charge, computer 114f controls rocket boosters 1f1-1f4, parachutes 148f1-148f4, separation system 136f, ignition system 288f, and the like, through control signal 81f. Ignition system 288f generates ignition signals 80f to igniters 226f1-226f4 to ignite turbine driven gas generator 200f1.

The combination of the oxider and the fuel in which handling, storage, and the like are easy and in which molecular weight of the generated gas is smaller is desirable. The oxidant includes hydrogen peroxide and an aqueous solution thereof, nitric acid or an aqueous solution thereof, red fuming nitric acid or an aqueous solution thereof, nitrogen dioxide, dinitrogen tetraoxide, and the like. The solid fuel includes composite-type fuels such as polybutadiene-based, polyurethane-based, polyester-based, polysulfide-based, polyethylene-based, rubber-based, and vinyl-based fuels. The addition of a metal such as aluminum used generally in a conventional fuel for solid rocket is little preferable because of damaging turbine (202f) and the like.

### Seventh Embodiment

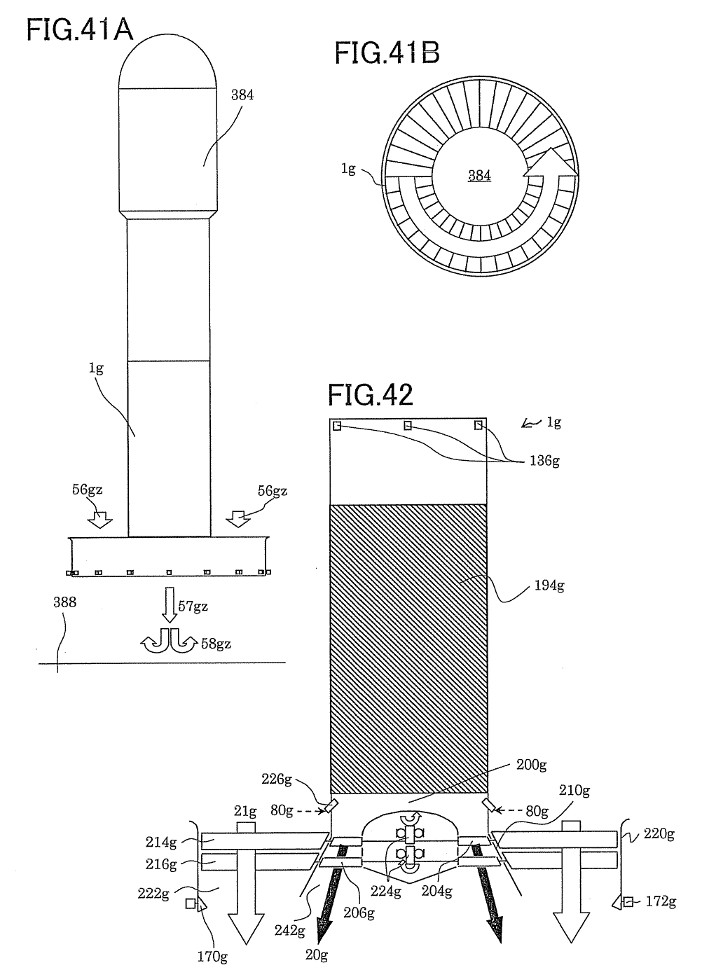

FIGS. 41A-41B shows a side view and a top view in launching a first stage of rocket 1g and second or more stages of rocket 384 according to the seventh embodiment of the invention, respectively. First stage of rocket 1g having a shape in which large or small cylinders are combined is fixed to the lower stand of existing second or more stages of rocket 384, the thrust generated in first stage of rocket 1g is transmitted to second or more stages of rocket 384.

First stage of rocket 1g is a flying body generating a thrust the aerospace, and noise and air contaminant are caused drastically by an existing rocket. First stage of rocket 1g ejects a large amount of surrounding air at a low speed without burning the air, and hence, the acceleration is slow, and structure weight of the rocket and the like can be reduced, and undesirable force and the like applied to mounted satellite and the like can be minimum. That is, moving speed in the aerosphere is also slow and hence, the time till the rocket reaches a predetermined altitude can be lengthened, but air resistance and aerodynamic heating that are generated in the rocket are small, and high propulsive efficiency can be maintained till the last. Because of a low speed, control or course correction is also easy, and by setting the structure to be disposable, the rocket becomes low-cost.

FIG. 42 shows a side section view of a first stage of rocket 1g in an activated state. First stage of rocket 1g has, a plurality of rectangular-parallelepiped-shaped separation systems 136g, turbine driven gas generator 200g having a can shape that generates gas 20g for driving turbine and has a vertical central axis and has a downward opening with an annular shape, columnar solid fuel 194g, columnar igniter 226g1 ignited by ignition signal 80g, a plurality of coaxial radial turbine rotor blades 204g for taking out mechanical work from gas 20g, a plurality of coaxial radial turbine rotor blades 206g for taking out mechanical work from gas 20g in the same manner by the reverse rotation with respect to the coaxial radial turbine rotor blades 204g for taking out mechanical work from gas 20g, a plurality of coaxial truncated-cone-shaped turbine cases 220g for preventing the broken pieces from scattering outside the engine if turbine rotor blades 214g and 216g are broken or scattered, a plurality of coaxial radial fan rotor blades 214g for pressuring air 21g indicated by white arrow, a plurality of coaxial radial fan rotor blades 216g for pressuring air 21g in the same manner that can rotate reversely with respect to coaxial radial fan rotor blades 214g for pressuring air 21g, a plurality of coaxial truncated-cone-shaped turbine cases 220g for preventing the broken pieces from scattering outside the engine if a plurality of fan rotor blades 214g and 216g are broken or scattered, nozzle 222g which is provided in fan case 220g and which is formed between the coaxial cylinder (fan case 220g) and the truncated cone (turbine case 210g) and in which opening area of the bottom face is smaller than the opening area of the top face for accelerating air 21g, shaft 224g on the central axis to be the central axis of turbine rotor blades 204g and 206g, coaxial truncated-cone-shaped diffuser 242g for converting speed energy into pressure energy, exhaust direction control nozzle 170g of being capable of discretionarily changing the direction of exit of the exhaust nozzle, and driving actuator 172g for driving exhaust direction control nozzle 170g.

Inside turbine driven gas generator 200g, solid fuel 194g is reacted by igniter 226g to generate turbine driven gas 20g. Gas 20g passes through turbine 204g and 206g and thereby becomes in a low-temperature and low-pressure state with reducing the energy that the gas has in itself, and reaches diffuser 242g, and some of the residual speed energy is converted into pressure energy. Turbine rotor blade 204g drives fan rotor blade 214g so that the shaft 224g serves as the rotational center, and turbine rotor blade 206g drives fan rotor blade 216g in the reverse direction with respect to fan rotor blade 214g so that the shaft 224g serves as the rotational center, and thereby, air 21g is sucked and compressed. Air 21g is accelerated by nozzle 222g. Air 21g and turbine driven gas 20g passing through diffuser 242g form a large amount of low-speed gas flow, and thereby, the rust of exhaust direction control nozzle 170g is discretionarily direction-controlled, and then, exhausted. First stage of rocket 1g has the same advantage as rocket booster 1f1 of the sixth embodiment. As a means for exhausting the large amount of air 21g at a low speed, it is possible to use another means such as, turboprop in which the fan is replaced to propeller, or compressor. By absorbing and adding mechanical work with rotor blades of rotating reversely to each other in such a case of turbine rotor blades 204g and 206g or fan rotor blades 214g and 216g, the distance in the axial direction is shortened and the structure becomes simple, and the rotational frequency can also be lowered, and hence, the contribution to downsizing and weight saving thereof is made.

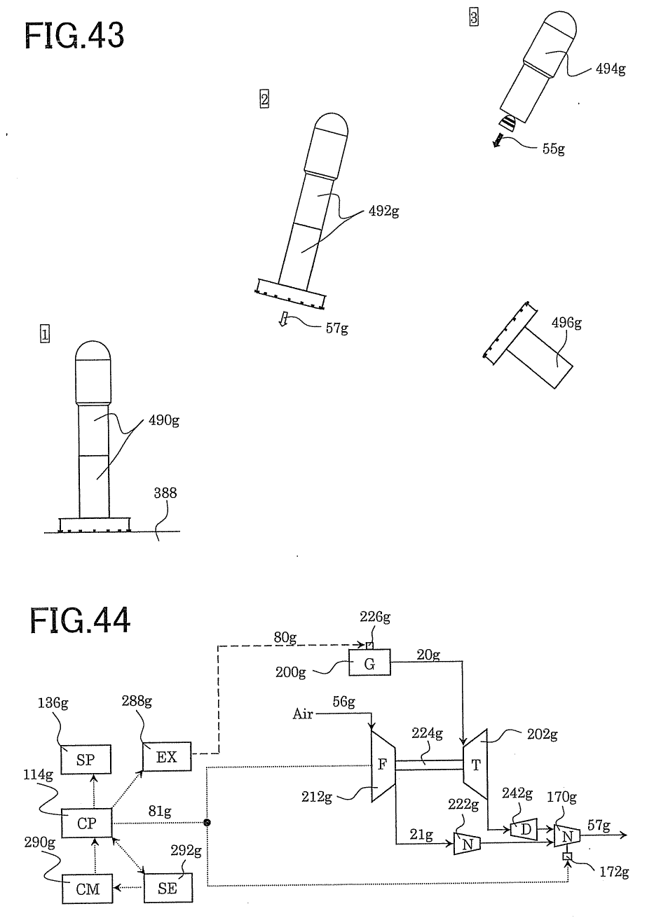

FIG. 43 is a side view useful for explaining a method for launching first stage of rocket 1g and the second-stage rocket 384. Digits 1-3 surrounded by rectangles indicate the respective processes of vertical takeoff and landing. Digits 1-3 surrounded by rectangles indicate the order of launching of first stage of rocket 1g and second or more stages of rocket 384. In the state that first stage of rocket 1g and second or more stages of rocket 384 are fixed one another, from a plain and the like 388 (490g), they move up by exhausting downward gas 57g indicated by white arrows (492g), and then, first stage of rocket 1g and second or more stages of rocket 384 are separated one another by separation system 136g. Second or more stages of rocket 384 exhausts gas 55g to continue moving up (494g), and first stage of rocket 1g after use is dumped (496g) to be burned out with friction with the atmosphere or thrown out on an ocean.

FIG. 44 is a block diagram of fluid and electric system of the first stage of rocket 1g. Turbine driven gas 20g generated in turbine driven gas generator 200g drives turbine 202g and passes through diffuser 242g, and thereby, the speed of the gas is converted into pressure. Turbine driven gas 20g generated in turbine driven gas generator 200g and then passes through diffuser 242g. The power obtained in turbine 202g drives fan 212g through shaft 224g. Fan 212g sucks surrounding air 56g, and the pressurized air 21g reaches nozzle 222g. In nozzle 222g, the pressure of air 21g is converted into speed and thereby air 21g is accelerated, and the thrust thereof is discretionarily direction-controlled in exhaust direction control nozzle 170g and then exhausted from first stage of rocket 1g (57g).

Control system 290g assigns charge to computer 114g according to information of a sensor 292g detecting information of the body and the like. According to the charge, computer 114g controls each part of first stage of rocket 1g, separation system 136g, ignition system 288g, and the like, through control signal 81g. Ignition system 288g generates ignition signals 80g to igniter 226g to ignite turbine driven gas generator 200g.

The fuel to be used in which handling, storage, and the like are easy and in which molecular weight of the generated gas is smaller is desirable. The solid fuel includes existing double-base-type and composite-type fuels, high-energy polymer such as GAP (Glycidyl Azide Polymer), and the like. The addition of a metal such as aluminum used generally in a conventional fuel for solid rocket is lift preferable because of damaging turbine (202g) and the like.

### Eighth Embodiment

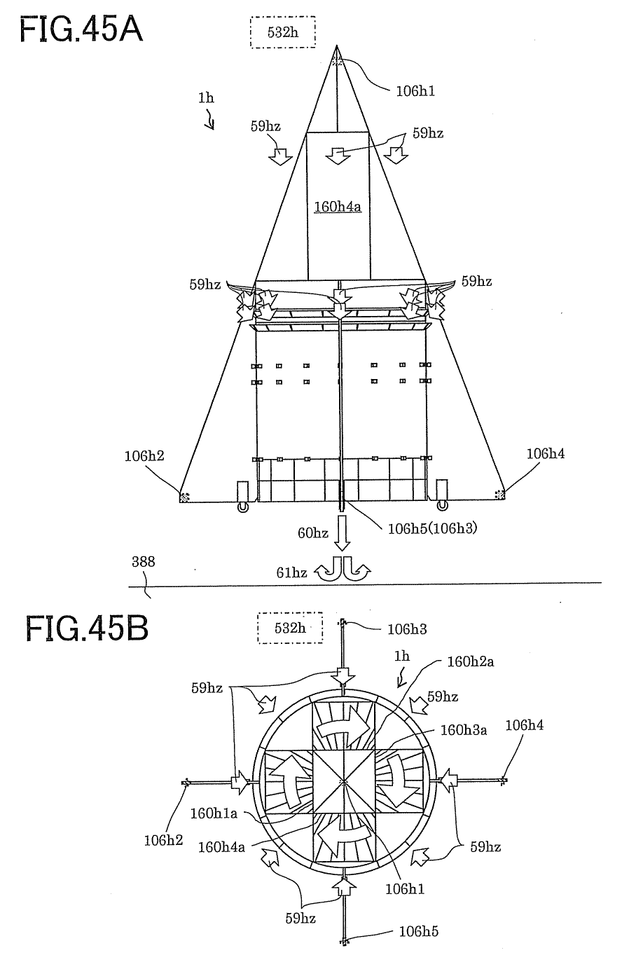

FIGS. 45A-45B are a side view and top view in launching space shuttle vehicle 1h according to the eighth embodiment of the invention (532). Space shuttle vehicle 1h moves up by the reaction force of taking in and accelerating and exhausting a large amount of surrounding air 59 hz (60 hz). In the view, space shuttle vehicle 1h is drawn so as to vertically take off or land but may horizontally take off or land.

Space shuttle vehicle 1h is a flying body that can take off from a ground and reach a satellite orbit and then land back to a ground again and that is a kind of Single Stage to Orbit (SSTO). Space shuttle vehicle 1h moves up at a low speed by a lift engine mode in the aerospace having a high air density, and accelerates with appropriate transition to gas generator cycle ATR (Air Turbo Ram) mode or expander cycle ATR mode, according to lowering of the density, and finally obtains a required orbit speed with rapid transition to a rocket mode after exceeding the aerospace. By the method, not only oxygen in the atmosphere but also air itself can be utilized to a maximum extent, and hence, the weight of propellant to be mounted can be reduced, compared to a conventional rocket and the like. In the future, for example, when production of propellant on an orbit such as moon and Mars becomes possible, propellant is supplemented there, and thereby, the space shuttle vehicle can shuttle between Earth and the outer space with loading a large amount of payload. By selecting most appropriate propulsion mode in the respective speed region, high propulsive efficiency can be maintained till the last. Space shuttle vehicle 1h can be low-cost and resource-saved with being repeatedly recycled, and environmental contaminant to be exhausted is small and can be harmless by selecting the propellant.

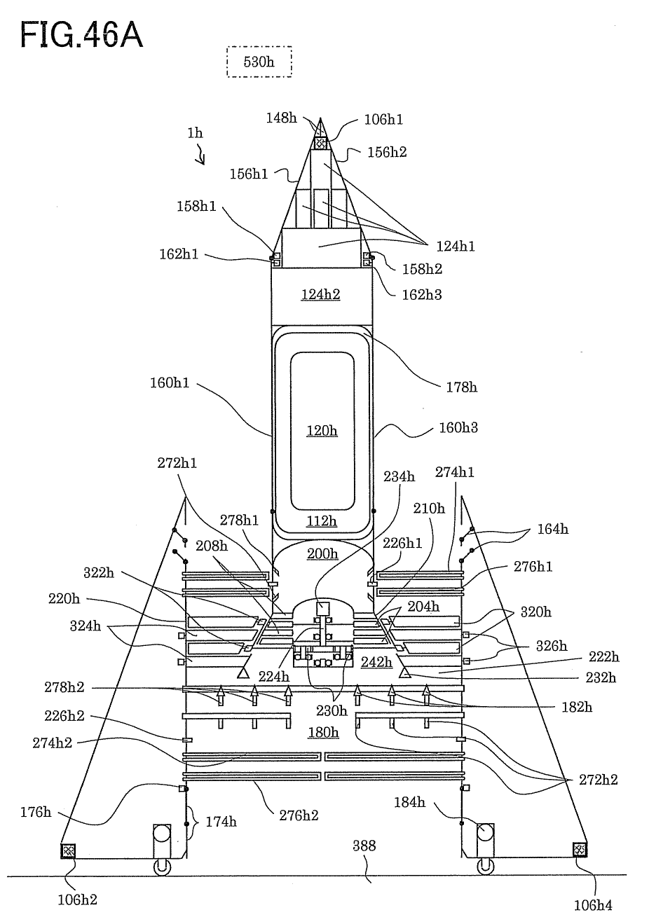

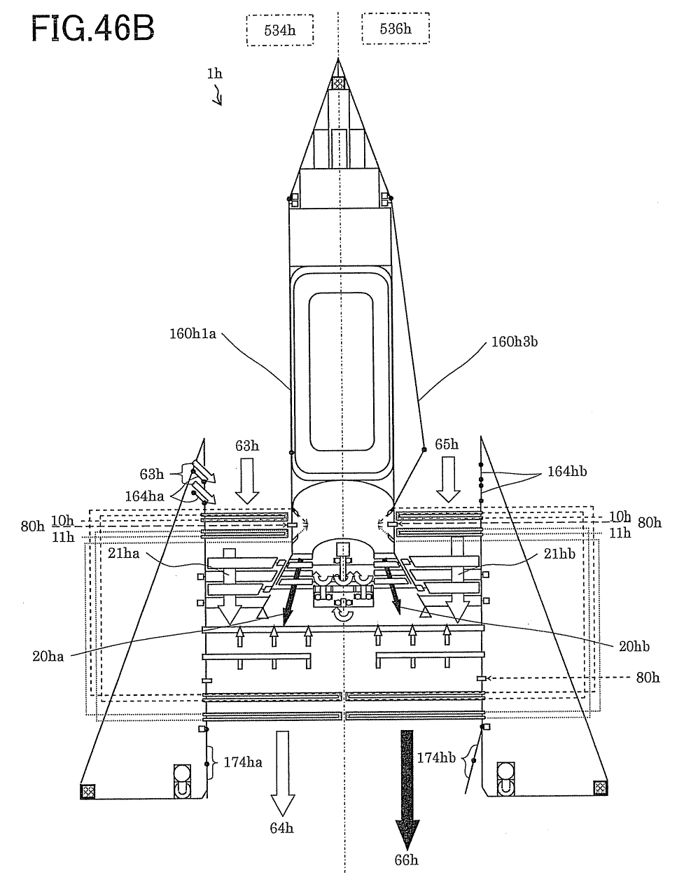

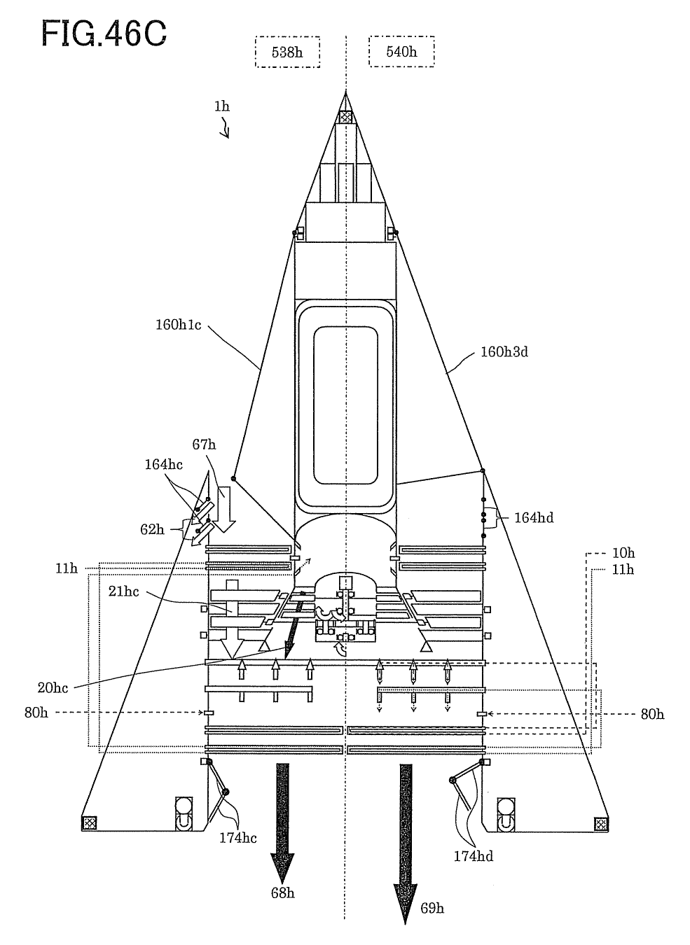

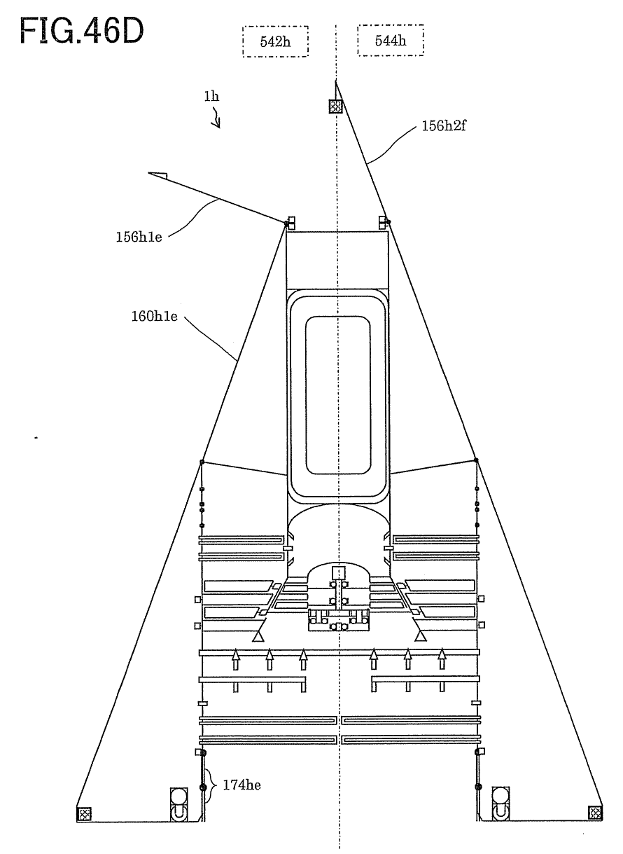

FIG. 46A is a side section view of the space shuttle vehicle in waiting (530h) for launching in a ground and the like. Space shuttle vehicle 1h has, reaction control engines 106h1-106h5 each having a shape in which two orthogonal cylinders are combined crisscross, half-rectangular-parallelepiped-shaped parachute 148f that can be contained with being folded, a plurality of rectangular-parallelepiped-shaped payloads 124h1-124h2 which are pay loads, a plurality of rectangular-parallelepiped-shaped fairings 156h1-156h2 of containing payloads 124h, a plurality of rectangular-parallelepiped-shaped fairing control actuators 158h1-158h2 by which fairings 156h1-156h2 is opened and closed, a plurality of rectangle-shaped changeable air intake lamps 160h1-160h4 which can efficiently take in air by changing a shape thereof, a plurality of rectangle-parallelepiped-shaped changeable-air-intake-lamp driving actuator 162h1-162h4 by which changeable air intake lamps 160h1-160h4 are transformed, rectangular-parallelepiped-shaped low-temperature fuel tank 120h that is provided in the central portion for thermal insulation and that stores low-temperature fuel, rectangular-parallelepiped-shaped low-temperature oxider tank 112h that is provided so as to surround low-temperature fuel tank 120h for thermal insulation and that stores low-temperature oxider, rectangular-parallelepiped-shaped reactant tank 178h that is provided so as to surround low-temperature fuel tank 112h for thermal insulation and that stores low-temperature reactant tank 178h.

Turbine driven gas generator 200h that has a vertical central axis for generating the turbine driven gas and that has an opening having an annular shape, a plurality of cylindrical igniters 226h1-226h2 of generating ignition energy by ignition signal, a plurality of cylindrical fuel nozzles 272h1-272b2 for dispersing the fuel, a plurality of cylindrical oxider nozzles 278h1-278h2 for dispersing the oxider, a plurality of coaxial radial turbine stator blades 208h for accelerating and turning the turbine driven gas, a plurality of coaxial radial turbine rotor blades 204h for taking mechanical work out of the turbine driven gas, coaxial truncated-cone-shaped turbine case 210h for preventing the broken pieces from scattering outside the engine if turbine rotor blade 204h is broken or scattered, a plurality of coaxial radial attached-angle changeable fan rotor blades 320h by which the surrounding air is sucked and accelerated and in which the attached angles of the blades can be changed, a plurality of columnar fan-rotor-blade-angle control actuators 322h for changing the attached angle of attached-angle changeable fan rotor blades 320h, a plurality of coaxial radial attached-angle changeable fan stator blades 324h in which the speed of the sucked air is converted into pressure and in which the attached angle of the blades can be changed, a plurality of columnar fan-stator-blade-angle control actuators 326h for changing the attached angle of attached-angle changeable fan stator blades 324h, coaxial cylindrical fan case 220h for preventing the broken pieces from scattering outside the engine if attached-angle changeable fan rotor blades 320h is broken or scattered, nozzle 222h which is provided in fan case 220h and which is formed between the coaxial cylinder (fan case 220h) and the truncated cone (turbine case 210h) and in which opening area of the bottom face is smaller than the opening area of the top face for accelerating the air.

Shaft 224h on the central axis to be rotated by turbine rotor blades 204h, transmission 230h in which gears and the like are combined to be rotational symmetry for transmitting the rotation from shaft 224h to attached-angle changeable fan rotor blades 320h, radially-rippling folded robe-shaped mixer 232h for mixing some of the gas driving the turbine and some of the sucked air to equalize temperature and speed of the exhaust gas, columnar rotation control motor and electrical generator 234h which is activated as electric generator or electric motor, truncated-cone-shaped diffuser 242h for converting speed energy of the turbine driven gas into pressure energy, shall-shaped assistance air intake and air exhaust door 164h which is open in the case of the speed of space shuttle vehicle 1h being slow and the area of air inlet being small and which exhausts the air in the case of the speed being high and the air being excess, a plurality of tubular oxider heating tubes 274h1-274b2 for cooling the surrounding fluid and for heating the oxider, a plurality of tubular fuel heating tubes 276h1-276h2 for cooling the surrounding fluid and for heating the fuel, cylindrical ram and rocket combustor 180h which becomes a ram combustor in the aerospace and which becomes a rocket combustor outside the aerospace, a plurality of wedge-shaped flame holders 182h for forming the recirculation region of the flame generated in ram and rocket combustor 180h, changeable area exhaust direction control nozzle 174h in which areas of the throat portion and the exit of the exhaust nozzle can be discretionarily changed and in which the direction of the exit can be discretionarily changed, a plurality of rectangular-parallelepiped-shaped drive actuator 176h for driving changeable area exhaust direction control nozzle 174h, and a plurality of sphere-shaped buoyancy buoys 184h which can be folded and contained and which is unfolded in use ensure buoyant forces 184h.

Low-temperature fuel tank 120h for storing fuel to have the lowest temperature is disposed at the center, and Low-temperature oxider tank 112h for storing low-temperature oxider is disposed therearound, and reactant tank 178h for storing reactant thereoutside, and thereby, the use of an insulation material and the like can be saved, and vaporization and wastage of the fuel and the oxider can also be small. Furthermore, the fuel and the reactant which are rich in reactivity are maintained to be low-temperature and thereby the safety can be enhanced.

FIG. 46B shows side section views of inner-space subsonic-speed flight 534h (left of the view) and inner-space transonic-speed flight 536h (right of the view) of space shuttle vehicle 1h. In the state of inner-space subsonic-speed flight 534h, fuel 11h and oxider 10h are preheated by fuel heating duct 276h2 and oxider heating duct 274h2 disposed in ram and rocket combustor 180h with cooling surrounding air 63h by fuel heating duct 276h1 and oxider heating duct 274h1 disposed in the upstream of fans 320h and 324h, and then, supplied inside turbine driven gas generator 200h from fuel nozzle 272h1 and from oxider nozzle 278h1 respectively, and reacted by energy 80h supplied by igniter 226h1 to generate turbine driven gas 20ha. The gas 20ha passes through turbine 204h and 208h and thereby becomes in a low-temperature and low-pressure state with reducing the energy that the gas has in itself, and reaches differ 242h, and thereby, some of the residual speed energy is converted into pressure energy.

The turbine rotor blade 204h rotates shaft 224h and rotation control motor and electrical generator 234h, and transmission 230h reduces the rotation to drive attached-angle changeable fan rotor blade 320h, and fans 320h and 324h suck and compress air 63h that passes through changeable air intake lamp 160h1a-160h4a and assistance air intake and air exhaust door 164 and that is precooled with fuel 11h and oxider 10h. Fans 320h and 324h appropriately change the attached angle with corresponding to flight speed and the like by attached-angle control actuators 322h and 326h of the respective blades. Air 21ha passing through the fans is accelerated by nozzle 222h and reaches mixer 232h. Some of gas 20ha is mixed with some of air 21ha passing through the fan channel, and the temperature and the speed are further reduced to form a large amount of low-speed gas flow and thereby to heat fuel 11h and oxider 10h, and then, the gas passes through changeable area exhaust direction control nozzle 174ha and is exhausted from space shuttle vehicle 1h (64h). Air 21h passing through fans 320h and 324h does not inflow in the side of the turbine 204h and 208h. The rotation of shaft 224h is appropriately controlled with the load of rotation control motor and electrical generator 234h. Space shuttle vehicle 1h obtains the thrust by exhausting a large amount of air 21h at a low speed by a small amount of turbine driven gas 20h, and hence, the economic efficiency is higher and the propulsion efficiency is also higher than those of a conventional rocket, the amount of exhaust gas 64h and the noise are also small (lift engine mode). As a means for exhausting the large amount of air 21h at a low speed, it is possible to use another means such as, turboprop in which the fan is replaced to propeller, or compressor. In space shuttle vehicle 1h, the thrust can be efficiently obtained by appropriately changing areas of the throat portion and the exit of changeable area exhaust direction control nozzle 174h and the direction of the exit can be appropriately controlled, even in a high altitude containing dilute air. In the state of inner-space subsonic-speed flight 534h, fuel 11h and oxider 10h are preheated by fuel heating duct 276h2 and oxider heating duct 274h2 disposed in ram and rocket combustor 180h with cooling surrounding air 65h by fuel heating duct 276h1 and oxider heating duct 274h1 disposed in the upstream of fans 320h and 324h, and then, supplied inside turbine driven gas generator 200h from fuel nozzle 272h1 and from oxider nozzle 278h1 respectively, and reacted by energy 80h supplied by igniter 226h to generate turbine driven gas 20hb. The gas 20hb passes through turbine 204h and 208h and thereby becomes in a low-temperature and low-pressure state with reducing the energy that the gas has in itself, and reaches diffuser 242h, and thereby, some of the residual speed energy is converted into pressure energy.

The turbine rotor blade 204h rotates shaft 224 and rotation control motor and electrical generator 234h, and transmission 230h reduces the rotation to drive attached-angle changeable fan rotor blade 320h, and fans 320h and 324h suck and compress air 65h that passes through changeable air intake lamp 160h1b-160h4b and assistance air intake and air exhaust door 164hb and that is precooled with fuel 11h and oxider 10h. Air 21hb passing through the fans is accelerated by nozzle 222h and reaches mixer 232h. Some of gas 20hb is mixed with some of air 21hb passing through the fan channel, the mixed gas of air 21hb and gas 20hb is reacted by the energy of igniter 226h2 to perform ram combustion, and thereby, high-temperature and high-speed gas flow 66h is formed to heat fuel 11h and oxider 10h and then passes through changeable exhaust direction control nozzle 174hb and is exhausted (gas generator cycle ATR mode).

FIG. 46C shows side section views of the space shuffle vehicle in inner-space supersonic-speed flight state 538h (left side) and outer-space flight state 540h (right side). In the state of inner-space supersonic-speed flight 538h, fuel 11h is preheated by fuel heating duct 276h2 disposed in ram and rocket combustor 180h with cooling surrounding air 63h by fuel heating duct 276h1 and oxider heating duct 274h1 disposed in the upstream of fans 320h and 324h, and then, is supplied inside turbine driven gas generator 200h from fuel nozzle 272h1, and thereby becomes turbine driven gas 20hc. The gas 20hc reaches diffuser 242h in the same manner as flight state 534h of FIG. 6B. The turbine rotor blade 204h rotates shaft 224h and rotation control motor and electrical generator 234h, and transmission 230h reduces the rotation to drive attached-angle changeable fan rotor blade 320h, and fans 320h and 324h suck and compress air 67h that passes through changeable air intake lamp 160h1c-160h4c and that is precooled with fuel 11h. At this time, surplus air 62h is exhausted from assistance intake and air exhaust door 164hc. Air 21hc passing through the fans is accelerated by nozzle 222h and reaches mixer 232h. Some of gas 20hc is mixed with some of air 21hc passing through the fan channel, and the temperature and the speed are further reduced to form a large amount of low-speed gas flow and thereby to heat fuel 11h, and then, the gas passes through changeable area exhaust direction control nozzle 174hc and is exhausted from space shuttle vehicle 1h (expander cycle ATR mode). In the state of outer-space flight 540h, lamps 160h1d-160h4d and doors 164hd are completely closed, and fuel 11h and oxider 10h which are heat-exchanged by fuel heating duct 276h2 and oxider heating duct 274b2 in ram and rocket combustor 180h are supplied from fuel nozzle 272b2 and from oxider nozzle 278b2, and igniter 226h2 is activated to perform rocket combustion, and gas 69h is exhausted from changeable area exhaust direction control nozzle 174hd (rocket mode). In addition, in the state of inner-space transonic-speed flight 536h and the state of inner-space supersonic-speed flight 538h, both of gas generator cycle ATR mode and expander cycle ATR mode may be used in any sequence (or any one of the modes may be used), and the tiring of switching to rocket mode which is in the state of outer-space flight state 540h is also appropriately determined by the provided task.

FIG. 46D shows side section views of the space shuttle vehicle in outer-space payload-unloaded state 542h (left) and atmospheric reentry state 544h (right). Space shuttle vehicle 1h unloads payload 124h1 by opening and closing fairings 156h1e-156h2e in the payload-unloaded state 542h. In atmospheric reentry state 544h, free fall with own weight is utilized in the state that all of the opened parts containing fairings 156h1e-156h2e are closed, and the reentry into the atmosphere is performed.

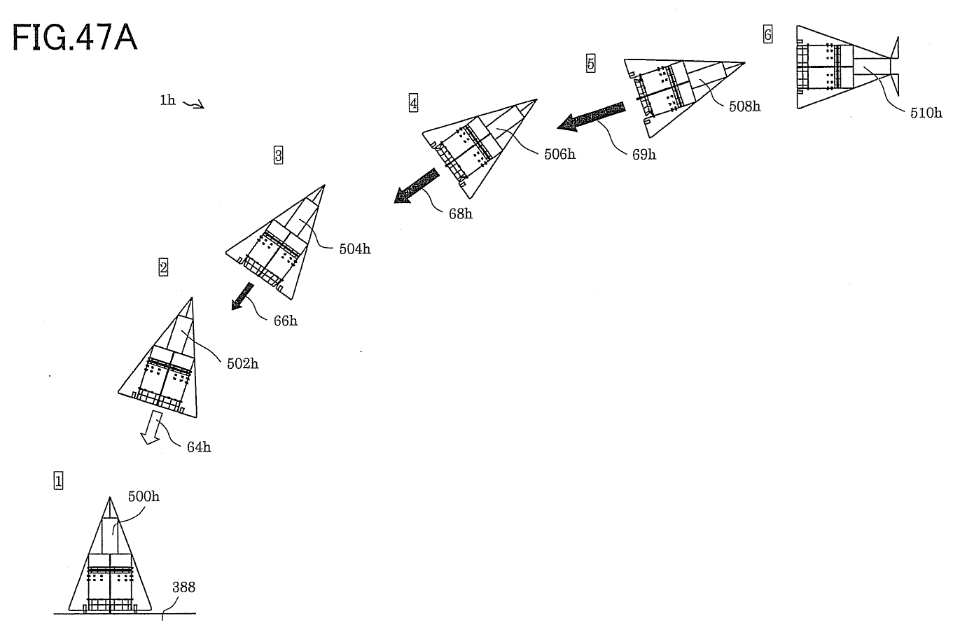

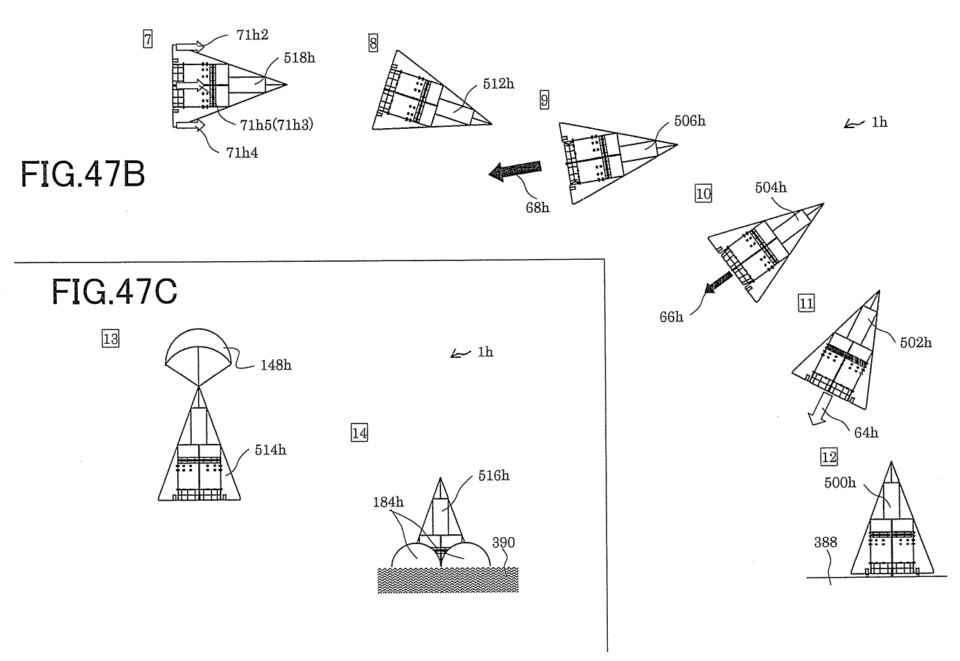

FIGS. 47A and 47B are side views useful for explaining launching and landing back of space shuttle vehicle 1h. Digits 1-12 surrounded by rectangles indicate the order of launching and landing back of space shuttle vehicle 1h. Space shuttle vehicle 1h disposed on plain and the like. 388 (500h) moves up at a subsonic speed by downward exhausting a large amount of gas 64h indicated by white arrow at a low speed by lift engine mode in the aerospace (502h), and then, continues forward moving up at a subsonic speed by exhausting backward gas 66h indicated by black arrow with the transition to gas generator cycle ATR mode (504h), and next, gas 68h indicated by black arrow with the transition to expander cycle ATR mode to further perform forward moving up at a supersonic speed (506h). Then, when reaching the outer space, space shuttle vehicle 1h (508h) continues moving up by exhausting backward gas 69h indicated by black arrow with transition to rocket mode and therewith accelerates to the orbital direction, and thereby, reaches the orbit, and then loads and unloads the payload (510h).

In landing back, space shuttle vehicle 1h on an orbit reduces the orbital speed by exhausting gases 71h2-71h5 indicated by white arrows from reaction control engines 106h2-106h5 to reduce the orbital speed (518h) and performs free fall and enters the aerospace (512h). Then, when reaching the aerospace, space shuttle vehicle 1h utilizes air in the atmosphere and performs transition to expander cycle AIR mode (506h) or to gas generator cycle ATR mode (504h), and then continues moving down at a safe speed by lift engine mode (502h), and lands on a plain and the like. (500h). Powered flight is performed in launching or landing, and thereby, has a high cross range capability and a high cruising capability.

FIG. 47C is a side view that is useful for explaining landing back in an emergency of space shuttle vehicle 1h. Digits 13-14 surrounded by rectangles indicate the processes of landing back of space shuttle vehicle 1h on a ground or water. In the case that continuation of the powered flight becomes difficult because emergency is caused in launching and landing back of space shuttle vehicle 1h (among digits 2-11 surrounded by rectangles of FIGS. 47A and 47B), parachute 148h is unfolded and the space shuttle vehicle is decelerated and lowered (514h), and can wait for rescue in the state as it is when the landing point is a ground or in the case that buoyancy buoy 184h is unfolded (516h). In this manner, space shuttle vehicle 1h moves in the aerospace in the same manner as an aircraft, differently from a conventional rocket and the like, and can perform safe landing back by using aerodynamic force.

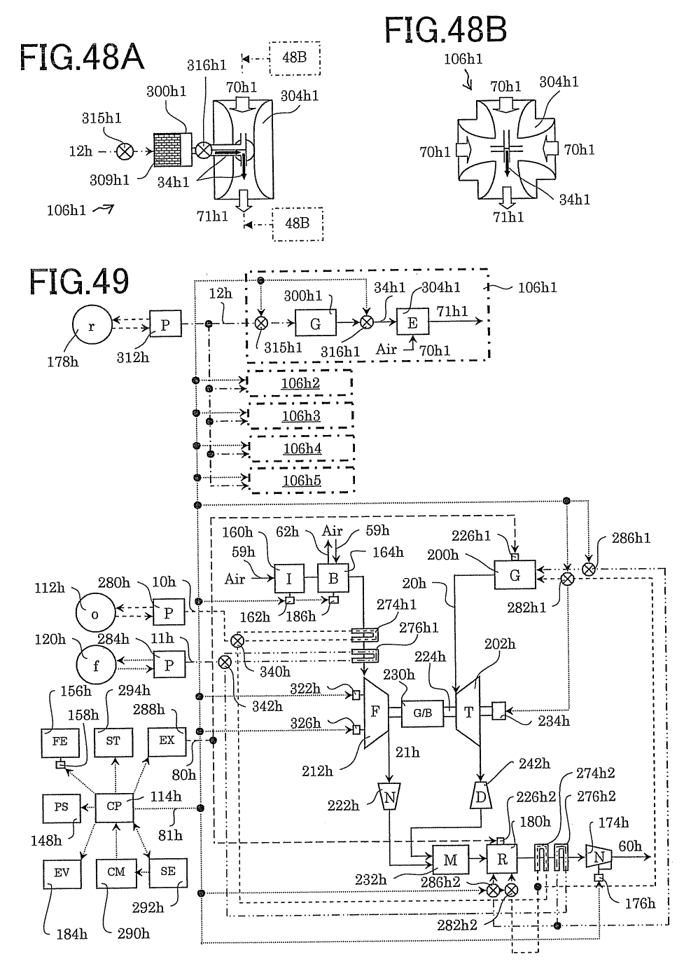

FIGS. 48A and 48B are a vertical section view showing an activated state of a reaction control engine of the space shuttle vehicle and a vertical section view in another section along 48B-48B. Reaction control engines 106h2-106h4 have the same structure as reaction control engine 106h1. Reaction control engine 106h1 has, cylindrical reaction control gas generator 300h1, reactant decomposition catalyst 309h1 for reaction control engine which contains pathway for generated liquid, reactant decomposition flow selecting valve 316h1 for selecting flow of oxide decomposition, and ejectors 304h1 each having a shape in which two orthogonal cylinders are combined crisscross. Flow amount of reactant 12h is adjusted by reactant flow amount control valve 315h1 for reaction control engine, and then the reactant is decomposed into reactant decomposition 33b1 with reactant decomposition catalyst 309h1 for reaction engine in reaction control gas generator 300h1. By reactant decomposition selecting valve 316h1, ejecting direction of reactant decomposition flow 34h1 indicated by black arrows is selected and the flow reaches ejector 304h1. By reactant decomposition flow 34h1 ejecting at a high speed, surrounding air 70h1 indicated by white wide arrow is sucked to ejector 304h1 and becomes mixed gas 71h1 of the both gases indicated by white wide arrows. Thus, a reaction force acts in the opposite direction on reaction control engine 106h1. The reaction control can be performed to a discretionary direction by selecting the reactant decomposition selecting valve 316b1.

FIG. 49 is a block diagram of fluid and electric system of space shuttle vehicle 1h. In space shuttle vehicle 1h, oxider 10h stored in low-temperature oxider tank 112h is pressurized by oxider pressuring system 280h and passes through oxider bypass value 340h and is heat-exchanged with the surrounding air and gas in oxider heading tube 274h1-274h2, and then passes through oxider flow control valves 282h1-282h2, and is supplied to turbine driven gas generator 200h and ram and rocket combustor 180h. On the other hand, fuel 11h stored in low-temperature fuel tank 120h is pressurized by fuel pressuring system 284h and passes through fuel bypass valve 342h and heat-exchanged with the surrounding air and gas in fuel heating ducts 276h1-276h2, and then passes through fuel flow control valves 286h1-286h2, and is supplied to turbine driven gas generator 200h and ram and rocket combustor 180h. Turbine driven gas 20h generated in turbine driven gas generator 200h drives turbine 202h, and then, passes through diffuser 242h and reaches mixer 230h. The power obtained in turbine 202h drives fan 212h through shaft 224h and transmission 230h Fan 212 appropriately controls the attached angle of blades thereof by attached-angle changeable actuators 322h and 326h of the respective blades, and thereby the surrounding air 59h is sucked by controlling changeable air intake lamp 160h and assistance air intake and air exhaust door 164h. The sucked air is cooled down in oxider heating duct 274h1 and fuel heating duct 276h1 and thereby the packing efficiency is enhanced and then the air reaches fan 212h and is pressurized (21h) and reaches nozzle 222h. In nozzle 222h, pressure of air 21h is converted into speed and thereby accelerated to reach mixer 232h. In mixer 232h, some of turbine driven gas 20h and some of air 21h are mixed and reach ram and rocket combustor 180h. Here, oxider 10h and fuel 11h are added and burned according to the flight state, and then heat oxider heating duct 274h2 and fuel heating duct 276h2 again, and passes through changeable area exhaust control nozzle 174h, and is exhausted (60h). The load of shaft 224h is controlled by rotation control motor and electrical generator 234h, and thereby, stall, surge, and the like are avoided. In the case that turbine driven gas 20h comes not to be generated, fan 212h is driven temporarily by rotation control motor and electrical generator 234h, and thereby, space shuttle vehicle 1h is landed as safely as possible.

Reactant 12h stored in reactant tank 178h is pressurized by reactant pressurizing system 312h and supplied to reaction control gas generators 300h1-300h5 of reaction control engines 106h1-106h5 through reactant flow control valves 315h1-315h5 for reaction control engine. Reactant decomposition 34h1-34h5 generated in reaction control gas generators 300h1-300h5 changes the channel thereof, and then, surrounding air 70h1-70h5 is sucked and exhausted (71h1-71h5), and thereby, the reaction is generated.

Control system 290h assigns charge to computer 114h according to information of a sensor 292h detecting information of the body and the like. According to the charge, computer 114h controls each part of space shuttle vehicle 1h, reaction control engines 106h1-106h5, parachute 148h, fairing control actuators 158h for opening and closing fairings 156h, buoyancy buoy 184h, ignition system 288h, and the like, through control signal 81g. Ignition system 288h generates ignition signals 80h to igniters 226h1-h2 to ignite turbine driven gas generator 200h and ram and rocket combustor 180h.

Different kinds of oxider may include liquid oxygen, liquid fluorine, and fluorine oxide such as oxygen difluoride. The fuel includes liquid hydrogen. The combination of liquid oxygen and liquid hydrogen is fascinating in the points that the molecular weight of the vapor to be generated and that harmful substance and environmental contaminant are not generated at all.

Different kinds of reactant may include, hydrogen peroxide and an aqueous solution thereof, hydrazine and a derivative thereof, ethylene oxide, n-propylnitrate, ethylnitrate, methylnitrate, nitromethane, tetranitromethane, and nitroglycerin. Among them, hydrogen peroxide and an aqueous solution thereof do not generate harmful substance and environment a substance at all. As described above, a hydrogen peroxide aqueous solution whose concentration by weight is 30-80% by weight, or a hydrogen peroxide aqueous solution of higher concentration and hydrogen peroxide are practically advantageous.

For reactant decomposition catalyst 309h for reaction control engine, appropriate catalyst components are selected according to the reactant to be used. In the case that the reactant is hydrogen peroxide or an aqueous solution thereof, catalyst components such as, a platinum group metal such as platinum or palladium, or manganese oxide may be used. Moreover, the catalysts can be replaced to a heater for pyrolyzing the reactant.

The above-described embodiments are only typical examples, and their combination, modifications and variations are apparent to those skilled in the art. It should be noted that those skilled in the art can make various modifications to the above-described embodiments without departing from the principle of the invention and the accompanying claims.

What is claimed is:

1. A flying body comprising:
a body;
one or more engines, at least one of the one or more engines being a lift engine which mainly provides a rust force in a vertical direction of the flying body;
a gas generator device which generates a gas for external work by using a raw material for gas generation which material is carried by said flying body;
a first thrust device which receives a power by the gas for external work and exhausts the gas for external work in a predetermined direction to thereby generate a first thrust force; and
a second thrust device which is driven by the power to suck and compress a surrounding gas and to accelerate and exhaust a flow of the surrounding gas substantially in a predetermined direction of a flow of the gas for external work exhausted by the first thrust device to generate a second rust force to be added to the first thrust force.

2. The flying body according to claim 1, wherein the first rust device has a turbine which receives the power, and the second thrust device has a fan driven by the power received by the turbine and has a nozzle provided in a downstream of the fan.

3. The flying body according to claim 2, wherein rotator blades of the turbine is arranged in a periphery of rotator blades of the fan.

4. The flying body according to claim 2, wherein the turbine has a first plurality of rotator blades and a second plurality of rotator blades which rotate in an opposite direction to that of the first plurality of rotator blades, and the fan has a third plurality of rotator blades connected to the first plurality of rotator blades of the turbine and a fourth plurality of rotator blades connected to the second plurality of rotator blades.

5. The flying body according to claim 4, wherein the fan has a plurality of stator blades, an attached angle of which can be changed.

6. The flying body according to claim 4, wherein the plurality of rotator blades of the fan have an attached angle which can be changed.

7. The flying body according to claim 2, further comprising a shaft to which rotator blades of the turbine is attached and which is connected to rotator blades of the fan.

8. The flying body according to claim 7, further comprising a transmission which is connected to the shaft and decreases rotation of the rotator blades of the turbine and transmits the decreased rotation to the rotator blade of the fan.

9. The flying body according to claim 8, further comprising a device which is connected one of the shaft and the transmission and which can perform at least one of control of the rotation and generation of electric power.

10. The flying body according to claim 1, further comprising a plurality of radial louvers which are disposed in a portion of the engine from which the gas is exhausted and which can be opened and closed and are change a direction of the exhausting gas.

11. The flying body according to claim 1, further comprising a plurality of turn blades in a downstream of the second thrust device.

12. The flying body according to claim 1, wherein the gas generator device includes a gas-liquid separator device which separates a liquid component of the raw material for gas generation.

13. A flying body comprising:
a body,
one or more engines, at least one of the one or more engines being a reaction control engine which provides a thrust force to mainly control reaction of said flying body,
a gas generator device which generates a gas for reaction control by using a raw material for gas generation which material is carried by said flying body; and
an ejector which exhausts the gas for reaction control in a predetermined direction to generate a first thrust force, and accelerates a flow of a surrounding gas and exhausts the accelerated surrounding gas substantially in a direction of a flow of the exhausted gas for reaction control to generate a second thrust force to be added to the first thrust force.

14. The flying body according to claim 13, wherein the reaction control engine includes an ejector for accelerating the surrounding gas with the gas generated by the gas generator device.

15. The flying body according to claim 13, wherein the reaction control engine includes: a valve for changing the direction of exhausting the gas generated by the gas generator device, and a plurality of such ejectors facing toward respective directions.

16. The flying body according to claim 13, wherein the gas generator device includes a gas-liquid separator device which separates a liquid component of the raw material for gas generation.

17. The flying body according to claim 2, further comprising a first duct located in a downstream of the turbine, a second duct located in a downstream of the fan, and a first valve which is provided in the second duct and controls a gas flow rate.

18. The flying body according to claim 17, further comprising:
a combustion device located between the fan and the turbine, and
a third duct which connects the combustion device to the fan, wherein the first valve has a closing function in addition of the function of controlling the gas flow rate.

19. The flying body according to claim 1, further comprising a device which is provided in a downstream of the first thrust device and heats the raw material for gas generation.

20. The flying body according to claim 1, further comprising a device which is provided in an upstream of the second thrust device and lowers a temperature of a surrounding gas.

21. A lift engine for a flying body, comprising:
a gas generator device of generating a gas for external work by using a raw material for gas generation;
a first thrust device which receives a power by the gas for external work and exhausts the gas for external work in a predetermined direction to thereby generate a first thrust force; and
a second rust device which is driven by the power to take in and compress a surrounding gas and to accelerate and exhaust a flow of the surrounding gas substantially in a predetermined direction of a flow of the gas for external work exhausted by the first thrust device to generate a second thrust force to be added to the first thrust force.

22. A reaction control engine for a flying body, comprising:
a gas generator device for generating a gas for reaction control by using a raw material for gas generation; and
an ejector which exhausts the gas for reaction control in a predetermined direction to generate a first thrust force, and accelerates a flow of a surrounding gas and exhausts the accelerated surrounding gas substantially in a direction of a flow of the exhausted gas for reaction control to generate a second thrust force to be added to the first thrust force.
